(19) United States
(12) Patent Application Publication
(10) Pub. No.: US 2025/0075147 A1
(43) Pub. Date: Mar. 6, 2025

(54) FRAGRANCE AND FLAVOR COMPOSITIONS COMPRISING NEW FLAVOR AND FRAGRANCE INGREDIENTS

(71) Applicant: OSMO LABS, PBC, Cambridge, MA (US)

(72) Inventors: Alexander WILTSCHKO, Somerville, MA (US); Christophe LAUDAMIEL, New York, NY (US)

(21) Appl. No.: 18/820,161

(22) Filed: Aug. 29, 2024

Related U.S. Application Data
(60) Provisional application No. 63/535,666, filed on Aug. 31, 2023.

(51) Int. Cl. C11B 9/00

(52) U.S. Cl. CPC C11B 9/0076

(57) ABSTRACT

The present application relates to compounds newly identified as having potential use as flavor and fragrance ingredients in food, cosmetic, pharmaceutical, consumer, and other compositions and products.

### CROSS-REFERENCE TO RELATED APPLICATIONS

This application is a nonprovisional application filed under 35 U.S.C. § 111(a), which claims priority to, and the benefit of, U.S. Provisional Applic. Ser. No. 63/535,666, filed on Aug. 31, 2023, the contents of which are hereby incorporated by reference in its entirety.

### FIELD OF THE APPLICATION

The present application relates to compounds newly identified as having potential use as flavor and fragrance ingredients in food, cosmetic, pharmaceutical, consumer, and other compositions and products.

### BACKGROUND

Scent is an important factor used to produce a sense of anticipation, quality, palatability, and security to many consumer products. Flavor is particularly important for foodstuffs. Identifying effective aromas and flavors to impart in a product is an element that contributes to the success of the product, and is useful in product marketing, consumer satisfaction, and consumer retention. Many particular odors and smells may be particularly desirable for certain flavors and fragrances and may be used in toiletries, cosmetics, household cleaners, room sprays, laundry, and fine fragrance applications, such as in perfumes and toilet water, dental hygiene products (such as toothpastes and mouthwashes), orally administered medications, and food products.

Considerable work is performed by many scientists relating to identifying new substances which can be used, alone or in combinations, to impart to, or enhance, the aroma or flavor of various consumable materials, including, e.g., cosmetics, cleaners, and foodstuffs. While there may be some trends in the relationship between chemical structure and flavor or fragrance—such as common use of low molecular weight aldehydes and alcohols as flavors and fragrances—the precise aroma associated with a molecule is exceedingly difficult to predict. Small changes in structure, such a lengthening or shortening a functional group by just one carbon atom, can have profound and unexpected effects on a compound's flavor or fragrance profile. The art of flavor and fragrance prediction is still in its infancy.

Using a proprietary predictive method, the inventors have identified the compounds disclosed herein, as new ingredients useful in flavors and fragrances. These compounds are believed to have not been previously identified as a flavor or fragrance ingredients, nor have their smells or odors been previously described.

This application describes the surprising and unexpected olfactive qualities of the compounds disclosed herein, and their use as fragrance and flavor ingredients, and potential applications thereof.

### BRIEF SUMMARY

In one aspect, the application describes a set of compounds (the “Compounds of the Disclosure”), each commercially available, which have been analyzed by a cohort of subjects trained to describe their perception of odorants using the Rate-All-That-Apply method (RATA) and a 55-word odor lexicon. During training sessions, each term in the lexicon was paired with visual and odor references. Only subjects that met certain performance standards were invited to join the panel. More than 300 compounds were evaluated by the cohort. Selected compounds were further evaluated by trained and/or certified flavor or fragrance chemists or master perfumers.

In another aspect, the application relates to fragrance and flavor compositions comprising any one or more of the Compounds of the Disclosure, optionally comprising one or more additives, additional fragrance or flavor ingredients, or a combination of additives and fragrance or flavor ingredients.

In another aspect, the application relates to products, such as consumer products, comprising such fragrance and flavor compositions comprising the Compounds of the Disclosure.

The details of one or more embodiments of the application are set forth in the accompanying description below. Unless defined otherwise, all technical and scientific terms used herein have the same meaning as commonly understood by one of ordinary skill in the art to which this application belongs. In the case of conflict, the present specification will control.

Other features and advantages of the application will be apparent from the following detailed description, examples, and claims.

### BRIEF DESCRIPTION OF DRAWINGS

FIG. 1: (top) Panel mean ratings with standard error bars, and (bottom) individual panelist ratings, averaged over 2 replicates, for the molecule 2,3-dihydrobenzofuran-5-carboxaldehyde (Compound 380). Descriptors are ordered by panel mean ratings. In the top panel, the top five ranked descriptors are shown in dark grey. In the bottom panel, descriptors are shaded based on rating (darker shading equals higher rating). The bottom panel is also annotated with the Pearson correlation coefficient of the data to the panel mean rating shown in the top panel. The bottom panel also includes panelist/panel correlation coefficients for the panelist that best matches the panel mean and for the panelist with the median match.

### DETAILED DESCRIPTION

The inventors have unexpectedly found that the compounds disclosed herein (“Compounds of the Disclosure”) have unique aromas and flavors and may be useful in imparting and providing desirable aromas and/or flavors to the compositions or products to which they are added. Such compounds are therefore potentially useful for compositions and products where the inclusion of a particular fragrance or flavor is desired, including, but not limited to, perfumes, household products, laundry products, personal care products, cosmetics, dental hygiene products, orally administered medications, and food products. The compounds disclosed herein may be employed in varying amounts depending upon the specific fragrance or flavor product application, the nature and amount of other flavor or fragrance ingredients present, and the desired aroma and/or flavor of the product.

In a first aspect, the present disclosure provides a compound selected from any of the compounds in the following Table 1 (the Compounds of the Disclosure):

| Comp. ID | Name (IUPAC name) |
|---|---|
| 6 | 1-cyclopropylethanol |
| 7 | 2-(4-methyl-1,3-thiazol-5-yl)ethyl formate |
| 12 | boc-DL-alanine |
| 14 | 2,4-dimethylbenzonitrile |
| 17 | bicyclo[2.2.1]heptan-2-one |
| 18 | 3-(2-methylprop-2-enoyloxy)butyl 2-methylprop-2-enoate |
| 22 | 2,3,4,6,7,8,9,10-octahydropyrimido[1,2-a]azepine |
| 29 | N,N-dibutyl formamide |
| 30 | 2-ethyl-N-(2-ethylhexyl)hexan-1-amine |
| 36 | methyl 3-amino-4-methoxybenzoate |
| 38 | 2-methylpropyl 2-cyanoacetate |
| 41 | 2-ethyladamantan-2-ol |
| 45 | 4,5-dimethyl-1,3-thiazol-2-amine |
| 47 | pent-2-yn-1-ol |
| 50 | ethyl 5-methyl-1,2-oxazole-4-carboxylate |
| 61 | 1,2,3,4,5-pentamethylbenzene |
| 63 | diethyl but-2-ynedioate |
| 64 | 5-hydroxyadamantan-2-one |
| 76 | 2-prop-2-ynoxyoxane |
| 79 | cyclooctanamine |
| 80 | (4-methoxy-3,5-dimethylpyridin-2-yl)methanol |
| 82 | benzyl 2-hydroxyacetate |
| 84 | (1S)-cyclohex-3-ene-1-carboxylic acid |
| 85 | 2-ethyl-5-methyl-1H-imidazole |
| 87 | 1-methyl-2-propan-2-yloxybenzene |
| 89 | N-tert-butyl-1-phenylmethanimine |
| 90 | N,N-dimethyl decanamide |
| 92 | 1-(dimethylamino)-2-methylpentan-3-one |
| 96 | dodecane-1,12-diamine |
| 98 | 2-prop-2-enoxybenzaldehyde |
| 100 | diethyl 2,2-dipropylpropanedioate |
| 101 | hept-3-yn-1-ol |
| 102 | 2-thiophen-3-y1-1,3-dioxolane |
| 103 | 6-(dimethylamino)hexan-1-ol |
| 105 | N-cyclohexyl cyclohexanamine |
| 109 | cyclohexylbenzene |
| 116 | 3-methyloxolane-2,5-dione |
| 118 | 8-tricyclo[5.2.1.02,6]decanyl 2-methylprop-2-enoate |
| 120 | methyl 2-cyanopyridine-4-carboxylate |
| 121 | 3-acetylbenzonitrile |
| 125 | (1R,4R,5E)-5-ethylidenebicyclo[2.2.1]hept-2-ene |
| 129 | 4-(cyclohexen-1-yl)morpholine |
| 131 | 2,3-dihydrothieno[3,4-b][1,4]dioxine |
| 132 | ethyl (3R)-4-cyano-3-hydroxybutanoate |
| 133 | 2,5-dimethyl-1H-imidazole |
| 136 | N,N,N′,N′-tetramethyl-1-[(2-methylpropan-2- |
| | yl)oxy]methanediamine |
| 137 | (E)-hex-3-enedinitrile |
| 139 | 2,4-dimethyl-1H-pyrrole |
| 140 | methyl 5-methyl-1,2-oxazole-3-carboxylate |
| 141 | 1-cyclohexylbutan-1-ol |
| 143 | (1S)-3-(dimethylamino)-1- |
| | thiophen-2-ylpropan-1-ol |
| 144 | (1S,2S,3R,5S)-2,6,6-trimethylbicyclo |
| | [3.1.1]heptane-2,3-diol |
| 146 | 1-methylimidazole-2-carbaldehyde |
| 147 | 1-ethenylazepan-2-one |
| 148 | dipropan-2-yl 3-oxocyclobutane-1,1-dicarboxylate |
| 149 | 3a,4,7,7a-tetrahydro-1H-indene |
| 150 | tert-butylcyclohexane |
| 152 | 1-methylindole-3-carbaldehyde |
| 153 | 3,3-dimethylcyclohexan-1-one |
| 157 | tert-butyl 2,2-dimethylpropanoate |
| 161 | 2-methylquinolin-8-ol |
| 163 | 1-phenylpyrazole |
| 164 | 2-methylsulfany1-1,3-thiazole |
| 165 | ethyl N-phenylmethanimidate |
| 168 | quinoline-2-carbaldehyde |
| 171 | 1,3-dimethylpiperidin-4-one |
| 173 | octyl prop-2-enoate |
| 175 | 2-methyl-1,2-thiazol-3-one |
| 177 | pyridine-2-carbonitrile |
| 179 | 4-aminobenzenethiol |
| 181 | N,N-dimethyl-3-oxobutanamide |
| 183 | 2,3,5-trimethylcyclohexa-2,5-diene-1,4-dione |
| 184 | cyclooctanol |
| 185 | N,N,N,N-tetramethylbutane-1,3-diamine |
| 188 | 1-(oxan-2-yl)pyrazole |
| 190 | 2-phenylethylbenzene |
| 191 | 2-ethylhexane-1,3-diol |
| 193 | N-(3,3-dimethylbutan-2-ylidene)hydroxylamine |
| 194 | 2-[2-(2-sulfanylethoxy)ethoxy ]ethanethiol |
| 196 | 3-(pyrrol-1-ylmethyl)pyridine |
| 200 | 1-methylcyclohexane-1-carboxylic acid |
| 201 | but-2-ynoic acid |
| 203 | 2-butanoyloxyethyl butanoate |
| 206 | 4-methylbenzene-1,2-diamine |
| 209 | ethylcyclohexane |
| 210 | 2,2,6,6-tetramethylpiperidin-4-one |
| 211 | propan-2-ylsulfanylbenzene |
| 214 | 2,4,7,9-tetramethyldec-5-yne-4,7-diol |
| 216 | 4,5-dimethyl-1H-pyrazole (e.g., phosphate salt) |
| 222 | 1-hexylimidazole |
| 225 | 6,7-dihydro-5H-cyclopenta[b]pyridine |
| 227 | 1-(1,3-benzodioxol-5-yl)butan-1-one |
| 229 | methyl cyclopentene-1-carboxylate |
| 230 | imidazo[1,2-a]pyridine |
| 232 | cyclooctene |
| 238 | 2-amino-3-phenylpropan-1-ol |
| 239 | 2-hydroxy-2-methylbutanoic acid |
| 240 | adamantane-1,3-diol |
| 241 | N-(1-phenylethylidene)hydroxylamine |
| 245 | cyclohex-3-en-1-ylmethanol |
| 246 | 5-amino-1,2,4-dithiazole-3-thione |
| 251 | 2-phenoxyethanamine |
| 253 | N-[(5-nitrofuran-2-yl)methylidene]hydroxylamine |
| 257 | 1-(4-methylphenyl)pentan-1-one |
| 258 | 5,6,7,8-tetrahydronaphthalen-1-ol |
| 259 | 2,4-dimethoxypyrimidine |
| 260 | 2,5,6-trimethyl-1,3-benzothiazole |
| 261 | pyridine-4-carbonitrile |
| 263 | 1,3-dihydro-2-benzofuran |
| 265 | 2-(dimethylamino)-2-methylpropan-1-ol |
| 268 | 3,4-diethoxycyclobut-3-ene-1,2-dione |
| 272 | 2-butoxypyridine |
| 273 | ethyl 3-(benzylamino)propanoate |
| 275 | 2,4,6,8-tetramethyl-1,3,5,7-tetraoxocane |
| 276 | 7-methyl-1H-indole |
| 277 | 6,6-dimethylhept-1-en-4-yn-3-ol |
| 278 | 2-(dimethylamino)acetonitrile |
| 28 | 3-(ethylamino)propanenitrile |
| 282 | 5-methyl-1,3-benzoxazole |
| 285 | methyl 4-acetyl-5-oxohexanoate |
| 290 | 2-(4-methylphenyl)acetonitrile |
| 294 | bicyclo[2.2.1]hept-5-ene-2-carbonitrile |
| 295 | 1-O-tert-butyl 2-O-ethyl piperidine-1,2-dicarboxylate |
| 297 | N-(9-methyl-9-azabicyclo[3.3.1]nonan-3- |
| | ylidene)hydroxylamine |
| 301 | 1,1-dimethoxy-2-methylsulfanylethane |
| 306 | 4-(4-methoxyphenyl)butan-1-ol |
| 307 | 1-nitrobutane |
| 312 | (NZ)-N-(thiophen-2-ylmethylidene)hydroxylamine |
| 313 | 2,3-dihydro-1,4-benzodioxin-6-amine |
| 314 | [(2S)-1-methoxy-3-[(2-methylpropan-2-yl)oxy]-1- |
| | oxopropan-2-yl]azanium (e.g., hydrochloride salt) |
| 315 | 2,2,4,4-tetramethylpentan-3-one |
| 316 | (1-methylpiperidin-3-yl)methanol |
| 317 | 2,4,4-trimethyl-5H-1,3-oxazole |
| 318 | ethyl 2-oxo-2-thiophen-2-ylacetate |
| 319 | 1-ethynylcyclohexan-1-ol |
| 320 | 4-pentoxybenzaldehyde |
| 321 | 1H-indene |
| 322 | 2-hydroxy-3-propyl-2H-furan-5-one |
| 324 | tert-butyl N-(6-aminohexyl)carbamate |
| 327 | 2-(cyclohexen-1-yl)cyclohexan-1-one |
| 330 | 4-cyclohexylbutanoic acid |
| 332 | 2,6-ditert-butylpyridine |
| 335 | methyl (R)-(+)-2,2-Dimethyl-1,3-dioxolane-4-carboxylate |
| 340 | 3-ethylpentan-3-ol |
| 344 | cyclohexyl prop-2-enoate |
| 349 | 2-(ethoxymethylidene)propanedinitrile |
| 352 | S-phenyl ethanethioate |
| 355 | bis(methylsulfanyl)methylidenecyanamide |
| 358 | (4-ethylphenyl)methanol |
| 366 | 2,2-diethoxy-1-phenylethanone |
| 367 | 3-(2-furyl)acrylic acid |
| 368 | 1-phenylcyclopropane-1-carboxylic acid |
| 370 | 2-(dimethylamino)ethyl acetate |
| 373 | 2-(2-aminophenyl)ethanol |
| 374 | 4,5-dihydro-1,3-thiazol-2-ylcyanamide |
| 377 | 4,9-dimethyltricyclo[5.2.1.02,6]deca-3,8-diene |
| 378 | bis(2-methylpropyl) benzene-1,2-dicarboxylate |
| 380 | 2,3-dihydro-1-benzofuran-5-carbaldehyde |
| 382 | 2-(cyclohexen-1-yl)ethanamine |
| 385 | methyl 2-cyano-2-methylpropanoate |
| 386 | methyl (2R)-2-(4-hydroxyphenoxy)propanoate |
| 391 | 1-(2-bicyclo[2.2.1]hept-5-enyl)ethanone |
| 392 | propan-2-yl cyclohexanecarboxylate |
| 400 | 2,3,3-trimethylindole |
| 401 | 2-ethyl-1H-imidazole |
| 402 | 1,5-dimethylpyrrole-2-carbonitrile |
| 403 | 1,1,3-trimethylthiourea |
| 404 | N-cyclohexyl-N-methylcyclohexanamine |
| 405 | tert-butyl 3-(cyanomethylidene)azetidine-1-carboxylate |
| 407 | 3-methylheptan-4-one |
| 409 | 4-(2-methylpropyl)morpholine |
| 411 | 3-(ethylamino)-4-methylphenol |
| 413 | 4,6-dimethoxypyrimidin-2-amine |
| 414 | 1-(1-adamantyl)ethanone |
| 415 | dimethylcyanamide |
| 416 | L-isoleucinol HCl |
| 417 | 3,4-dihydro-2H-pyran-2-ylmethanol |
| 418 | 3-acetyloxolan-2-one |
| 419 | tert-butyl 3-methylpiperazine-1-carboxylate |
| 424 | ethyl 1-cyanocyclopropane-1-carboxylate |
| 427 | methyl oxane-4-carboxylate |
| 428 | 2-(1-ethoxyethylidene)propanedinitrile |
| 432 | pentanehydrazide |
| 433 | 2-[2-(diethylamino)ethoxy]ethanol |
| 434 | tricyclo[5.2.1.02,6]decan-8-one |
| 436 | 5-nitro-2,3-dihydro-1H-indole |
| 439 | 3-amino-5-methyl-1H-pyridin-2-one |
| 442 | 1-cyclopropylethanone |
| 445 | 1-benzothiophene-2-carbaldehyde |
| 449 | (1S)-2,2-dimethylcyclopropane-1-carboxamide |
| 450 | 4-methylthiophene-2-carboxylic acid |
| 451 | 2,6-dimethylbenzonitrile |
| 452 | 2-piperidin-1-ylethanol |
| 453 | 1-thiophen-3-ylethanone |
| 455 | 5-methyl-1H-imidazole |
| 457 | N-benzyl-N-ethylaniline |
| 458 | 3-nitro-1H-pyridin-4-one |
| 460 | adamantan-2-ol |
| 461 | N-(pyridin-4-ylmethyl)ethanamine |
| 464 | 1,2,4-tris(ethenyl)cyclohexane |
| 465 | 4-methoxy-4-methylpentan-2-one |
| 470 | 1-benzothiophene-3-carbaldehyde |
| 471 | diethyl 2-(2-methylpropyl)propanedioate |
| 472 | tert-butyl N-(1,3-thiazol-2-yl)carbamate |
| 473 | deca-1,9-diene |
| 474 | 3-phenyloxolane-2,5-dione |
| 478 | 2-hydroxy-3-methylbenzaldehyde |
| 480 | chromen-4-one |
| 481 | 2-methylisoindole-1,3-dione |
| 482 | ethyl 3-oxocyclobutane-1-carboxylate |
| 484 | 4-methoxy-1-methyl-2-nitrobenzene |
| 485 | 3,3-dimethylbutan-1-ol |
| 487 | 3,4-dimethoxyphenol |
| 489 | 4-ethenylpyridine |
| 490 | 1,3-thiazole-4-carboxylic acid |
| 491 | dimethyl cyclobutane-1,1-dicarboxylate |
| 492 | dipropan-2-yl butanedioate |
| 499 | 4-methylsulfanylaniline |
| 500 | 1,2,3,4-tetrahydronaphthalen-1-amine |
| 502 | ethyl 3-oxo-3-pyridin-4-ylpropanoate |
| 504 | oxolan-3-ylmethanol |
| 505 | ethyl 3-cyclopropyl-3-oxopropanoate |
| 507 | (1S,2R,6S,7R)-2-methyl-4-oxatricyclo |
| | [5.2.1.02,6]dec-8-ene-3,5-dione |
| 511 | 1H-indazole |
| 512 | 3-(methylamino)-1-phenylpropan-1-ol |
| 514 | 1,2,3,4-tetramethoxy-5-methylbenzene |
| 515 | N-cyclohexylidenehydroxylamine |
| 517 | 2-[methyl(pyridin-2-yl)amino]ethanol |
| 518 | (NE)-N-butan-2-ylidenehydroxylamine |
| 520 | 3-methoxybutyl 3-sulfanylpropanoate |
| 526 | methyl 1H-pyrrole-2-carboxylate |
| 527 | 2-phenylsulfanylacetonitrile |
| 531 | 2-(4-methoxyphenoxy)acetonitrile |
| 533 | pyridine-4-carboxamide |
| 534 | pyridazin-3-amine |
| 539 | 1-methoxy-2-propan-2-ylbenzene |
| 541 | 1,1,1-triethoxyethane |
| 544 | 2-[(2-methylpropan-2-yl)oxy]ethanol |
| 545 | cyclopropyl(phenyl)methanol |
| 550 | methyl 2-amino-4-methylthiophene-3-carboxylate |
| 551 | 2-phenylaniline |
| 554 | N-methyl-1-naphthalen-1-ylmethanamine |
| 558 | 1-benzylpyrrolidin-3-one |
| 560 | 1-methylsulfanyldodecane |
| 561 | N,N-diethyl hydroxylamine |
| 562 | pyridazine |
| 563 | 3-methyl-N,N-bis(3-methylbutyl)butan-1-amine |
| 568 | 1-adamantylmethanol |
| 569 | N-propan-2-ylprop-2-enamide |
| 570 | cyclopropyl-(4-methoxyphenyl)methanone |
| 571 | 2,2-dimethyl-1,3-benzodioxole |
| 575 | 4-hydroxy-2,6-dimethylbenzaldehyde |
| 578 | (1R)-1-phenylpropan-1-amine |
| 580 | acenaphthylene |
| 582 | 4-(dimethoxymethyl)pyrimidine |
| 585 | (4Z)-1-methyl-4- |
| | (6-methylhept-5-en-2-ylidene)cyclohexene |
| 586 | 2,5-dimethyl-1H-indole |
| 590 | 1,3-dimethylcyclohexane |
| 591 | 1,1-dimethoxycyclohexane |
| 592 | N-methoxy-N-methylacetamide |
| 593 | ethyl 2-(2-methoxyphenoxy)acetate |
| 594 | cyclohexane-1,3-dione |
| 595 | 1-phenylpyrrole |
| 596 | 2,4-dimethyl-1H-pyrimidin-6-one |
| 598 | 2-amino-5-methylthiophene-3-carbonitrile |
| 600 | 2,5-dimethylhexa-2,4-diene |
| 601 | 2,5-dimethyl-4H-pyrazol-3-one |
| 604 | 2-aminocyclohexan-1-ol |
| 607 | ethyl 2-methyl-1,3-thiazole-4-carboxylate |
| 611 | cyclohexen-1-ylbenzene |
| 613 | 2-prop-2-enylcyclohexan-1-one |
| 615 | isobornyl methacrylate |
| 620 | 1-methylimidazole |
| 625 | 2-(1-methylpyrrolidin-2-yl)ethanol |
| 627 | 4-pentylcyclohexan-1-one |
| 630 | 4-propan-2-ylcyclohexane-1-carboxylic acid |
| 631 | ethyl 2-(dimethylamino)acetate |
| 634 | 1-(3-hydroxyphenyl)propan-1-one |
| 638 | (4-tert-butylphenyl)methanethiol |
| 642 | 2-cyclopropylacetic acid |
| 649 | 1-methoxy-3,5-dimethylbenzene |
| 660 | 2-ethyl-4,5-dihydro-1,3-oxazole |
| 661 | N-tert-butyl formamide |
| 663 | 2-hydroxy-5-methoxybenzaldehyde |
| 665 | dibutyl 2-methylidenebutanedioate |
| 679 | ethyl (E)-3-ethoxyprop-2-enoate |
| 680 | (E)-3-cyclopentylprop-2-enenitrile |
| 692 | 5-[(3R)-dithiolan-3-yl]pentanoic acid |
| 693 | nonan-5-ol |
| 694 | 3a,4,7,7a-tetrahydro-2-benzofuran-1,3-dione |
| 698 | 2-(methylamino)benzoic acid |
| 699 | cyclohexen-1-yl acetate |
| 700 | 1,3-diethylurea |
| 701 | N,N-di(propan-2-yl)formamide |
| 702 | 2,2,4,4-tetramethylcyclobutane-1,3-dione |
| 703 | 1,1,3,3-tetraethoxypropane |
| 704 | 3-anilinopropanenitrile |
| 709 | 2-(2-aminoethyldisulfanyl)ethanamine |
| 710 | 4-ethyl-3-methyl-1,2-dihydropyrrol-5-one |
| 71. | 4-[(2-methylpropan-2-yl)oxy]-4-oxobutanoic acid |
| 713 | 4,5-dimethyl-1H-pyrazole |
| 717 | 4-methyl-3H-1,3-thiazole-2-thione |
| 721 | 1-phenyl-2-nitropropene |
| 722 | 1-(4-hydroxy-3-methylphenyl)ethanone |
| 724 | (2-methylphenyl)methanol |
| 728 | 2-ethylcyclohexan-1-ol |
| 730 | methyl carbamimidothioate (e.g., sulfate salt) |
| 731 | 1-cyclohexylpiperazine |
| 733 | (2,2,6,6-tetramethylpiperidin-4-yl) |
| | 2-methylprop-2-enoate |
| 735 | 5-ethenylbicyclo[2.2.1]hept-2-ene |
| 736 | 2-bicyclo[2.2.1]hept-5-enylmethanol |
| 738 | propan-2-yl (Z)-3-aminobut-2-enoate |
| 741 | 1,3,3-trimethyl-2-methylideneindole |
| 743 | 1H-indol-2-ol |
| 745 | 2,3-dimethyl-2-propan-2-ylbutanenitrile |
| 753 | 2,1,3-benzothiadiazole |
| 755 | 2-methylpropane-2-sulfinamide |
| 756 | 1,3-dimethyl-2-nitrobenzene |
| 757 | 4-propylcyclohexan-1-ol |
| 758 | 2-butyl-1-benzofuran |
| 760 | tert-butyl N-piperidin-3-ylcarbamate |
| | (e.g., hydrochloride salt) |
| 761 | 2-methyl-2-propylpropane-1,3-diol |
| 762 | ethyl 2,5-dimethylpyrazole-3-carboxylate |
| 763 | 3,5-dimethyl-1H-1,2,4-triazole |
| 764 | 2-methyl-1H-indene |
| 765 | 1-ethylpyrrolidin-3-ol |
| 773 | 4-nitrobenzaldehyde |
| 776 | methyl 2-methoxypyridine-3-carboxylate |
| 777 | pent-4-yn-1-ol |
| 780 | 1-ethynyl-4-pentylbenzene |
| 781 | methyl (E)-3-(4-methylphenyl)prop-2-enoate |
| 783 | 1,4-bis(methoxymethyl)benzene |
| 784 | 1-benzyl-N-methylpyrrolidin-3-amine |
| 786 | 3,3-dimethylbutanoic acid |
| 790 | 3-butylthiophene |
| 791 | 4,4-dimethyl-3-oxopentanenitrile |
| 800 | thiomorpholine |
| 801 | 3,4-dihydro-2H-pyran-5-carboxylic acid |
| 803 | (3-methoxyphenyl)methanol |
| 812 | 2-butyl-2-ethylpropane-1,3-diol |
| 820 | 1-phenylethenylbenzene |
| 822 | methyl 3-oxopentanoate |
| 827 | 7-methoxy-3,4,5,6-tetrahydro-2H-azepine |
| 829 | 1,2-dimethylindole |
| 832 | ethyl (2R)-2-hydroxy-2-phenylacetate |
| 834 | 1-[2-(2-butoxyethoxy)ethoxy]butane |
| 847 | N-methyl-N-phenylaniline |
| 848 | ethyl 3-piperidin-1-ylpropanoate |
| 854 | 2,2,6,6-tetramethyl-1-piperidinyloxy radical |
| 861 | decane-1-thiol |
| 864 | ethyl 2-(4-ethoxyphenyl)acetate |
| 868 | 1,1-bis(methylsulfanyl)-2-nitroethene |
| 875 | 2-(N-ethyl-3-methylanilino)ethanol |
| 876 | thiophene-2-carbonitrile |
| 877 | 1-propylpiperidin-4-one |
| 879 | 1-cyclohexylpyrrolidin-2-one |
| 881 | 1-methoxybutan-2-ol |
| 882 | 3-phenylprop-2-ynoic acid |
| 887 | 5-hydroxy-2,3-dihydroinden-1-one |
| 889 | 5-ethyl-1,3,4-thiadiazol-2-amine |
| 895 | N-butan-2-ylidenehydroxylamine |
| 896 | 1-tert-butyl-3,5-dimethylbenzene |
| 897 | 3,4-dimethylpyridine |
| 898 | 2-tert-butylsulfany1-2-methylpropane |
| 900 | (4-ethenylphenyl) acetate |
| 901 | butyl 2,2-dimethyl-4-oxo-3H-pyran-6-carboxylate |
| 905 | 2,6-dimethylcyclohexan-1-ol |
| 906 | 6-methoxy-2-methylquinoline |
| 913 | 2-ethoxypyrazine |
| 917 | (1S)-3-(methylamino)-1-thiophen-2-ylpropan-1-ol |
| 918 | 2-methylfuran-3-carboxylic acid |
| 920 | 2-(4-methylphenyl)acetic acid |
| 926 | 1,3-benzoxazole |
| 927 | 2-methylsulfanylacetic acid |
| 931 | tert-butyl 4-aminobenzoate |
| 934 | phenyl carbamate |
| 941 | 2-phenyl-4,5-dihydro-1,3-oxazole |
| 944 | 4-pyrrolidin-1-ylbutanenitrile |
| 946 | oxane-4-carbonitrile |
| 947 | 2-hydroxycyclohepta-2,4,6-trien-1-one |
| 950 | 2-tert-butylphenol |
| 952 | 3-methyl-4-methylsulfanylphenol |
| 954 | 3-(cyclohexylamino)propanenitrile |
| 955 | 1-(2-methylphenyl)piperazine |
| 959 | 5-methyl-1,2-oxazol-3-one |
| 960 | 2-pyridin-4-ylpyridine |
| 961 | thiophene-3-carbonitrile |
| 962 | N-(4-aminophenyl)acetamide |
| 963 | 2,2-dimethyl-3H-1-benzofuran-7-ol |
| 964 | 3-oxo-3-phenylpropanenitrile |
| 965 | 2-pyridin-2-ylsulfanylethanol |
| 968 | methyl 3-(4-hydroxyphenyl)propanoate |
| 971 | (1-ethylpyrrolidin-2-yl)methanamine |
| 974 | 3,5-dimethylbenzonitrile |
| 976 | 7-methoxy-3,4-dihydro-2H-naphthalen-1-one |
| 982 | 2-methylbutan-2-ylbenzene |
| 985 | 1-phenylcyclopentane-1-carbonitrile |
| 988 | 3,3-dimethyl-2H-inden-1-one |
| 995 | 2,6-dimethyl-3-nitropyridine |
| 999 | 3-methylbenzoic acid |

each in free base or salt form (e.g., acid addition salt form or base addition salt form, as appropriate).

In a preferred embodiment of the first aspect, the present disclosure provides a compound selected from any of the compounds in the following Table 2:

| Comp. ID | Name (IUPAC name) |
|---|---|
| 18 | 3-(2-methylprop-2-enoyloxy)butyl 2-methylprop-2-enoate |
| 41 | 2-ethyladamantan-2-ol |
| 50 | ethyl 5-methyl-1,2-oxazole-4-carboxylate |
| 61 | 1,2,3,4,5-pentamethylbenzene |
| 100 | diethyl 2,2-dipropylpropanedioate |
| 118 | 8-tricyclo[5.2.1.02,6]decanyl 2-methylprop-2-enoate |
| 141 | 1-cyclohexylbutan-1-ol |
| 193 | N-(3,3-dimethylbutan-2-ylidene)hydroxylamine |
| 216 | 4,5-dimethyl-1H-pyrazole (e.g., phosphate salt) |
| 229 | methyl cyclopentene-1-carboxylate |
| 232 | cyclooctene |
| 259 | 2,4-dimethoxypyrimidine |
| 263 | 1,3-dihydro-2-benzofuran |
| 272 | 2-butoxypyridine |
| 275 | 2,4,6,8-tetramethyl-1,3,5,7-tetraoxocane |
| 285 | methyl 4-acetyl-5-oxohexanoate |
| 314 | [(2S)-1-methoxy-3-[(2-methylpropan-2-yl)oxy]- |
| | 1-oxopropan-2-yl]azanium (e.g., hydrochloride salt) |
| 316 | (1-methylpiperidin-3-yl)methanol |
| 322 | 2-hydroxy-3-propyl-2H-furan-5-one |
| 327 | 2-(cyclohexen-1-yl)cyclohexan-1-one |
| 352 | S-phenyl ethanethioate |
| 377 | 4,9-dimethyltricyclo[5.2.1.02,6]deca-3,8-diene |
| 391 | 1-(2-bicyclo[2.2.1]hept-5-enyl)ethanone |
| 402 | 1,5-dimethylpyrrole-2-carbonitrile |
| 407 | 3-methylheptan-4-one |
| 413 | 4,6-dimethoxypyrimidin-2-amine |
| 424 | ethyl 1-cyanocyclopropane-1-carboxylate |
| 455 | 5-methyl-1H-imidazole |
| 458 | 3-nitro-1H-pyridin-4-one |
| 482 | ethyl 3-oxocyclobutane-1-carboxylate |
| 492 | dipropan-2-yl butanedioate |
| 502 | ethyl 3-oxo-3-pyridin-4-ylpropanoate |
| 505 | ethyl 3-cyclopropyl-3-oxopropanoate |
| 514 | 1,2,3,4-tetramethoxy-5-methylbenzene |
| 533 | pyridine-4-carboxamide |
| 539 | 1-methoxy-2-propan-2-ylbenzene |
| 544 | 2-[(2-methylpropan-2-yl)oxy]ethanol |
| 582 | 4-(dimethoxymethyl)pyrimidine |
| 613 | 2-prop-2-enylcyclohexan-1-one |
| 634 | 1-(3-hydroxyphenyl)propan-1-one |
| 660 | 2-ethyl-4,5-dihydro-1,3-oxazole |
| 699 | cyclohexen-1-yl acetate |
| 701 | N,N-di(propan-2-y1)formamide |
| 722 | 1-(4-hydroxy-3-methylphenyl)ethanone |
| 728 | 2-ethylcyclohexan-1-ol |
| 736 | 2-bicyclo[2.2.1 ]hept-5-enylmethanol |
| 757 | 4-propylcyclohexan-1-ol |
| 758 | 2-butyl-1-benzofuran |
| 762 | ethyl 2,5-dimethylpyrazole-3-carboxylate |
| 780 | 1-ethynyl-4-pentylbenzene |
| 876 | thiophene-2-carbonitrile |
| 917 | (1S)-3-(methylamino)-1-thiophen-2-ylpropan-1-ol |
| 920 | 2-(4-methylphenyl)acetic acid |
| 926 | 1,3-benzoxazole |
| 988 | 3,3-dimethyl-2H-inden-1-one |
| 995 | 2,6-dimethyl-3-nitropyridine |
| 7 | 2-(4-methyl-1,3-thiazol-5-yl)ethyl formate |
| 45 | 4,5-dimethyl-1,3-thiazol-2-amine |
| 47 | pent-2-yn-1-ol |
| 63 | diethyl but-2-ynedioate |
| 102 | 2-thiophen-3-yl-1,3-dioxolane |
| 109 | cyclohexylbenzene |
| 165 | ethyl N-phenylmethanimidate |
| 177 | pyridine-2-carbonitrile |
| 183 | 2,3,5-trimethylcyclohexa-2,5-diene-1,4-dione |
| 227 | 1-(1,3-benzodioxol-5-yl)butan-1-one |
| 261 | pyridine-4-carbonitrile |
| 268 | 3,4-diethoxycyclobut-3-ene-1,2-dione |
| 273 | ethyl 3-(benzylamino)propanoate |
| 276 | 7-methyl-1H-indole |
| 295 | 1-O-tert-butyl 2-O-ethyl piperidine-1,2-dicarboxylate |
| 332 | 2,6-ditert-butylpyridine |
| 340 | 3-ethylpentan-3-ol |
| 366 | 2,2-diethoxy-1-phenylethanone |
| 414 | 1-(1-adamantyl)ethanone |
| 417 | 3,4-dihydro-2H-pyran-2-ylmethanol |
| 418 | 3-acetyloxolan-2-one |
| 427 | methyl oxane-4-carboxylate |
| 453 | 1-thiophen-3-ylethanone |
| 460 | adamantan-2-ol |
| 464 | 1,2,4-tris(ethenyl)cyclohexane |
| 480 | chromen-4-one |
| 484 | 4-methoxy-1-methyl-2-nitrobenzene |
| 487 | 3,4-dimethoxyphenol |
| 504 | oxolan-3-ylmethanol |
| 558 | 1-benzylpyrrolidin-3-one |
| 560 | 1-methylsulfanyldodecane |
| 568 | 1-adamantylmethanol |
| 593 | ethyl 2-(2-methoxyphenoxy)acetate |
| 596 | 2,4-dimethyl-1H-pyrimidin-6-one |
| 679 | ethyl (E)-3-ethoxyprop-2-enoate |
| 680 | (E)-3-cyclopentylprop-2-enenitrile |
| 693 | nonan-5-ol |
| 735 | 5-ethenylbicyclo[2.2.1]hept-2-ene |
| 741 | 1,3,3-trimethyl-2-methylideneindole |
| 760 | tert-butyl N-piperidin-3-ylcarbamate |
| | (e.g., hydrochloride salt) |
| 776 | methyl 2-methoxypyridine-3-carboxylate |
| 777 | pent-4-yn-1-ol |
| 861 | decane-1-thiol |
| 895 | N-butan-2-ylidenehydroxylamine |
| 900 | (4-ethenylphenyl) acetate |
| 901 | butyl 2,2-dimethyl-4-oxo-3H-pyran-6-carboxylate |
| 963 | 2,2-dimethyl-3H-1-benzofuran-7-ol |
| 965 | 2-pyridin-2-ylsulfanylethanol |
| 968 | methyl 3-(4-hydroxyphenyl)propanoate |
| 974 | 3,5-dimethylbenzonitrile |
| 976 | 7-methoxy-3,4-dihydro-2H-naphthalen-1-one |
| 76 | 2-prop-2-ynoxyoxane |
| 82 | benzyl 2-hydroxyacetate |
| 85 | 2-ethyl-5-methyl-1H-imidazole |
| 98 | 2-prop-2-enoxybenzaldehyde |
| 101 | hept-3-yn-1-ol |
| 121 | 3-acetylbenzonitrile |
| 125 | (1R,4R,5E)-5-ethylidenebicyclo[2.2.1]hept-2-ene |
| 132 | ethyl (3R)-4-cyano-3-hydroxybutanoate |
| 153 | 3,3-dimethylcyclohexan-1-one |
| 164 | 2-methylsulfanyl-1,3-thiazole |
| 184 | cyclooctanol |
| 191 | 2-ethylhexane-1,3-diol |
| 209 | ethylcyclohexane |
| 214 | 2,4,7,9-tetramethyldec-5-yne-4,7-diol |
| 257 | 1-(4-methylphenyl)pentan-1-one |
| 319 | 1-ethynylcyclohexan-1-ol |
| 432 | pentanehydrazide |
| 451 | 2,6-dimethylbenzonitrile |
| 515 | N-cyclohexylidenehydroxylamine |
| 518 | (NE)-N-butan-2-ylidenehydroxylamine |
| 531 | 2-(4-methoxyphenoxy)acetonitrile |
| 550 | methyl 2-amino-4-methylthiophene-3-carboxylate |
| 570 | cyclopropyl-(4-methoxyphenyl)methanone |
| 585 | (4Z)-1-methyl-4- |
| | (6-methylhept-5-en-2-ylidene)cyclohexene |
| 663 | 2-hydroxy-5-methoxybenzaldehyde |
| 703 | 1,1,3,3-tetraethoxypropane |
| 713 | 4,5-dimethyl-1H-pyrazole |
| 724 | (2-methylphenyl)methanol |
| 745 | 2,3-dimethyl-2-propan-2-ylbutanenitrile |
| 753 | 2,1,3-benzothiadiazole |
| 784 | 1-benzyl-N-methylpyrrolidin-3-amine |
| 829 | 1,2-dimethylindole |
| 854 | 2,2,6,6-tetramethyl-1-piperidinyloxy free radical |
| 864 | ethyl 2-(4-ethoxyphenyl)acetate |
| 877 | 1-propylpiperidin-4-one |
| 882 | 3-phenylprop-2-ynoic acid |
| 905 | 2,6-dimethylcyclohexan-1-ol |
| 950 | 2-tert-butylphenol |
| 982 | 2-methylbutan-2-ylbenzene |
| 290 | 2-(4-methylphenyl)acetonitrile |
| 358 | (4-ethylphenyl)methanol |
| 473 | deca-1,9-diene |

each in free base or salt form (e.g., acid addition salt form or base addition salt form, as appropriate).

In a more preferred embodiment of the first aspect, the present disclosure provides a corn und selected from any of the compounds in the following Table 3:

| Comp. ID | Name (IUPAC name) |
|---|---|
| 18 | 3-(2-methylprop-2-enoyloxy)butyl 2-methylprop-2-enoate |
| 41 | 2-ethyladamantan-2-ol |
| 50 | ethyl 5-methyl-1,2-oxazole-4-carboxylate |
| 61 | 1,2,3,4,5-pentamethylbenzene |
| 100 | diethyl 2,2-dipropylpropanedioate |
| 118 | 8-tricyclo[5.2.1.02,6]decanyl 2-methylprop-2-enoate |
| 141 | 1-cyclohexylbutan-1-ol |
| 193 | N-(3,3-dimethylbutan-2-ylidene)hydroxylamine |
| 216 | 4,5-dimethyl-1H-pyrazole (e.g., phosphate salt) |
| 229 | methyl cyclopentene-1-carboxylate |
| 232 | cyclooctene |
| 259 | 2,4-dimethoxypyrimidine |
| 263 | 1,3-dihydro-2-benzofuran |
| 272 | 2-butoxypyridine |
| 275 | 2,4,6,8-tetramethyl-1,3,5,7-tetraoxocane |
| 285 | methyl 4-acetyl-5-oxohexanoate |
| 314 | [(2S)-1-methoxy-3-[(2-methylpropan-2-yl)oxy]-1- |
| | oxopropan-2-yl]azanium (e.g., hydrochloride salt) |
| 316 | (1-methylpiperidin-3-yl)methanol |
| 322 | 2-hydroxy-3-propyl-2H-furan-5-one |
| 327 | 2-(cyclohexen-1-yl)cyclohexan-1-one |
| 352 | S-phenyl ethanethioate |
| 377 | 4,9-dimethyltricyclo[5.2.1.02,6]deca-3,8-diene |
| 391 | 1-(2-bicyclo[2.2.1]hept-5-enyl)ethanone |
| 402 | 1,5-dimethylpyrrole-2-carbonitrile |
| 407 | 3-methylheptan-4-one |
| 413 | 4,6-dimethoxypyrimidin-2-amine |
| 424 | ethyl 1-cyanocyclopropane-1-carboxylate |
| 455 | 5-methyl-1H-imidazole |
| 458 | 3-nitro-1H-pyridin-4-one |
| 482 | ethyl 3-oxocyclobutane-1-carboxylate |
| 492 | dipropan-2-yl butanedioate |
| 502 | ethyl 3-oxo-3-pyridin-4-ylpropanoate |
| 505 | ethyl 3-cyclopropyl-3-oxopropanoate |
| 514 | 1,2,3,4-tetramethoxy-5-methylbenzene |
| 533 | pyridine-4-carboxamide |
| 539 | 1-methoxy-2-propan-2-ylbenzene |
| 544 | 2-[(2-methylpropan-2-yl)oxy ]ethanol |
| 582 | 4-(dimethoxymethyl)pyrimidine |
| 613 | 2-prop-2-enylcyclohexan-1-one |
| 634 | 1-(3-hydroxyphenyl)propan-1-one |
| 660 | 2-ethyl-4,5-dihydro-1,3-oxazole |
| 699 | cyclohexen-1-yl acetate |
| 701 | N,N-di(propan-2-yl)formamide |
| 722 | 1-(4-hydroxy-3-methylphenyl)ethanone |
| 728 | 2-ethylcyclohexan-1-ol |
| 736 | 2-bicyclo[2.2.1 ]hept-5-enylmethanol |
| 757 | 4-propylcyclohexan-1-ol |
| 758 | 2-butyl-1-benzofuran |
| 762 | ethyl 2,5-dimethylpyrazole-3-carboxylate |
| 780 | 1-ethynyl-4-pentylbenzene |
| 876 | thiophene-2-carbonitrile |
| 917 | (1S)-3-(methylamino)-1-thiophen-2-ylpropan-1-ol |
| 920 | 2-(4-methylphenyl)acetic acid |
| 926 | 1,3-benzoxazole |
| 988 | 3,3-dimethyl-2H-inden-1-one |
| 995 | 2,6-dimethyl-3-nitropyridine |
| 7 | 2-(4-methyl-1,3-thiazol-5-yl)ethyl formate |
| 45 | 4,5-dimethyl-1,3-thiazol-2-amine |
| 47 | pent-2-yn-1-ol |
| 63 | diethyl but-2-ynedioate |
| 102 | 2-thiophen-3-yl-1,3-dioxolane |
| 109 | cyclohexylbenzene |
| 165 | ethyl N-phenylmethanimidate |
| 177 | pyridine-2-carbonitrile |
| 183 | 2,3,5-trimethylcyclohexa-2,5-diene-1,4-dione |
| 227 | 1-(1,3-benzodioxol-5-yl)butan-1-one |
| 261 | pyridine-4-carbonitrile |
| 268 | 3,4-diethoxycyclobut-3-ene-1,2-dione |
| 273 | ethyl 3-(benzylamino)propanoate |
| 276 | 7-methyl-1H-indole |
| 295 | 1-O-tert-butyl 2-O-ethyl piperidine-1,2-dicarboxylate |
| 332 | 2,6-ditert-butylpyridine |
| 340 | 3-ethylpentan-3-ol |
| 366 | 2,2-diethoxy-1-phenylethanone |
| 414 | 1-(1-adamantyl)ethanone |
| 417 | 3,4-dihydro-2H-pyran-2-ylmethanol |
| 418 | 3-acetyloxolan-2-one |
| 427 | methyl oxane-4-carboxylate |
| 453 | 1-thiophen-3-ylethanone |
| 460 | adamantan-2-ol |
| 464 | 1,2,4-tris(ethenyl)cyclohexane |
| 480 | chromen-4-one |
| 484 | 4-methoxy-1-methyl-2-nitrobenzene |
| 487 | 3,4-dimethoxyphenol |
| 504 | oxolan-3-ylmethanol |
| 558 | 1-benzylpyrrolidin-3-one |
| 560 | 1-methylsulfanyldodecane |
| 568 | 1-adamantylmethanol |
| 593 | ethyl 2-(2-methoxyphenoxy)acetate |
| 596 | 2,4-dimethyl-1H-pyrimidin-6-one |
| 679 | ethyl (E)-3-ethoxyprop-2-enoate |
| 680 | (E)-3-cyclopentylprop-2-enenitrile |
| 693 | nonan-5-ol |
| 735 | 5-ethenylbicyclo[2.2.1 ]hept-2-ene |
| 741 | 1,3,3-trimethyl-2-methylideneindole |
| 760 | tert-butyl N-piperidin-3-ylcarbamate |
| | (e.g., hydrochloride salt) |
| 776 | methyl 2-methoxypyridine-3-carboxylate |
| 777 | pent-4-yn-1-ol |
| 861 | decane-1-thiol |
| 895 | N-butan-2-ylidenehydroxylamine |
| 900 | (4-ethenylphenyl) acetate |
| 901 | butyl 2,2-dimethyl-4-oxo-3H-pyran-6-carboxylate |
| 963 | 2,2-dimethyl-3H-1-benzofuran-7-ol |
| 965 | 2-pyridin-2-ylsulfanylethanol |
| 968 | methyl 3-(4-hydroxyphenyl)propanoate |
| 974 | 3,5-dimethylbenzonitrile |
| 976 | 7-methoxy-3,4-dihydro-2H-naphthalen-1-one |

each in free base or salt form (e.g., acid addition salt form or base addition salt form, as appropriate).

In a more preferred embodiment of the first aspect, the present disclosure provides a corn und selected from any of the compounds in the following Table 4:

| Comp. ID | Name (IUPAC name) |
|---|---|
| 18 | 3-(2-methylprop-2-enoyloxy)butyl |
| | 2-methylprop-2-enoate |
| 41 | 2-ethyladamantan-2-ol |
| 50 | ethyl 5-methyl-1,2-oxazole-4-carboxylate |
| 61 | 1,2,3,4,5-pentamethylbenzene |
| 100 | diethyl 2,2-dipropylpropanedioate |
| 118 | 8-tricyclo[5.2.1.02,6]decanyl 2-methylprop-2-enoate |
| 141 | 1-cyclohexylbutan-1-ol |
| 193 | N-(3,3-dimethylbutan-2-ylidene)hydroxylamine |
| 216 | 4,5-dimethyl-1H-pyrazole (e.g., phosphate salt) |
| 229 | methyl cyclopentene-1-carboxylate |
| 232 | cyclooctene |
| 259 | 2,4-dimethoxypyrimidine |
| 263 | 1,3-dihydro-2-benzofuran |
| 272 | 2-butoxypyridine |
| 275 | 2,4,6,8-tetramethyl-1,3,5,7-tetraoxocane |
| 285 | methyl 4-acetyl-5-oxohexanoate |
| 314 | [(2S)-1-methoxy-3-[(2-methylpropan-2-yl)oxy]-1- |
| | oxopropan-2-yl]azanium (e.g., hydrochloride salt) |
| 316 | (1-methylpiperidin-3-yl)methanol |
| 322 | 2-hydroxy-3-propyl-2H-furan-5-one |
| 327 | 2-(cyclohexen-1-yl)cyclohexan-1-one |
| 352 | S-phenyl ethanethioate |
| 377 | 4,9-dimethyltricyclo[5.2.1.02,6]deca-3,8-diene |
| 391 | 1-(2-bicyclo[2.2.1]hept-5-enyl)ethanone |
| 402 | 1,5-dimethylpyrrole-2-carbonitrile |
| 407 | 3-methylheptan-4-one |
| 413 | 4,6-dimethoxypyrimidin-2-amine |
| 424 | ethyl 1-cyanocyclopropane-1-carboxylate |
| 455 | 5-methyl-1H-imidazole |
| 458 | 3-nitro-1H-pyridin-4-one |
| 482 | ethyl 3-oxocyclobutane-1-carboxylate |
| 492 | dipropan-2-yl butanedioate |
| 502 | ethyl 3-oxo-3-pyridin-4-ylpropanoate |
| 505 | ethyl 3-cyclopropyl-3-oxopropanoate |
| 514 | 1,2,3,4-tetramethoxy-5-methylbenzene |
| 533 | pyridine-4-carboxamide |
| 539 | 1-methoxy-2-propan-2-ylbenzene |
| 544 | 2-[(2-methylpropan-2-yl)oxy]ethanol |
| 582 | 4-(dimethoxymethyl)pyrimidine |
| 613 | 2-prop-2-enylcyclohexan-1-one |
| 634 | 1-(3-hydroxyphenyl)propan-1-one |
| 660 | 2-ethyl-4,5-dihydro-1,3-oxazole |
| 699 | cyclohexen-1-yl acetate |
| 701 | N,N-di(propan-2-yl)formamide |
| 722 | 1-(4-hydroxy-3-methylphenyl)ethanone |
| 728 | 2-ethylcyclohexan-1-ol |
| 736 | 2-bicyclo[2.2.1 ]hept-5-enylmethanol |
| 757 | 4-propylcyclohexan-1-ol |
| 758 | 2-butyl-1-benzofuran |
| 762 | ethyl 2,5-dimethylpyrazole-3-carboxylate |
| 780 | 1-ethynyl-4-pentylbenzene |
| 876 | thiophene-2-carbonitrile |
| 917 | (1S)-3-(methylamino)-1-thiophen-2-ylpropan-1-ol |
| 920 | 2-(4-methylphenyl)acetic acid |
| 926 | 1,3-benzoxazole |
| 988 | 3,3-dimethyl-2H-inden-1-one |
| 995 | 2,6-dimethyl-3-nitropyridine |

each in free base or salt form (e.g., acid addition salt form or base addition salt form, as appropriate).

In some embodiments of the preceding aspect, the following compounds are excluded from the listing of Tables 1, 2, 3 and/or 4: ID Nos. 45, 133, 285, 319, 418, 491, 499, 593, 728, 731, and/or 917.

In some embodiments of the preceding aspect, the following compounds are excluded from the listing of Tables 1, 2, 3 and/or 4: ID Nos. 45, 103, 136, 285, 318, 370, 418, 491, 499, 728, 731, and/or 917.

In some embodiments of the preceding aspect, the following compounds are excluded from the listing of Tables 1, 2, 3 and/or 4: ID Nos. 47, 90, 101, 409, 461, 490, 520, 550, 607, 692, 777, and/or 868.

In some embodiments of the preceding aspect, the following compounds are excluded from the listing of Tables 1, 2, 3 and/or 4: ID Nos. 7, 103, 136, 141, 150, 184, 203, 301, 318, 370, 392, 442, 455, 544, 615, 625, 745, 822, and/or 927.

In some embodiments of the preceding aspect, the following compounds are excluded from the listing of Tables 1, 2, 3 and/or 4: ID Nos. 201, 253, 316, 560, 594, 864, 918, 955, and/or 995.

In some embodiments of the preceding aspect, the following compounds are excluded from the listing of Tables 1, 2, 3 and/or 4: ID Nos. 45, 133, 184, 201, 316, 491, 560, 594, 625, 728, 731, 864, 918, 955, and/or 995.

In some embodiments of the preceding aspect, the following compounds are excluded from the listing of Tables 1, 2, 3 and/or 4: ID Nos. 45, 201, 316, 560, 864, 955, and/or 995.

In some embodiments of the preceding aspect, the following compounds are excluded from the listing of Tables 1, 2, 3 and/or 4: ID Nos. 163, 188, 216, 601, 713, and/or 762 (pyrazoles).

In some embodiments of the preceding aspect, the following compounds are excluded from the listing of Tables 1, 2, 3 and/or 4: ID Nos. 319 and/or 780 (ethynyl compounds).

In some embodiments of the preceding aspect, the following compounds are excluded from the listing of Tables 1, 2, 3 and/or 4: ID Nos. 41, 64, 240, 414, 460, and/or 568 (adamantane compounds).

In some embodiments of the preceding aspect, the following compounds are excluded from the listing of Tables 1, 2, 3 and/or 4: ID Nos. 102, 131, 143, 179, 312, 318, 445, 450, 453, 470, 550, 598, 790, 876, 917, and/or 961 (thiophene and benzothiophene compounds).

In some embodiments of the preceding aspect, the following compounds are excluded from the listing of Tables 1, 2, 3 and/or 4: ID Nos. 98, 320, 478, 575, 663, and/or 773 (benzaldehydes).

In some embodiments of the preceding aspect, the following compounds are excluded from the listing of Tables 1, 2, 3 and/or 4: ID Nos. 84, 105, 109, 129, 141, 150, 153, 183, 200, 209, 245, 319, 327, 330, 344, 382, 392, 404, 464, 515, 585, 590, 591, 594, 604, 611, 613, 627, 630, 699, 728, 731, 757, 879, 905, and/or 954 (cyclohexanes and cyclohexenes).

In some embodiments of the preceding aspect, the following compounds are excluded from the listing of Tables 1, 2, 3 and/or 4: ID Nos. 263, 380, 694, 758, and/or 963 (benzofurans).

In some embodiments of the preceding aspect, the following compounds are excluded from the listing of Tables 1, 2, 3 and/or 4: ID Nos. 17, 125, 294, 391, 507, 735, and/or 736 (norbornanes).

In a second aspect, the present disclosure provides a flavor composition and/or a fragrance composition (Composition 1) comprising any one or more of Compounds 6 to 999 in free base or salt form, as described in any embodiments hereinabove, in admixture with one or more carriers or excipients, which carriers or excipients are non-toxic, orally acceptable, pharmaceutically acceptable, cosmetically acceptable, acceptable for a household product, or otherwise acceptable for the intended purpose of the Composition. In particular embodiments, the second aspect provides:
1.1 Composition 1, wherein the composition is a fragrance composition.
1.2 Composition 1, wherein the composition is a flavor composition.
1.3 Composition 1, or any of Compositions 1.1-1.2, wherein the composition comprises any one or more of the Compounds of the Disclosure (e.g., Compounds 6 to 999), in an amount of 0.1 to 100% by weight of the composition, e.g., 0.1 to 90%, or 0.1 to 80%, or 0.1 to 70%, or 0.1 to 60%, or 0.1 to 50%, or 0.1 to 40%, or 0.1 to 30%, or 0.1 to 20%, or 0.1 to 15%, or 0.1 to 10%, or 0.1 to 7.5%, or 0.1 to 5%, or 0.1 to 4%, or 0.1 to 3%, or 0.1 to 2%, or 0.1 to 1%, or 10 to 100%, or 20 to 100%, or 30 to 100%, or 40 to 100%, or 50 to 100%, or 60 to 100%, or 70 to 100%, or 80 to 100%, or 90 to 100%, or 95 to 100%, or 25 to 75%, or 50 to 75%, or 75 to 95%, by weight of the composition.
1.4 Composition 1, or any of Compositions 1.1-1.3, wherein the composition further comprises one or more other flavors or fragrances.
1.5 Composition 1, or any of Compositions 1.1-1.4, wherein the composition further comprises one or more solvents.
1.6 Composition 1.5, wherein the one or more solvents are selected from water, methanol, ethanol, propanol, isopropanol, dimethyl ether, diethyl ether, diisopropyl ether, methyl tert-butyl ether, ethylene glycol, propylene glycol, glycerin, triethyl citrate, triacetin, triglycerides, liquid waxes, propylene glycol derivatives (e.g., polypropylene glycols or ethylene oxide/propylene oxide copolymers), ethylene glycol derivatives (e.g., polyethylene glycols or ethylene oxide/propylene oxide copolymers), other alcohols or ethers, or any combination thereof.
1.7 Composition 1, or any of composition 1.1 to 1.6, wherein the composition is a liquid.
1.8 Composition 1, or any of compositions 1.1 to 1.6, wherein the composition is a soft or waxy solid.
1.9 Composition 1, or any of compositions 1.1-1.8, wherein the composition further comprises one or more of a polymer, gelling agent, powdery substrate, surfactant, emollient, plasticizer, wetting agent, swelling agent, or active agent (e.g., an oral care active or a medicinal active agent), or any other additives as described herein.
1.10 Composition 1, or any of Compositions 1.1-1.9, wherein the composition does not comprise any ingredient or component that would not be safe for ingestion, application to the oral cavity, or topical application to the skin or hair,
1.11 Composition 1, or any of Compositions 1.1-1.10, wherein the composition does not comprise any ingredient or component which is unsafe for, or not approved for, use in a food, cosmetic composition, pharmaceutical composition, oral care composition, or consumer cleaning composition.

As used herein, the term “fragrance composition” means a mixture of fragrance ingredients (e.g., including any one or more of Compounds 6 to 999 in free base or salt form, as described any embodiments hereinabove) with one or more carriers or excipients, which carriers or excipients are non-toxic, orally acceptable, pharmaceutically acceptable, cosmetically acceptable, acceptable for a household product, or otherwise acceptable for the intended purpose of the Composition, such as solvents. For example, the fragrance ingredient(s) may be dissolved in a suitable solvent or mixed with a powdery substrate, with additional auxiliary substances added (e.g., additives), if desired. A fragrance composition is used, and intended to be used, to provide or impart a desired odor or aroma to a product, such as a cosmetic product or household product (e.g., household cleaners). Thus, a fragrance composition is used as an ingredient or component in a final product, such as a cosmetic product or consumer product, for which a particular fragrance is desired. Examples of products having fragrance compositions include, but are not limited to, perfumes, soaps, insect repellants and insecticides, detergents, household cleaning agents, air fresheners, room sprays, pomanders, candles, cosmetics, toilet waters, pre- and aftershave lotions, talcum powders, hair-care products, body deodorants, anti-perspirants, and pet litter. A fragrance composition should have enough of its fragrance ingredients so that it is effective to provide the desired odor or aroma to the final product, and this depends both on the concentration of the fragrance ingredient(s) in the composition and the concentration of the composition used in the product.

In some embodiments, the term “fragrance composition” may embrace a composition comprising a fragrance ingredient (e.g., including any one or more of Compounds 6 to 999 in free base or salt form, as described any embodiments hereinabove) which has a poor, unpleasant, noxious, or offensive odor. Such compositions find use as odorants added to flammable or hazardous gases which are otherwise odorless, e.g., as a warning (e.g., odorants for natural gas). Such compositions may also be used when it is necessary or desirous to mimic the smell of a toxic or dangerous substance without exposure to such a substance, such as in training scenarios or for dramatic recreations (e.g., in motion picture media). Such compositions may comprise a compound of the present disclosure in admixture with any suitable carrier or solvent for the purpose intended, such as, a flammable or hazardous gas (e.g., natural gas), or an inert carrier gas (e.g., air, nitrogen), or inert liquid carrier (e.g., water or alcohols, such as for spray application).

As used herein, the term “flavor composition” means a mixture of flavor ingredients (e.g., including any one or more of Compounds 6 to 999 in free base or salt form, as described any embodiments hereinabove) with one or more carriers or excipients, which carriers or excipients are non-toxic, orally acceptable, pharmaceutically acceptable, cosmetically acceptable, acceptable for a household product, or otherwise acceptable for the intended purpose of the Composition, such as solvents. For example, the flavor ingredient(s) may be dissolved in a suitable solvent or mixed with a suitable solid, semi-solid, or liquid excipients, with additional auxiliary substances added (e.g., additives), if desired. A flavor composition is used, and intended to be used, to provide or impart a desired flavor and aroma to a product, such as a food product or oral pharmaceutical product. Thus, a flavor composition is used as an ingredient or component in a final product, such as a food or oral pharmaceutical product, for which a particular flavor is desired. Examples of products having flavor compositions include, but are not limited to, oral care compositions (e.g., dental hygiene products such as mouth wash, toothpaste, floss, and breath fresheners), pharmaceutical compositions (e.g., orally administered medications including liquids, tablets or capsules), and food products. A flavor composition should have enough of its flavor ingredients so that it is effective to provide the desired flavor and aroma to the final product, and this depends both on the concentration of the flavor ingredients in the composition and the concentration of the composition used in the product.

Fragrance and flavor ingredients and mixtures of fragrance and flavor ingredients that may be used in combination with the Compounds of the Disclosure for the manufacture of fragrance and flavor compositions include, but are not limited to, natural products including extracts, animal products and essential oils, absolutes, resinoids, resins, and concretes, and synthetic fragrance materials which include, but are not limited to, alcohols, aldehydes, ketones, ethers, acids, esters, acetals, phenols, ethers, lactones, furansketals, nitriles, acids, and hydrocarbons, including both saturated and unsaturated compounds and aliphatic carbocyclic and heterocyclic compounds, and animal products. As used herein, the terms “fragrance ingredient” and “flavor ingredient” refer to ingredients other than the Compounds 6 to 999, which are used to impart a flavor or a fragrance to a composition or product.

Examples of esters which may be used as fragrance ingredients or flavor ingredients in the compositions and products of the present disclosure include, but are not limited to, acrylic acid esters (methyl, ethyl, etc.), acetoacetic acid esters (methyl, ethyl, etc.), anisic acid esters (methyl, ethyl, etc.), benzoic acid esters (allyl, isoamyl, ethyl, geranyl, linalyl, phenylethyl, hexyl, cis-3-hexenyl, benzyl, methyl, etc.), anthranilic acid esters (cinnamyl, cis-3-hexenyl, methyl, ethyl, linalyl, isobutyl, etc.), N-methylanthranilic acid esters (methyl, ethyl, etc.), isovaleric acid esters (amyl, allyl, isoamyl, isobutyl, isopropyl, ethyl, octyl, geranyl, cyclohexyl, citronellyl, terpenyl, linalyl, cinnamyl, phenylethyl, butyl, propyl, hexyl, benzyl, methyl, rhodinyl, etc.), isobutyric acid esters (isoamyl, geranyl, citronellyl, terpenyl, cinnamyl, octyl, nellyl, phenylethyl, phenylpropyl, phenoxyethyl, butyl, propyl, isopropyl, hexyl, benzyl, methyl, ethyl, linalyl, rhodinyl, etc.), undecylenic acid esters (allyl, isoamyl, butyl, ethyl, methyl, etc.), octanoic acid esters (allyl, isoamyl, ethyl, octyl, hexyl, butyl, methyl, linalyl, etc.), octenoic acid esters (methyl, ethyl, etc.), octynecarboxylic acid esters (methyl, ethyl, etc.), caproic acid esters (allyl, amyl, isoamyl, methyl, ethyl, isobutyl, propyl, hexyl, cis-3-hexenyl, trans-2-hexenyl, linalyl, geranyl, cyclohexyl, etc.), hexenoic acid esters (methyl, ethyl, etc.), valeric acid esters (amyl, isopropyl, isobutyl, ethyl, cis-3-hexenyl, trans-2-hexenyl, cinnamyl, phenylethyl, methyl, etc.), formic acid esters (anisyl, isoamyl, isopropyl, ethyl, octyl, geranyl, citronellyl, cinnamyl, cyclohexyl, terpenyl, phenylethyl, butyl, propyl, hexyl, cis-3-hexenyl, benzyl, linalyl, rhodinyl, etc.), crotonic acid esters (isobutyl, ethyl, cyclohexyl, etc.), cinnamic acid esters (allyl, ethyl, methyl, isopropyl, propyl, 3-phenylpropyl, benzyl, cyclohexyl, methyl, etc.), succinic acid esters (monomethyl, diethyl, dimethyl, etc.), acetic acid esters (anisyl, amyl, α-amylcinnamyl, isoamyl, isobutyl, isopropyl, isobornyl, isoeugenyl, eugenyl, 2-ethylbutyl, ethyl, 3-octyl, p-cresyl, o-cresyl, geranyl, α- or β-santalyl, cyclohexyl, cycloneryl, dihydrocuminyl, dimethyl benzyl carbinyl, cinnamyl, styralyl, decyl, dodecyl, terpenyl, guainyl, neryl, nonyl, phenyl ethyl, phenylpropyl, butyl, furfuryl, propyl, hexyl, cis-3-hexenyl, trans-2-hexenyl, cis-3-nonenyl, cis-6-noneyl, cis-3-cis-6-nonadienyl, 3-methyl-2-butenyl, heptyl, benzyl, bomyl, myrcenyl, dihydromyrcenyl, myrtenyl, methyl, 2-methylbutyl, menthyl, linalyl, rhodinyl, etc.), salicylic acid esters (allyl, isoamyl, phenyl, phenylethyl, benzyl, ethyl, methyl, etc.), cyclohexylalkanoic acid esters (ethyl cyclohexylacetate, allyl cyclohexylpropionate, allyl cyclohexylbutyrate, allyl cyclohexylhexanoate, allyl cyclohexyldecanoate, allyl cyclohexylvalerate, etc.), stearic acid esters (ethyl, propyl, butyl, etc.), sebacic acid esters (diethyl, dimethyl, etc.), decanoic acid esters (isoamyl, ethyl, butyl, methyl, etc.), dodecanoic acid esters (isoamyl, ethyl, butyl, etc.), lactic acid esters (isoamyl, ethyl, butyl, etc.), nonanoic acid esters (ethyl, phenylethyl, methyl, etc.), nonenoic acid esters (allyl, ethyl, methyl, etc.), hydroxyhexanoic acid esters (ethyl, methyl, etc.), phenylacetic acid esters (isoamyl, isobutyl, ethyl, geranyl, citronellyl, cis-3-hexenyl, methyl, etc.), phenoxyacetic acid esters (allyl, ethyl, methyl, etc.), furancarboxylic acid esters (ethyl furancarboxylate, methyl furancarboxylate, hexyl furancarboxylate, isobutyl furan carboxylate, etc.), propionic acid esters (anisyl, allyl, ethyl, amyl, isoamyl, propyl, butyl, isobutyl, isopropyl, benzyl, geranyl, cyclohexyl, citronellyl, cinnamyl, tetrahydrofurfuryl, tricyclodecenyl, heptyl, bornyl, methyl, menthyl, linallyl, terpenyl, α-methylpropionyl, β-methylpropionyl, etc.), heptanoic acid esters (allyl, ethyl, octyl, propyl, methyl, etc.), heptenecarboxylic acid esters (allyl, ethyl, propyl, methyl, etc.), myristic acid esters (isopropyl, ethyl, methyl, etc.), phenylglycidic acid esters (ethyl phenylglycidate, ethyl 3-methylphenylglycidate, ethyl p-methyl-β-phenylglycidate, etc.), 2-methylbutyric acid esters (methyl, ethyl, octyl, phenyl ethyl, butyl, hexyl, benzyl, etc.), 3-methylbutyric acid esters (methyl, ethyl, etc.), butyric acid esters (anisyl, amyl, allyl, isoamyl, methyl, ethyl, propyl, octyl, guainyl, linallyl, geranyl, cyclohexyl, citronellyl, cinnamyl, nellyl, terpenyl, phenylpropyl, β-phenylethyl, butyl, hexyl, cis-3-hexenyl, trans-2-hexenyl, benzyl, rhodinyl, etc.), and hydroxybutyric acid esters (methyl, ethyl, menthyl or the like of 3-hydroxybutyric acid esters).

Examples of alcohols which may be used as fragrance ingredients or flavor ingredients, or as solvents, in the compositions and products of the present disclosure include, but are not limited to, aliphatic alcohols (isoamyl alcohol, 2-ethylhexanol, 1-octanol, 3-octanol, 1-octene-3-ol, 1-decanol, 1-dodecanol, 2,6-nonadienol, nonanol, 2-nonanol, cis-6-nonenol, trans-2, cis-6-nonadienol, cis-3, cis-6-nonadienol, butanol, hexanol, cis-3-hexenol, trans-2-hexenol, 1-undecanol, heptanol, 2-heptanol, 3-methyl-1-pentanol, etc.); terpene alcohols (borneol, isoborneol, carveol, geraniol, α- or β-santalol, citronellol, 4-thujanol, terpineol, 4-terpineol, nerol, myrcenol, myrtenol, dihydromyrcenol, tetrahydromyrcenol, nerolidol, hydroxycitronellol, farnesol, perilla alcohol, rhodinol, linalool, etc.); and aromatic alcohols (anisic alcohol, α-amylcinnamic alcohol, isopropylbenzylcarbinol, carvacrol, cumin alcohol, dimethylbenzylcarbinol, cinnamic alcohol, phenyl allyl alcohol, phenylethylcarbinol, β-phenylethyl alcohol, 3-phenylpropyl alcohol, benzyl alcohol, etc.).

Examples of aldehydes which may be used as fragrance ingredients or flavor ingredients in the compositions and products of the present disclosure include, but are not limited to, aliphatic aldehydes (acetaldehyde, octanal, nonanal, decanal, undecanal, 2,6-dimethyl-5-heptanal, 3,5,5-trimethylhexanal, cis-3, cis-6-nonadienal, trans-2, cis-6-nonadienal, valeraldehyde, propanal, isopropanal, hexanal, trans-2-hexenal, cis-3-hexenal, 2-pentenal, dodecanal, tetradecanal, trans-4-decenal, trans-2-tridecenal, trans-2-dodecenal, trans-2-undecenal, 2,4-hexadienal, cis-6-nonenal, trans-2-nonenal, 2-methylbutanal, etc.); aromatic aldehydes (anisic aldehyde, α-amylcinnamic aldehyde, α-methylcinnamic aldehyde, cyclamen aldehyde, p-isopropylphenylacetaldehyde, ethylvanillin, cumin aldehyde, salicylaldehyde, cinnamic aldehyde, o-, m- or p-tolylaldehyde, vanillin, piperonal, phenylacetaldehyde, heliotropin, benzaldehyde, 4-methyl-2-pheny-2-pentenal, p-methoxycinnamic aldehyde, p-methoxybenzaldehyde, etc.); and terpene aldehydes (geranial, citral, citronellal, α-sinensal, β-sinensal, perillaldehyde, hydroxycitronellal, tetrahydrocitral, myrtenal, cyclocitral, isocyclocitral, citronellyloxyacetaldehyde, neral, α-methylenecitronellal, myrac aldehyde, vernaldehyde, safranal, etc.).

Examples of ketones which may be used as fragrance ingredients or flavor ingredients in the compositions and products of the present disclosure include, but are not limited to, cyclic ketones (1-acetyl-3,3-dimethyl-1-cyclohexene, cis-jasmone, α-, ρ- or γ-irone, ethyl maltol, cyclotene, dihydronootkatone, 3,4-dimethyl-1,2-cyclopentadione, sotolon, α-, β-, γ- or δ-damascone, α-, β- or γ-damascenone, nootkatone, 2-sec-butylcyclohexanone, maltol, α-, β- or γ-ionone, α-, β- or γ-methylionone, α-, β- or γ-isomethylionone, furaneol, camphor, etc.); aromatic ketones (acetonaphthone, acetophenone, anisylideneacetone, raspberry ketone, p-methyl acetophenone, anisylacetone, p-methoxy acetophenone, etc.); and chain ketones (diacetyl, 2-nonanone, diacetyl, 2-heptanone, 2,3-heptanedione, 2-pentanone, methyl amyl ketone, methyl nonyl ketone, β-methyl naphthyl ketone, methyl heptanone, 3-heptanone, 4-heptanone, 3-octanone, 2,3-hexanedione, 2-undecanone, dimethyloctenone, 6-methyl-5-hepten-2-one, etc.).

Examples of acetals which may be used as fragrance ingredients or flavor ingredients in the compositions and products of the present disclosure include, but are not limited to, acetaldehyde diethyl acetal, acetaldehyde diamyl acetal, acetaldehyde dihexyl acetal, acetaldehyde propylene glycol acetal, acetaldehyde ethyl cis-3-hexenyl acetal, benzaldehyde glycerin acetal, benzaldehyde propylene glycol acetal, citral dimethyl acetal, citral diethyl acetal, citral propylene glycol acetal, citral ethylene glycol acetal, phenylacetaldehyde dimethyl acetal, citronellyl methyl acetal, acetaldehyde phenylethylpropyl acetal, hexanal dimethyl acetal, hexanal dihexyl acetal, hexanal propylene glycol acetal, trans-2-hexenal diethyl acetal, trans-2-hexenal propylene glycol acetal, cis-3-hexenal diethyl acetal, heptanal diethyl acetal, heptanal ethylene glycol acetal, octanal dimethyl acetal, nonanal dimethyl acetal, decanal dimethyl acetal, decanal diethyl acetal, 2-methylundecanal dimethyl acetal, citronellal dimethyl acetal, Ambersage (manufactured by Givaudan), ethyl acetoacetate ethylene glycol acetal, and 2-phenylpropanal dimethyl acetal.

Examples of phenols which may be used as fragrance ingredients or flavor ingredients in the compositions and products of the present disclosure include, but are not limited to, eugenol, isoeugenol, 2-methoxy-4-vinylphenol, thymol, carvacrol, guaiacol, and chavicol, and vanillin.

Examples of ethers and epoxides which may be used as fragrance ingredients or flavor ingredients in the compositions and products of the present disclosure, but are not limited to, anethole, 1,4-cineole, dibenzyl ether, linalool oxide, limonene oxide, nerol oxide, rose oxide, methyl isoeugenol, methyl chavicol, isoamyl phenyl ethyl ether, β-naphthyl methyl ether, phenyl propyl ether, p-cresyl methyl ether, vanillyl butyl ether, α-terpinyl methyl ether, citronellyl ethyl ether, geranyl ethyl ether, rose furan, theaspirane, decylmethyl ether, and methylphenyl methyl ether.

Examples of lactones which may be used as fragrance ingredients or flavor ingredients in the compositions and products of the present disclosure include, but are not limited to, γ- or δ-decalactone, γ-heptalactone, γ-nonalactone, γ- or δ-hexylactone, γ- or δ-octalactone, γ- or δ-undecalactone, δ-dodecalactone, δ-2-decenolactone, methyl lactone, 5-hydroxy-8-undecenoic acid δ-lactone, jasmine lactone, menthalactone, dihydrocoumarin, octahydrocoumarin, and 6-methylcoumarin.

Examples of furans which may be used as fragrance ingredients or flavor ingredients in the compositions and products of the present disclosure include, but are not limited to, furan, 2-methylfuran, 3-methylfuran, 2-ethylfuran, 2,5-diethyltetrahydrofuran, 3-hydroxy-2-methyltetrahydrofuran, 2-(methoxymethyl)furan, 2,3-dihydrofuran, furfural, 5-methylfurfural, 3-(2-furyl)-2-methyl-2-propenal, 5-(hydroxymethyl)furfural, 2,5-dimethyl-4-hydroxy-3(2H)-furanone (furaneol), 4,5-dim ethyl-3-hydroxy-2(5H)-furanone (sotolon), 2-ethyl-4-hydroxy-5-methyl-3(2H)-furanone (homofuraneol), 5-ethyl-3-hydroxy-4-methyl-2(5H)-furanone (homosotolon), 3-methyl-1,2-cyclopentanedione (cyclotene), 2(5H)-furanone, 4-methyl-2(5H)-furanone, 5-methyl-2(5H)-furanone, 2-methyl-3(2H)-furanone, 5-methyl-3(2H)-furanone, 2-acetylfuranone, 2-acetyl-5-methylfuran, furfuryl alcohol, methyl 2-furancarboxylate, ethyl 2-furancarboxylate, and furfuryl acetate.

Examples of hydrocarbons which may be used which may be used as fragrance ingredients or flavor ingredients in the compositions and products of the present disclosure include, but are not limited to, α- or β-bisabolene, β-caryophyllene, p-cymene, terpinene, terpinolene, cadinene, cedrene, longifolene, farnesene, limonene, ocimene, myrcene, α- or β-pinene, 1,3,5-undecatriene and valencene.

Examples of acids that may be used which may be used as fragrance ingredients or flavor ingredients in the compositions and products of the present disclosure include, but are not limited to, geranic acid, dodecanoic acid, myristic acid, stearic acid, lactic acid, phenylacetic acid, pyruvic acid, trans-2-methyl-2-pentenoic acid, 2-methyl-cis-3-pentenoic acid, 2-methyl-4-pentenoic acid, and cyclohexanecarboxylic acid.

The fragrance and flavor compositions of the application may comprise as additional fragrance or flavor ingredients one or more natural extracts or oils including, but not limited to, anise, orange, lemon, lime, mandarin, petitgrain, bergamot, lemon balm, grapefruit, elemi, olibanum, lemongrass, neroli, marjoram, angelica root, star anise, basil, bay, calamus, chamomile, caraway, cardamom, cassia, cinnamon, pepper, perilla, cypress, oregano, cascarilla, ginger, parsley, pine needle, sage, hyssop, tea tree, mustard, horseradish, clary sage, clove, cognac, coriander, estragon, eucalyptus, fennel, guaiac wood, dill, cajuput, wormseed, pimento, juniper, fenugreek, garlic, laurel, mace, myrrh, nutmeg, spruce, geranium, citronella, lavender, lavandin, palmarosa, rose, rosemary, sandalwood, oakmoss, cedarwood, vetiver, linaloe, bois de rose, patchouli, labdanum, cumin, thyme, ylang ylang, birch, capsicum, celery, tolu balsam, genet, immortelle, benzoin, jasmine, cassie, tuberose, reseda, marigold, mimosa, opoponax, orris, vanilla and licorice. Each of these natural extracts or oils comprises a complex mixture of chemical compounds, which may include those compounds described above. Additional fragrance ingredients may be isolated from natural products, for example, geraniol and citronellal may be isolated from citronella oil, citral may be isolated from lemon-grass oil, eugenol may be isolated from clove oil, and linalool may be isolated from rosewood oil. Animal products used in fragrance compositions include, but are not limited to, musk, ambergris, civet and castoreum. The natural ingredients described herein may also be produced synthetically, and may include the compounds disclosed herein, and be used as fragrance and/or flavor ingredients in the fragrance and flavor compositions of the present application.

Examples of fragrance ingredients used in perfumes, air fresheners, laundry detergents, pet litters, cleaning products, liquid and bar soaps, shampoos and conditioners, cosmetics, deodorants, and personal hygiene products include, but are not limited to: hexyl cinnamic aldehyde; amyl cinnamic aldehyde; amyl salicylate; hexyl salicylate; terpineol; 3,7-dimethyl-cis-2,6-octadien-1-ol; 2,6-dimethyl-2-octanol; 2,6-dimethyl-7-octen-2-ol; 3,7-dimethyl-3-octanol; 3,7-dimethyl-trans-2,6-octadien-1-ol; 3,7-dimethyl-6-octen-1-ol; 3,7-dimethyl-1-octanol; 2-methyl-3-(para-tert-butylphenyl)-propionaldehyde; 4-(4-hydroxy-4-methylpentyl)-3-cyclohexene-1-carboxaldehyde; tricyclodecenyl propionate; tricyclodecenyl acetate; anisaldehyde; 2-methyl-2-(para-iso-propylphenyl)-propionaldehyde; ethyl-3-methyl-3-phenyl glycidate; 4-(para-hydroxyphenyl)-butan-2-one; 1-(2,6,6-trimethyl-2-cyclohexen-1-yl)-2-buten-1-one; para-methoxyacetophenone; para-methoxy-alpha-phenylpropene; methyl-2-n-hexyl-3-oxo-cyclopentane carboxylate; undecalactone gamma, geraniol; geranyl acetate; linalool; linalyl acetate; tetrahydrolinalool; citronellol; citronellyl acetate; dihydromyrcenol; dihydromyrcenyl acetate; tetrahydromyrcenol; terpinyl acetate; nopol; nopyl acetate; 2-phenylethanol; 2-phenylethyl acetate; benzyl alcohol; benzyl acetate; benzyl salicylate; benzyl benzoate; styrallyl acetate; dimethylbenzylcarbinol; trichloromethylphenylcarbinyl; methylphenylcarbinyl acetate; isononyl acetate; vetiveryl acetate; vetiverol; 2-methyl-3-(p-tert-butylphenyl)-propanal; 2-methyl-3-(p-isopropylphenyl)-propanal; 3-(p-tert-butylphenyl)-propanal; 4-(4-methyl-3-pentenyl)-3-cyclohexenecarbaldehyde; 4-acetoxy-3-pentyltetrahydropyran; methyl dihydrojasmonate; 2-n-heptylcyclopentanone; 3-methyl-2-pentyl-cyclopentanone; n-decanal; n-dodecanal; 9-decenol-1; phenoxyethyl isobutyrate; phenylacetaldehyde dimethyl acetal; phenylacetaldehyde diethyl acetal; geranonitrile; citronellonitrile; cedryl acetal; 3-isocamphylcyclohexanol; cedryl methyl ether; isolongifolanone; aubepine nitrile; aubepine; heliotropine; eugenol; vanillin; diphenyl oxide; hydroxycitronellal ionones; methyl ionones; isomethyl ionones; irones; cis-3-hexenol and esters thereof; indane musk fragrances; tetralin musk fragrances; isochroman musk fragrances; macrocyclic ketones; macrolactone musk fragrances; and ethylene brassylate.

The fragrance and flavor ingredients in a given product's fragrance or flavor composition are selected based on the intended use of the product and the product's desired aroma. For example, flavor ingredients used in toothpaste, mouth wash, and dental hygiene products may be selected to impart “freshness” and include, but are not limited to, spearmint oil, peppermint oil, star anise oil, lemon oil, and menthol.

Flavor compositions may be used to mask the unpleasant taste of orally administered medications. For example, if a medication is salty, a flavor composition that has cinnamon, raspberry, orange, maple, butterscotch, or glycyrrhiza (licorice) flavor may be used to mask the taste. If a medication is overly sweet, a flavor composition that has a berry, vanilla, or acacia flavor may render the medication more palatable. In the case of bitter tasting medications, flavor compositions that have cocoa, chocolate-mint, wild cherry, walnut, glycyrrhiza (licorice), and eriodictyon flavors might be used, whereas sour medications may be improved by flavor compositions that have fruity, citrus, or cherry flavors. These flavors may be provided by the natural or synthetic flavor ingredients discussed herein.

Examples of flavor ingredients used in flavor compositions for food products also include, but are not limited to, glucosyl steviol glycosides, isomenthols, carbonothoic acids, cassyrane, 1,5-octadien-3-ol, 2-mercaptoheptan-4-ol, 4 3-(methylthio)decanal, (4Z,7Z)-trideca-4,7-dienal, persicaria odorata oil, Amacha leaves extract, glutamyl-2-aminobutyric acid, glutamyl-2-aminobutyric acid, glutamyl-norvalyl-glycine, glutamyl-norvaline, N1-(2,3-Dimethoxybenzyl)-N2-(2-(pyridin-2-yl)ethyl) oxalamide, 1-(2-hydroxy-4-methylcyclohexyl)ethanone, Mexican lime oil, Persian lime oil, 6-methoxy-2,6-dimethylheptanal, 3,5-undecadien-2-one, 2,5-undecadien-1-ol, triethylthialdine. 4-methylpentyl 4-methylvalerate, (R)—N-(1-methoxy-4-methylpentan-2-yl)-3,4-dimethylbenzamide, 2 N-acetyl glutamate, 1,3-propanediol, Szechuan pepper extract, Tasmannia lanceolata extract, Mentha longifolia oil, mangosteen distillate, ethyl 3-(2-hydroxyphenyl)propanoate, 1-cyclopropanemethyl-4-methoxybenzene, prenyl thioisobutyrate, prenyl thioisovalerate, matairesinol, stevioside, 1-(2,4-dihydroxyphenyl)-3-(3-hydroxy-4-methoxyphenyl)propan-1-one, ethyl 5-formyloxydecanoate, 3-[3-(2-isopropyl-5-methyl-cyclohexyl)ureido]butyric acid ethyl ester, 2-Isopropyl-4-methyl-3-thiazoline, 2,6,10-trimethyl-9-undecenal, 5-mercapto-5-methyl-3-hexanone, Meyer lemon oil, teviol glycoside extract, Stevia rebaudiana, rebaudioside A 60%, rubescenamine, 4-amino-5-(3-(isopropylamino)-2,2-dimethyl-3-oxopropoxy)-2-methylquinoline-3-carboxylic acid, 3-methyl-5-(2,2,3-trimethylcyclopent-3-en-1-yl)pent-4-en-2-ol, (1-Methyl-2-(1,2,2-trimethylbicyclo[3.1.0]hex-3-ylmethyl)cyclopropyl)methanol, erospicata oil, and curly mint oil. See L. J. Mamett et al., GRAS Flavoring Substances 26, Food Technology, 44-45 (2013).

Preferred solvents and excipients for use in the compositions and products of the present disclosure include, but are not limited to, triethyl citrate, triacetin, glycerol, propylene glycol, dipropylene glycol, isopropyl myristate, ethanol, water, triglycerides, liquid waxes, propylene glycol derivatives (e.g., polymers), and ethylene glycol derivatives (e.g., polymers).

The amount of a given fragrance or flavor ingredient in a fragrance or flavor composition cannot be categorically described because it varies depending on the type product being scented or flavored, the intended use of the product, and the desired aroma and/or taste of the product. The amount of a fragrance or flavor ingredient in a fragrance or flavor composition is usually in the range of from about 1% to about 99% by mass of the fragrance composition. When the amount of the ingredient is too small, a sufficient strength of the scent or flavor may not be obtained. Further, when the amount of the ingredient is too large, a larger amount of the agent(s) needed to solubilize the ingredient may be needed, which may in turn reduce the desired aromatic or flavor properties of the end product by inhibiting volatilization or other mechanisms by which the flavor or fragrance is dispersed when the product is used or consumed. The amount of each of the fragrance and flavor ingredients in a given fragrance or flavor composition must therefore be selected based upon the aromatic and/or flavor characteristics of the selected ingredient, the overall composition of the product, and the intended aromatic and/or flavor effect.

Additives may be used in the flavor and fragrance compositions of the present disclosure. Additives that may be used include, but are not limited to, solvents, surfactants, pH adjusters, buffers, thickening agents, desiccants, emulsifiers, foaming agents, stabilizers, antioxidants, and disintegrating agents. Other fragrance and flavor composition additives will be selected in accordance with the intended use of the composition.

Solvents, for example water-soluble organic solvents, which may be used in the flavor and fragrance compositions of the present disclosure include, but are not limited to, ethanol, propanol, isopropanol, butanol, 3-methoxy-3-methyl-1-butanol, benzyl alcohol, ethyl carbitol (diethylene glycol monoethyl ether), ethylene glycol, propylene glycol, dipropylene glycol, butylene glycol, hexylene glycol, glycerin, ethylene glycol monomethyl ether, propylene glycol monomethyl ether, propylene glycol monoethyl ether, and dipropylene glycol monomethyl ether. These water-soluble solvents may be used solely or in combination. The content of the water-soluble organic solvent in the compositions of the application may be determined according to the desired composition properties, and is usually from about 1% to about 99% by mass.

Oil-soluble organic solvents which may be used with the flavor and fragrance compositions of the application include, but are not limited to, isoparaffin, paraffin, limonene, pinene, triethyl citrate, benzyl benzoate, isopropyl myristate, triacetin, and silicone.

Preferred solvents include, but are not limited to, triethyl citrate, triacetin, glycerol, ethanol, water, triglycerides, liquid waxes, propylene glycol derivatives, and ethylene glycol derivatives.

In some embodiments, the flavor and fragrance compositions and products of the present disclosure may further comprise other substances, including, but not limited to, sequestering agents, preservatives, antioxidants, deodorizers, sterilization agents, ultraviolet absorbers, pH adjusters, insecticidal components, components for protection from insects, insect repellents, colorants, excipients, and buffers. The substances used in, or in addition to, the fragrance and flavor compositions of the present application may be determined by the product in which the composition is included. When the substance is used in a flavor or fragrance composition, it may be an additive. When the substance is used alongside a flavor or fragrance composition, it may be considered as part of a product composition that comprises a fragrance or flavor composition.

Excipients that may be used in the fragrance and flavoring compositions and products of the present disclosure may vary depending on the use of the intended product and its overall composition. In some instances, the excipient may be included in the fragrance or flavor composition or may, alternatively, be independent of the composition. Excipients used in or with flavoring compositions of an orally administered medication may include, but are not limited to, tablet coatings, such as a cellulose ether hydroxypropyl methylcellulose, synthetic polymer, shellac, corn protein zein or other polysaccharides, and gelatin. In contrast, cosmetic excipients may include, but are not limited to, Carbopol 940 ETD, triethanolamine, purified water, glycerin, imidazolidinyl urea, EDTA, polyvinyl alcohol, methyl parabens phenoxyethanol 0, ethyl alcohol 1, peg 7 glyceryl cocoate, peg 6 triglyceryl caproic glycerides, acemulogar LAM V, isopropyl myristate, tegosoft CT, xanthan gum, sepicide CL, polyquaternium 7, and Vaseline oils. Additional suitable excipients for use with or in a flavor and/or fragrance composition for a given product will be readily selected by those having ordinary skill in the art.

Buffers that may be used with the fragrance and flavoring compositions of the present application may vary depending on the use of the intended product and its overall composition. In some instances, the buffer may be included in the fragrance or flavor composition or may, alternatively, be independent of the composition. Examples of buffers that may be used in or with the fragrance and flavor compositions of the application include, but are not limited to, citrates, acetates, and phosphates. For example, trisodium citrate may be used as a flavor or as a preservative, and is known to impart tartness to a flavor, but also acts as a buffer. Trisodium citrate is an ingredient in a variety of sodas and other beverages, as well as drink mixes and bratwurst. In cosmetic products, disodium hydrogen phosphate, potassium dihydrogen phosphate, disodium hydrogen phosphate and, and citric acid may be used to buffer the pH of the product. In toothpaste, calcium carbonate and/or dicalcium phosphate may be used as pH buffers. Additional suitable buffers for use with or in a flavor and/or fragrance composition for a given product will be readily selected by those having ordinary skill in the art.

In a third aspect, the present disclosure provides a product which comprises any one or more of Compounds 6 to 999 in free base or salt form, as described any embodiments hereinabove. In some embodiments, the product may be selected from the following: personal care products (e.g., a soap, skin cream or lotion, balm, shampoo, body wash, shower gel, hydrating cream, deodorant, antiperspirant, after-shave lotion, cologne, perfume, or other hair care or skin care product), sunscreens, insect repellants and insecticides, detergents, household cleaning agents (e.g., a surface cleaner, a metal cleaner, a wood cleaner, a glass cleaner, a body cleaner such as a soap, a dish-washing detergent, or a laundry detergent), air fresheners, room sprays, pomanders, candles, cosmetics (e.g., perfumes, colognes, nail polish, eye liner, mascara, lipstick, foundation, concealer, blush, bronzer, eye shadow, lip liner, lip balm), toilet waters, talcum powders, and pet litter.

Having now described some embodiments of the application, it should be apparent to those skilled in the art that the foregoing is merely illustrative and not limiting, having been presented by way of example only. The embodiments of the application can therefore be in other specific forms without departing from the spirit or essential characteristics thereof.

Those skilled in the art should recognize or be able to ascertain, using no more than routine experimentation, equivalents to the specific embodiments of the application. It is therefore to be understood that the embodiments described herein are presented by way of example only and that the scope of the application is thus indicated by the appended claims and equivalents thereto, and that the application may be practiced otherwise than as specifically described in the foregoing description.

The term “about,” when used to describe one of the compositions of the application, refers to a recited percentage ±5%, ±4%, ±3%, ±2.5%, ±2%, ±1.5%, ±1%, ±0.75%, ±0.5%, ±0.25%, or ±0.1%. In one embodiment, the term “about,” refers to a recited percentage ±5%. For example, “about 50%” refers to the range 45% to 55%. In one embodiment, the term “about,” refers to a recited percentage ±2.5%. In one embodiment, the term “about,” refers to a recited percentage ±1%. In one embodiment, the term “about,” refers to a recited percentage ±0.5%. In one embodiment, the term “about,” refers to a recited percentage ±0.1%.

As used herein, the singular forms “a,” “an,” and “the” include plural referents unless the context clearly dictates otherwise. Thus, for example, reference to “a fragrance ingredient” includes not only a single fragrance ingredient but also a combination or mixture of two or more different fragrance ingredients, reference to “an additive” includes a single additive as well as two or more additives, and the like.

As used herein, the phrases “for example,” “for instance,” “such as,” or “including” are meant to introduce examples that further clarify more general subject matter. These examples are provided only as an aid for understanding the disclosure, and are not meant to be limiting in any fashion. Furthermore, as used herein, the terms “may,” “optional,” “optionally,” or “may optionally” mean that the subsequently described circumstance may or may not occur, so that the description includes instances where the circumstance occurs and instances where it does not. For example, the phrase “optionally present” means that an object may or may not be present, and, thus, the description includes instances wherein the object is present and instances wherein the object is not present.

The term “compound,” as used herein, unless otherwise indicated, refers to any specific chemical compound disclosed herein, or a salt, solvate, or co-crystal thereof, and includes tautomers, and where applicable, stereoisomers, including optical isomers (enantiomers) and other stereoisomers (diastereomers) thereof. Within its use in context, the term compound generally refers to a single compound, but also may include other compounds such as stereoisomers and/or optical isomers (including racemic mixtures) as well as specific enantiomers or enantiomerically enriched mixtures of disclosed compounds. The term also refers to any specific chemical compound in which one or more atoms have been replaced with one or more different isotopes of the same element (e.g., compounds having deuterium, atom incorporation or radiolabel incorporation).

The entire disclosure of each of the patent documents and scientific articles referred to herein is incorporated by reference in its entirety for all purposes. The function and advantages of these and other embodiments will be more fully understood from the following non-limiting examples. The examples are intended to be illustrative in nature and are not to be considered as limiting the scope of the embodiments discussed herein.

### Examples

The Compounds of the Disclosure are known and commercially available, and means for their chemical synthesis has been previously known or disclosed, although they are believed to have not been previously disclosed as flavor or fragrance ingredients, or for use in flavor or fragrance compositions.

As part of the evaluation and validation of a novel artificial-intelligence driven software model to map molecular structures to odor perception, a set of 400 commercially available chemical compounds of diverse structure were obtained and submitted to analysis by the model to generate a predicted odor profile on each compound. A cohort of subjects were also trained to describe their perception of odorants using the Rate-All-That-Apply method (RATA) and a 55-word odor lexicon, and a group of the subjects were selected to sit on an odor evaluation panel. The results of the analysis by the panel were compared to the odor map generated by the model in order to validate the model.

During training sessions for the subjects, each term in the lexicon was paired with visual and odor references. Only subjects that met performance standards on the pretest of 20 common odorants (individual test-retest correlation R>0.35; reasonable label selection for common odorants) were invited to join the panel. The 55 descriptors in the lexicon were organized so that perceptually similar terms were close together in the list (terms below are listed in the order they appeared on subjects' ratings ballots). Each term was paired with at least one aroma reference to facilitate rater training. The terms woody, floral, and spicy, each had a second aroma reference. The selected lexicon terms, and their aroma references, are shown in Table 5 below:

| Lexicon Term | Aroma References |
|---|---|
| green | Le Nez Du Vin aroma standard-Vegetal |
| grassy | 2% cis-3-hexenol solution |
| cucumber | 1% nona-2,6-dienal solution |
| tomato | AromaMasters aroma standard-Tomato |
| hay | Animal bedding |
| herbal | Herbs de Provence; Dried dill |
| mint | Dried mint |
| woody | AromaMasters aroma standard-Cedar; |
| | Pine shavings |
| pine | 5% alpha-pinene solution |
| floral | AromaMasters aroma standard-Linden; |
| | AromaMasters aroma standard-Honeysuckle |
| jasmine | Jasmine essential oil |
| rose | Rose water |
| honey | Honey |
| fruity | Good & Gather flavor fusion fruit strips |
| citrus | Combined essential oils of orange, |
| | grapefruit, lime, and lemon |
| Lemon | Lemon essential oil |
| orange | Orange essential oil |
| tropical | Trident tropical twist gum |
| berry | Le Nez Du Vin aroma standard-Bilberry |
| peach | Le Nez Du Vin aroma standard-Peach |
| apple | Jolly Rancher-green apple |
| sour | White vinegar |
| fermented | GT’s original kombucha |
| alcoholic | 200 proof ethanol |
| winey | Sutter Home red wine blend |
| rummy | Oakheart spiced rum |
| caramellic | Caramel flavor extract |
| vanilla | Vanilla extract |
| spicy | Blend of ground cinnamon, nutmeg, |
| | cloves, and allspice; Ground black pepper |
| coffee | Folgers medium roast ground coffee |
| smoky | 5% guaiacol solution |
| roasted | Le Nez Du Vin aroma standard-Toasted |
| meaty | Le Nez Du Vin aroma standard-Cooked beef |
| nutty | Roasted mixed nuts |
| fatty | 10% (E,E)-2,4-decadienal solution |
| coconut | AromaMasters aroma standard-Coconut |
| waxy | Crayola crayon |
| dairy | Carnation half & half pods |
| buttery | Butter extract |
| cheesy | Kernel Seasons white cheddar powder |
| sulfurous | Le Nez Du Vin aroma standard - Rotten egg |
| garlic | Garlic powder |
| earthy | Peat moss |
| musty | 0.1% 2,4,6-tribromoanisole solution |
| animal | AromaMasters aroma standard-Horse sweat |
| musk | Solution of galaxolide, |
| | ethylene brassylate, and tonalide |
| powdery | Johnson & Johnson baby powder |
| sweet | Charms cotton candy |
| cooling | Menthol crystals |
| sharp | 10% acetic acid solution |
| medicinal | Vicks VapoRub |
| Camphor | 1% camphor solution |
| metallic | Pennies to be rubbed against skin |
| ozone | Adoxal |
| fishy | 0.5% trimethylamine solution |

A pool of 26 prospective panelists between the ages of 18 and 55 and with a normal sense of smell were recruited to participate in a 5-session series of training and screening exercises. Subjects received odorant kits shortly before the start of the experiment and participated in sessions from home, facilitated by an experimenter over a video call. The initial odorant kit contained 58 odor references (as shown in the above table), 10 blinded odor references used for training quizzes, and 20 common odorants used in screening exercises.

In the first session, subjects were introduced to the study and trained to use the rate-all-that-apply (RATA) method to describe their perception of odorants. In the RATA method, subjects choose from a list of terms that apply to the sample being evaluated, and then rate how strongly the chosen terms apply to the sample from 1 (low/slightly applicable) to 5 (high/very applicable). Subjects were given guidance on how to evaluate the odorants (e.g., take several short sniffs, hold the vial far from the nose to start and gradually bring it closer while sniffing, keep the cap tightly on each vial while not actively evaluating it) and taught to use a standard nasal rinse protocol (wet clean washcloth until just saturated, heat in microwave for 60 s to produce steam, breathe in moist air above washcloth through nose for 30 seconds between evaluations, re-warm washcloth as needed; washcloths were provided with odor kits). Subjects then evaluated 20 common odorants using the RATA method as a pre-test.

In the second and third sessions, researchers trained the subjects on the meaning of labels in the aroma lexicon. For each label, researchers described the olfactory meaning of the label, showed a related image, and prompted subjects to smell the associated odor reference(s). At the end of each session, subjects participated in a quiz in which they tried to identify blinded odor references and mixtures of references. Researchers then revealed the true identity of the blinded references and led a discussion about the results, prompting subjects to re-smell references and reinforce label meanings.

Following training, subjects evaluated the 20 common odorants in the fourth and again in the fifth session. Researchers reviewed subjects' quiz responses label selections for the 20 common odorants and calculated their test-retest correlation for post-training ratings. 18 subjects who met the test-retest criterion (R>0.35), and made reasonable label selections for common odorants (e.g., mint selected to describe (−)-carvone), were invited to join the test panel (12 female, 6 male).

Initially, 580 structurally distinct molecules were purchased for initial evaluation based on price, availability, structure (including atom composition), purity, prediction of non-toxicity, and prediction of likely odor (i.e., compounds with a water-solubility cLogP of greater than 0 and a boiling point under 300° C. Compounds which were deemed likely to degrade or react under the experimental conditions were excluded

From the 580 compounds obtained, each was examined by the researchers, and those which were odorless, or had insufficiently strong order, were not further considered. 400 compounds were selected for evaluation by the panel and the model.

The panelists were asked to rate the applicability of the 55 odor labels for each sample using the RATA method, as well as rate the intensity and pleasantness of each sample (some early rounds of testing did not include the pleasantness question). Panelists received the odorants in sets of 50 and evaluated each twice over 4 sessions (25 evaluations/session). Odorants were blinded with random 3-digit ID codes, and the order in which subjects evaluated the odorants was determined following a Williams Latin Square design. There was an enforced 30 second break between each evaluation, and subjects followed a standard nasal rinse protocol during that break. At least 15 of the initial 18 panelists participated in each phase of the study such that n is greater than or equal to 15 for each odorant*replicate (400 molecules×55 odor classes×15 panelists×2 replicates=660,000 human sensory data points).

Of the 400 molecules selected and characterized by the panel, 77 were ultimately dropped from the final prospective validation for the model set due to low intensity (42), redundancy (2), mistaken inclusion (1), or with confirmed (19) or potential contamination (13). Model performance was only evaluated on the remaining 323 molecules without model retraining.

Molecules with lower rated intensity were found to have the weakest panel test-retest correlations, indicating that the panel was not able to get a consistent evaluation. For validation of the model, any molecules with intensity of less than 3 (on a 0 to 10 scale) were excluded. Of the 400 molecules evaluated by the panel, 42 were dropped from the validation set due to low odor intensity.

To account for the potential presence of odorous contaminants in the 400 commercial compounds purchased for the study, a gas chromatography-mass spectrometry/olfactometry (GC-MS/O) quality control (QC) procedure was developed and applied. Compounds for which a contaminant was suspected as being a major contributor to the overall odor profile were excluded, while compounds for which a contaminant was suspected as being a minor contributor to the overall odor profile were included.

Aggregating all molecules and descriptors, the panel exhibited a test-retest correlation of 0.8. The panel test-retest correlation was high for most descriptors. Compared to a prior large-scale human psychophysical study, our collected dataset has more descriptors and higher panel mean test-retest reliability, even with fewer panelists.

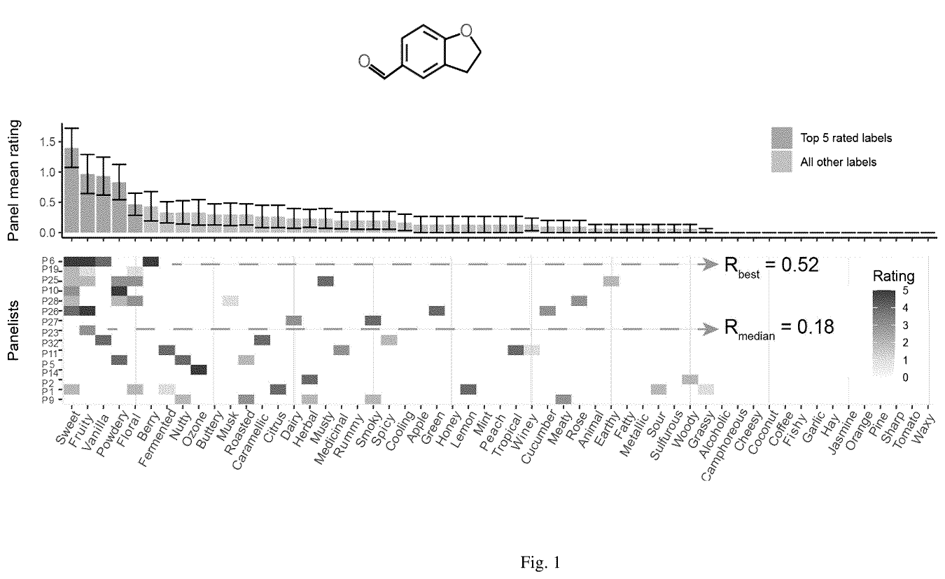

For each of the 400 compounds evaluated by the panelist, results were summarized in the form of panel mean ratings and panel individual ratings for each of the 55 odor labels. An example of such results in shown in FIG. 1 for the molecule 2,3-dihydrobenzofuran-5-carboxaldehyde (Compound 380).

The panelist ratings are found to show a clear correlation to structure. For example, fruity descriptors are more likely to co-occur with each other and less likely to co-occur with other descriptors including meaty, sulfurous, and roasted. Ratings are also related to odorant chemical class. For example, molecules containing a sulfur atom are more likely to be described as meaty, molecules containing an amine group are more likely to be described as fishy, and molecules containing a carboxylic acid group are more likely to be described as sour.

The mean panelist scores for odor “intensity” and odor “pleasantness,” and for the four odor labels “sweet,” “spicy,” “fruity,” and “floral” for 399 compounds is shown in the following, table (Table 6) (the one “mistaken inclusion” compound is omitted):

| ID | Intensity | Pleasantness | Sweet | Spicy | Fruity | Floral |
|---|---|---|---|---|---|---|
| 6 | 7.986 | | 0.278 | 0 | 0.056 | 0.056 |
| 7 | 6.641 | 4.772 | 0.094 | 0.281 | 0 | 0 |
| 12 | 4.45 | | 1.306 | 0.056 | 0.667 | 0.528 |
| 14 | 6.806 | 6.121 | 1.242 | 0.818 | 0.364 | 0.97 |
| 17 | 8.254 | 1.989 | 0.429 | 0.229 | 0 | 0 |
| 18 | 5.106 | | 0.111 | 0.167 | 0.25 | 0.083 |
| 22 | 4.382 | 4.456 | 0 | 0.088 | 0 | 0.206 |
| 29 | 6.053 | 5.947 | 1.375 | 0.031 | 0.75 | 0.469 |
| 30 | 4.966 | 3.647 | 0.125 | 0 | 0 | 0.281 |
| 36 | 6.319 | | 0.222 | 0.167 | 0 | 0.167 |
| 38 | 5.628 | | 0.944 | 0.028 | 0.722 | 0.5 |
| 41 | 6.719 | 5.516 | 0.452 | 0.065 | 0.032 | 0.032 |
| 45 | 6.75 | 5.316 | 1.031 | 0.156 | 0 | 0.031 |
| 47 | 6.953 | 4.519 | 0.312 | 0.344 | 0.219 | 0.156 |
| 50 | 6.085 | 6.527 | 1.909 | 0.121 | 1.394 | 0.485 |
| 61 | 5.603 | 3.997 | 0.097 | 0.258 | 0.032 | 0.226 |
| 63 | 7.772 | 3.903 | 0.75 | 0.469 | 0.594 | 0.281 |
| 64 | 0.742 | | 0 | 0.056 | 0.028 | 0 |
| 76 | 7.156 | 4.531 | 0.844 | 0.375 | 0.75 | 0.156 |
| 79 | 5.9 | 2.948 | 0.273 | 0.303 | 0.061 | 0 |
| 80 | 5.07 | 4.967 | 0.2 | 0.167 | 0 | 0 |
| 82 | 5.981 | | 0.667 | 0.056 | 0.667 | 0.194 |
| 84 | 6.297 | 4.997 | 1.206 | 0.088 | 2.294 | 0.353 |
| 85 | 6.147 | | 0.306 | 0.111 | 0 | 0 |
| 87 | 6.478 | | 0.278 | 0.139 | 0.056 | 0.444 |
| 89 | 7.506 | 4.527 | 1.424 | 0.515 | 0.758 | 0.121 |
| 90 | 5.653 | 3.359 | 0.219 | 0.281 | 0.062 | 0.062 |
| 92 | 7.456 | 3.972 | 0.312 | 0.25 | 0 | 0.125 |
| 96 | 3.577 | 4.407 | 0.267 | 0 | 0 | 0.267 |
| 98 | 6.966 | 3.897 | 0.594 | 0.5 | 0.125 | 0.094 |
| 100 | 4.747 | 6.344 | 1.062 | 0 | 1.562 | 0.312 |
| 101 | 7.193 | 5.177 | 0.533 | 0.167 | 0.3 | 0 |
| 102 | 7.288 | 4.859 | 1.781 | 0.406 | 1.688 | 0.219 |
| 103 | 6.256 | | 0 | 0 | 0 | 0 |
| 105 | 6.644 | | 0.111 | 0.056 | 0 | 0.167 |
| 109 | 6.744 | | 0.556 | 0.278 | 0.333 | 0.778 |
| 116 | 4.733 | | 0.556 | 0.306 | 0 | 0.028 |
| 118 | 6.438 | 6.356 | 1.562 | 0 | 1.375 | 0.781 |
| 120 | 0.481 | | 0.083 | 0 | 0.028 | 0 |
| 121 | 6.106 | 4.283 | 1.029 | 0.314 | 0.229 | 0.486 |
| 125 | 7.658 | | 0.333 | 0.194 | 0.556 | 0.139 |
| 129 | 9.417 | 0.897 | 0.333 | 0.3 | 0 | 0 |
| 131 | 7.149 | 3.394 | 0.143 | 0.4 | 0 | 0.457 |
| 132 | 3.175 | 6.103 | 0.594 | 0 | 0.562 | 0.281 |
| 133 | 6.022 | 6.638 | 0.312 | 0.094 | 0 | 0 |
| 136 | 4.056 | 2.919 | 0.094 | 0 | 0 | 0.125 |
| 137 | 0.822 | | 0.111 | 0 | 0.083 | 0.083 |
| 139 | 4.506 | 5.434 | 0.656 | 0.062 | 0.375 | 0.188 |
| 140 | 2.947 | 5.594 | 0.344 | 0.062 | 0.406 | 0 |
| 141 | 7.312 | 6.747 | 1.875 | 0.031 | 2.375 | 0.531 |
| 143 | 3.07 | 4.852 | 0.848 | 0.03 | 0.424 | 0.182 |
| 144 | 1.68 | 4.893 | 0.233 | 0 | 0.033 | 0.1 |
| 146 | 4.067 | 4.824 | 0.485 | 0.242 | 0.061 | 0.242 |
| 147 | 6.442 | 5.712 | 1 | 0.152 | 0.667 | 0.303 |
| 148 | 2.578 | 5.334 | 0.25 | 0.125 | 0.156 | 0.25 |
| 149 | 6.474 | 4.943 | 0.171 | 0.114 | 0.029 | 0.2 |
| 150 | 7.41 | 5.42 | 0.5 | 0.133 | 0.233 | 0.2 |
| 152 | 4.141 | 4.938 | 0.441 | 0.235 | 0 | 0.235 |
| 153 | 8.225 | | 0.611 | 0 | 0.583 | 0.333 |
| 157 | 5.903 | 5.925 | 0.75 | 0 | 0 | 0.281 |
| 161 | 7.049 | 4.943 | 0.6 | 0.286 | 0 | 0.114 |
| 163 | 6.782 | 4.597 | 0.559 | 0.176 | 0.176 | 0.265 |
| 164 | 7.056 | 5.719 | 0.344 | 0.125 | 0 | 0 |
| 165 | 5.892 | | 1.278 | 0 | 1.194 | 0.278 |
| 168 | 7.578 | 3.25 | 0.125 | 0.594 | 0 | 0.125 |
| 171 | 5.966 | 2.514 | 0.143 | 0 | 0 | 0 |
| 173 | 7.088 | 5.153 | 0.781 | 0.094 | 1.219 | 0.75 |
| 175 | 3.772 | 4.922 | 0.094 | 0.125 | 0.219 | 0.281 |
| 177 | 4.771 | 5.694 | 1.161 | 0.871 | 0.806 | 0.161 |
| 179 | 1.219 | 4.991 | 0.125 | 0.031 | 0.094 | 0 |
| 181 | 4.4 | 4.176 | 0.455 | 0.091 | 0.212 | 0.182 |
| 183 | 6.45 | 4.166 | 0.844 | 0.375 | 0.188 | 0.469 |
| 184 | 6.364 | 5.788 | 0.818 | 0 | 0.758 | 0.061 |
| 185 | 7.206 | 2.529 | 0.097 | 0 | 0.065 | 0.097 |
| 188 | 7.446 | 4.757 | 0.457 | 0.229 | 0.171 | 0.629 |
| 190 | 4.712 | 5.556 | 1 | 0.156 | 0.312 | 0.562 |
| 191 | 4.39 | 4.43 | 0.733 | 0.133 | 0.167 | 0.167 |
| 193 | 8.05 | 3.323 | 0.033 | 0.4 | 0 | 0 |
| 194 | 7.294 | | 0 | 0.083 | 0 | 0.056 |
| 196 | 4.447 | 5.279 | 1 | 0.176 | 0.324 | 0.324 |
| 200 | 6.882 | 4.77 | 1.242 | 0.455 | 0.515 | 0.273 |
| 201 | 7.858 | | 0.333 | 0.139 | 0.25 | 0 |
| 203 | 7.147 | 4.853 | 0.312 | 0.125 | 0.594 | 0.125 |
| 206 | 0.772 | | 0.167 | 0.056 | 0.139 | 0.028 |
| 209 | 2.777 | 4.453 | 0.567 | 0 | 0.1 | 0.233 |
| 210 | 4.22 | 2.991 | 0.114 | 0.114 | 0.057 | 0 |
| 211 | 7.075 | 4.553 | 0.844 | 0.156 | 0.125 | 1.25 |
| 214 | 6.529 | 3.935 | 0.516 | 0.387 | 0.032 | 0.226 |
| 216 | 5.738 | 5.556 | 0.875 | 0.469 | 0.094 | 0 |
| 222 | 6.111 | | 0.139 | 0 | 0.028 | 0.139 |
| 225 | 5.918 | 5.259 | 0.529 | 0.118 | 0.235 | 0 |
| 227 | 4.569 | 6.281 | 0.906 | 0.094 | 1.406 | 0.156 |
| 229 | 8.264 | | 0.722 | 0.056 | 0.889 | 0.417 |
| 230 | 6.147 | | 0.139 | 0.278 | 0.111 | 0 |
| 232 | 6.725 | 5.053 | 0.531 | 0.281 | 0.219 | 0.219 |
| 238 | 5.797 | 3.891 | 0.114 | 0.114 | 0 | 0.2 |
| 239 | 4.549 | 5.266 | 0.286 | 0 | 0.543 | 0 |
| 240 | 0.878 | | 0.25 | 0 | 0 | 0.083 |
| 241 | 3 | 5.066 | 0.781 | 0.094 | 0.188 | 0.969 |
| 245 | 7.428 | | 0.611 | 0.194 | 0.333 | 0.389 |
| 246 | 2.784 | 4.744 | 0.125 | 0.281 | 0 | 0 |
| 251 | 6.456 | 5.234 | 0.062 | 0.125 | 0 | 0 |
| 253 | 3.856 | 4.369 | 0.062 | 0.438 | 0 | 0.031 |
| 257 | 6.957 | 7.283 | 1.833 | 0.4 | 2.4 | 0.867 |
| 258 | 7.031 | | 0.278 | 0.25 | 0.083 | 0 |
| 259 | 6.997 | 5.671 | 0.529 | 0 | 0.088 | 0 |
| 260 | 3.781 | 5.097 | 0.688 | 0.094 | 0.156 | 0.406 |
| 261 | 3.166 | 5.774 | 0.829 | 0.057 | 0.429 | 0.143 |
| 263 | 6.119 | 6.453 | 1.875 | 0.781 | 1.188 | 0.938 |
| 265 | 6.234 | 3.091 | 0.344 | 0.031 | 0.062 | 0.125 |
| 268 | 6.05 | 5.756 | 0.531 | 0 | 0.75 | 0.125 |
| 272 | 7.925 | | 0.583 | 0.833 | 0.306 | 0.417 |
| 273 | 6.031 | | 0 | 0.25 | 0 | 0.028 |
| 275 | 4.432 | 5.965 | 1.065 | 0 | 0.548 | 0.29 |
| 276 | 4.991 | 3.581 | 0.219 | 0.188 | 0 | 0.188 |
| 277 | 5.012 | 4.372 | 0.188 | 0.375 | 0 | 0.281 |
| 278 | 6.062 | 3.147 | 0.062 | 0 | 0.062 | 0.031 |
| 281 | 4.472 | 3.497 | 0.281 | 0.062 | 0 | 0.031 |
| 282 | 7.418 | 4.512 | 0.971 | 0.735 | 0.059 | 0.088 |
| 285 | 6.806 | 4.834 | 0 | 0.219 | 0 | 0 |
| 290 | 7.256 | 4.997 | 1.344 | 0.781 | 0.688 | 0.688 |
| 294 | 6.544 | | 0.861 | 0.056 | 0.75 | 0.583 |
| 295 | 5.994 | 6.365 | 1.971 | 0.235 | 1.706 | 0.765 |
| 297 | 2.928 | 5.025 | 0.281 | 0.094 | 0.344 | 0.188 |
| 301 | 8.03 | 6.236 | 0.152 | 0.939 | 0 | 0.03 |
| 306 | 2.392 | | 0.611 | 0.278 | 0.167 | 0.306 |
| 307 | 7.556 | 4.856 | 1.25 | 0.219 | 0.938 | 0.125 |
| 312 | 3.235 | 4.961 | 0.548 | 0.161 | 0 | 0.355 |
| 313 | 5.494 | 5.091 | 0.844 | 0.375 | 0.25 | 0.406 |
| 314 | 3.847 | 5.167 | 0.833 | 0.1 | 0.267 | 0.167 |
| 315 | 7.643 | 6.306 | 0.514 | 0.029 | 0.257 | 0 |
| 316 | 5.918 | 5.871 | 0.412 | 0 | 0 | 0 |
| 317 | 5.665 | 4.623 | 0.645 | 0.097 | 0.742 | 0.29 |
| 318 | 6.909 | 4.362 | 0.188 | 0.281 | 0 | 0.062 |
| 319 | 5.831 | | 0.528 | 0 | 0.111 | 0 |
| 320 | 5.85 | 4.025 | 0.625 | 0 | 0.625 | 0.469 |
| 321 | 7.694 | | 0.222 | 0 | 0 | 0.306 |
| 322 | 4.128 | | 0.444 | 0 | 0.056 | 0 |
| 324 | 2.292 | | 0.139 | 0.056 | 0.139 | 0.389 |
| 327 | 6.55 | 5.519 | 1.062 | 0.344 | 0.781 | 0.344 |
| 330 | 4.881 | 4.425 | 0.406 | 0.688 | 0.094 | 0.125 |
| 332 | 5.583 | 4.421 | 0.759 | 0.517 | 0.793 | 0.207 |
| 335 | 6.722 | 5.797 | 1.406 | 0.125 | 0.719 | 0.562 |
| 340 | 8.519 | 5.025 | 0.531 | 0 | 0.156 | 0.031 |
| 344 | 7.344 | 4.994 | 1.375 | 0.344 | 0.875 | 0.5 |
| 349 | 5.294 | 4.794 | 0.562 | 0.281 | 0.188 | 0.625 |
| 352 | 8.075 | 2.697 | 0 | 0.406 | 0 | 0 |
| 355 | 8.553 | 3.197 | 0 | 0.438 | 0 | 0 |
| 358 | 5.588 | 3.331 | 0.438 | 0 | 0.062 | 0.125 |
| 366 | 6.883 | 6.714 | 1.886 | 0 | 2.2 | 0.943 |
| 367 | 3.697 | 4.716 | 0.625 | 0.094 | 0.312 | 0.062 |
| 368 | 4.522 | | 0.944 | 0.167 | 0 | 1.639 |
| 370 | 7.369 | | 0 | 0.028 | 0 | 0 |
| 373 | 6.906 | 5.078 | 0.594 | 0 | 0.25 | 0.562 |
| 374 | 5.172 | 2.794 | 0.062 | 0.219 | 0 | 0 |
| 377 | 8.039 | 4.539 | 0.903 | 0.484 | 0 | 0.129 |
| 378 | 4.481 | 5.672 | 0.344 | 0.062 | 0.25 | 0.125 |
| 380 | 5.973 | 6.093 | 1.4 | 0.2 | 0.967 | 0.467 |
| 382 | 7.509 | 2.294 | 0.469 | 0.219 | 0 | 0.594 |
| 385 | 6.871 | 3.8 | 0.529 | 0.176 | 0.441 | 0.176 |
| 386 | 4.634 | 5.471 | 0.971 | 0.086 | 0.257 | 0.371 |
| 391 | 7.345 | 4.923 | 1.516 | 0.161 | 0.516 | 0.452 |
| 392 | 7.847 | 6.784 | 2.156 | 0.062 | 2.844 | 0.25 |
| 400 | 6.339 | | 0.528 | 0.083 | 0.139 | 0.417 |
| 401 | 1.275 | | 0.139 | 0 | 0.028 | 0.083 |
| 402 | 6.848 | 6 | 2.194 | 0.71 | 0.581 | 0.645 |
| 403 | 1.092 | | 0 | 0 | 0 | 0 |
| 404 | 7.466 | 2.956 | 0.062 | 0.156 | 0 | 0.094 |
| 405 | 1.261 | | 0.25 | 0 | 0 | 0 |
| 407 | 6.834 | 5.85 | 1.531 | 0.031 | 1.062 | 0.156 |
| 409 | 6.673 | 2.743 | 0.5 | 0 | 0.067 | 0.133 |
| 411 | 3.225 | 4.222 | 0.281 | 0 | 0.344 | 0.125 |
| 413 | 4.623 | 4.957 | 0.057 | 0.057 | 0 | 0 |
| 414 | 7.243 | 5.346 | 0.771 | 0 | 0.457 | 0.171 |
| 415 | 4.819 | 4.612 | 1.094 | 0.438 | 0.5 | 0.531 |
| 416 | 4.681 | | 0.611 | 0 | 0 | 0.111 |
| 417 | 5.683 | | 0.417 | 0.083 | 0.667 | 0.167 |
| 418 | 5.932 | 3.944 | 0.5 | 0.029 | 0.059 | 0 |
| 419 | 4.678 | 6.516 | 1 | 0.031 | 0 | 0.094 |
| 424 | 6.006 | | 1.306 | 0.139 | 0.5 | 0.472 |
| 427 | 6.441 | 5.772 | 1.906 | 0 | 1.844 | 0.594 |
| 428 | 4.406 | | 0.528 | 0.167 | 0.111 | 0 |
| 432 | 6.725 | 3.522 | 0 | 0.031 | 0.094 | 0.094 |
| 433 | 4.139 | 5.17 | 0.727 | 0 | 0.364 | 0.212 |
| 434 | 7.471 | 6.346 | 1.429 | 0.171 | 0.6 | 0.4 |
| 436 | 2.385 | 5.203 | 0.206 | 0.353 | 0.176 | 0 |
| 439 | 3.603 | 4.355 | 0.576 | 0.273 | 0 | 0.333 |
| 442 | 8.394 | 3.981 | 0.375 | 0 | 0.312 | 0.062 |
| 445 | 7.117 | | 1.694 | 0.361 | 2.472 | 0.694 |
| 449 | 4.184 | 5.623 | 1.419 | 0 | 0.871 | 0.194 |
| 450 | 7.488 | 3.059 | 0.344 | 0.938 | 0 | 0 |
| 451 | 7.242 | | 0.667 | 0.389 | 0.028 | 0.222 |
| 452 | 4.861 | 4.242 | 0.333 | 0 | 0 | 0.212 |
| 453 | 7.671 | 5.271 | 1.129 | 0.161 | 0.194 | 0.226 |
| 455 | 5.581 | 6.778 | 0.719 | 0.062 | 0 | 0.094 |
| 457 | 5.789 | 6.134 | 1.371 | 0.086 | 0.6 | 1.743 |
| 458 | 5.223 | 5.371 | 0.323 | 0 | 0.129 | 0.129 |
| 460 | 3.208 | | 0.056 | 0.361 | 0.028 | 0.056 |
| 461 | 6.516 | 3.594 | 0.094 | 0.156 | 0 | 0 |
| 464 | 7.271 | 5.071 | 0.588 | 0.471 | 0.206 | 0.324 |
| 465 | 7.303 | 4.906 | 1.062 | 0.031 | 0.562 | 0.719 |
| 470 | 4.044 | | 0.806 | 0.167 | 0.361 | 0.361 |
| 471 | 6.439 | | 1.722 | 0.111 | 2.306 | 0.444 |
| 472 | 1.847 | | 0.306 | 0 | 0 | 0.056 |
| 473 | 6.167 | | 0.222 | 0 | 0.111 | 0.167 |
| 474 | 2.797 | | 0.167 | 0.083 | 0 | 0.056 |
| 478 | 7.75 | 5.997 | 1.812 | 0.281 | 0.5 | 0.438 |
| 480 | 4.189 | | 1.25 | 0 | 0.583 | 0.889 |
| 481 | 2.044 | 4.684 | 0.125 | 0.062 | 0 | 0.062 |
| 482 | 5.9 | | 1.167 | 0 | 1.361 | 0.333 |
| 484 | 6.503 | | 0.333 | 0.139 | 0 | 0.5 |
| 485 | 8.287 | 4.235 | 0.742 | 0 | 0.516 | 0.452 |
| 487 | 5.206 | | 0.25 | 0.167 | 0 | 0 |
| 489 | 6.652 | 4.461 | 0.903 | 0.226 | 0.097 | 0.677 |
| 490 | 7.494 | 1.919 | 0 | 0.281 | 0 | 0 |
| 491 | 7.789 | | 0 | 0.083 | 0 | 0 |
| 492 | 4.412 | 6.372 | 0.844 | 0.094 | 1.406 | 0.281 |
| 499 | 5.3 | 3.509 | 0 | 0.529 | 0 | 0 |
| 500 | 5.917 | | 0.028 | 0.194 | 0 | 0.611 |
| 502 | 2.588 | 5.219 | 0.656 | 0.094 | 0.531 | 0.312 |
| 504 | 3.928 | | 0.361 | 0 | 0.306 | 0.056 |
| 505 | 5.775 | 6.553 | 1.844 | 0 | 1.906 | 0.156 |
| 507 | 4.777 | 5.034 | 0.314 | 0.257 | 0.4 | 0.314 |
| 511 | 4.631 | 4.728 | 0.625 | 0.25 | 0.125 | 0.156 |
| 512 | 1.344 | 4.806 | 0.031 | 0.188 | 0.031 | 0 |
| 514 | 4.953 | 5.4 | 0.412 | 0.088 | 0 | 0.412 |
| 515 | 6.257 | 3.443 | 0.1 | 0.433 | 0.067 | 0 |
| 517 | 5.061 | 5.577 | 0.645 | 0.032 | 0.161 | 0.387 |
| 518 | 5.936 | 5.176 | 0.636 | 0.242 | 0.061 | 0.394 |
| 520 | 8.494 | 1.084 | 0 | 0.094 | 0 | 0 |
| 526 | 4.941 | 6.016 | 1.781 | 0.438 | 0.812 | 0.5 |
| 527 | 4.118 | 4.382 | 0.412 | 0.294 | 0 | 0.088 |
| 531 | 3.931 | 4.291 | 0.344 | 0.219 | 0.031 | 0.031 |
| 533 | 4.89 | 6.25 | 1.6 | 0.033 | 1.467 | 0.433 |
| 534 | 0.947 | | 0.167 | 0 | 0 | 0.028 |
| 539 | 7.672 | | 0.111 | 0.306 | 0 | 0.111 |
| 541 | 8.892 | | 0.556 | 0 | 0.139 | 0.111 |
| 544 | 6.894 | | 0.5 | 0.056 | 0.139 | 0.056 |
| 545 | 5.622 | 5.784 | 1.406 | 0.438 | 0.156 | 0.719 |
| 550 | 7.454 | 2.509 | 0 | 0.257 | 0 | 0.086 |
| 551 | 5.847 | 4.206 | 0.5 | 0.281 | 0.25 | 0.188 |
| 554 | 6.111 | 3.817 | 0.086 | 0.114 | 0 | 0.171 |
| 558 | 6.25 | 5.69 | 0.633 | 0.133 | 0.8 | 0.3 |
| 560 | 6.583 | | 0 | 0.083 | 0 | 0 |
| 561 | 6.553 | 2.978 | 0.156 | 0.125 | 0 | 0.219 |
| 562 | 5.134 | 5.175 | 0.531 | 0.125 | 0.438 | 0.281 |
| 563 | 6.956 | 4.159 | 1.031 | 0 | 1.062 | 0.438 |
| 568 | 4.003 | 5.006 | 0.2 | 0.143 | 0.314 | 0.429 |
| 569 | 6.208 | | 0 | 0.139 | 0 | 0.139 |
| 570 | 5.838 | 5.612 | 1.062 | 0.062 | 0.125 | 0.219 |
| 571 | 7.9 | 4.506 | 0.114 | 0.686 | 0 | 0.429 |
| 575 | 4.597 | 4.397 | 0.594 | 0.094 | 0.219 | 0.125 |
| 578 | 7.271 | 3.051 | 0.229 | 0.114 | 0 | 0.286 |
| 580 | 6.997 | 3.906 | 0.182 | 0.182 | 0 | 0.061 |
| 582 | 7.259 | 4.281 | 0.156 | 0.688 | 0 | 0.094 |
| 585 | 7.687 | 4.977 | 1.129 | 0 | 0.645 | 0.226 |
| 586 | 4.806 | 4.226 | 0.2 | 0.143 | 0 | 0.086 |
| 590 | 4.052 | 6.109 | 1 | 0 | 0.818 | 0.394 |
| 591 | 7.24 | 6.12 | 1.333 | 0 | 0.833 | 0.4 |
| 592 | 4.776 | 5.726 | 0.794 | 0.029 | 0.235 | 0.235 |
| 593 | 6.825 | 5.947 | 1.75 | 0.469 | 0.656 | 0.406 |
| 594 | 4.731 | | 0.111 | 0 | 0 | 0 |
| 595 | 7.086 | | 0.333 | 0.028 | 0.111 | 0.333 |
| 596 | 4.666 | 5.249 | 0.086 | 0.2 | 0 | 0.029 |
| 598 | 5.815 | 6.135 | 1.647 | 0.529 | 0.529 | 0.324 |
| 600 | 4.959 | 4.484 | 0.5 | 0.094 | 0.281 | 0.156 |
| 601 | 6.161 | 5.924 | 0.273 | 0.121 | 0 | 0 |
| 604 | 3.856 | 3.619 | 0 | 0.031 | 0 | 0.094 |
| 607 | 3.343 | 4.689 | 0.143 | 0.343 | 0 | 0.086 |
| 611 | 6.894 | 5.197 | 0.656 | 0.406 | 0.188 | 1.156 |
| 613 | 8.403 | 5.119 | 1.125 | 0 | 0.094 | 0.062 |
| 615 | 6.297 | 6.111 | 0.286 | 0.371 | 0 | 0.429 |
| 620 | 3.522 | | 0.361 | 0 | 0.083 | 0.194 |
| 625 | 6.706 | 5.952 | 0.152 | 0.061 | 0 | 0.061 |
| 627 | 8.035 | 5.056 | 0.559 | 0 | 0.529 | 0.353 |
| 630 | 5.724 | 3.144 | 0.235 | 0.647 | 0 | 0 |
| 631 | 7.566 | 2.303 | 0.344 | 0.125 | 0 | 0.156 |
| 634 | 5.835 | 4.326 | 0.71 | 0.161 | 0.323 | 0.226 |
| 638 | 7.864 | | 0.083 | 0.361 | 0 | 0 |
| 642 | 6.897 | 4.525 | 1.219 | 0.125 | 0.75 | 0 |
| 649 | 7.194 | 4.731 | 0.531 | 0.375 | 0.188 | 0.469 |
| 660 | 6.3 | 5.035 | 0.588 | 0.206 | 0.059 | 0.118 |
| 661 | 4.35 | 5.862 | 1 | 0.156 | 0.656 | 0.25 |
| 663 | 5.359 | 5.628 | 1.938 | 0.625 | 0.719 | 0.281 |
| 665 | 3.478 | | 0.75 | 0 | 0.472 | 0.028 |
| 679 | 7.141 | 6.528 | 1.781 | 0 | 2.562 | 0.906 |
| 680 | 5.306 | | 0.833 | 0.417 | 0.278 | 0.028 |
| 692 | 6.269 | 2.663 | 0 | 0.057 | 0 | 0 |
| 693 | 7.153 | | 1.5 | 0.194 | 2 | 0.472 |
| 694 | 1.539 | | 0 | 0.028 | 0 | 0.083 |
| 698 | 2.453 | 5.197 | 0.375 | 0.031 | 0 | 0.219 |
| 699 | 6.714 | 5.903 | 1.571 | 0.171 | 1.486 | 0.771 |
| 700 | 2.063 | 4.869 | 0.143 | 0.571 | 0.086 | 0.257 |
| 701 | 5.84 | 5.737 | 1.033 | 0 | 0.933 | 0.2 |
| 702 | 7.694 | 4.252 | 0.636 | 0.091 | 0.758 | 0.303 |
| 703 | 6.311 | | 0.611 | 0.083 | 0.194 | 0.25 |
| 704 | 2.281 | 5.003 | 0.406 | 0 | 0.062 | 0.125 |
| 709 | 4.906 | 5.097 | 0 | 0.094 | 0 | 0.094 |
| 710 | 2.586 | 5.183 | 0.486 | 0 | 0.114 | 0.143 |
| 711 | 2.852 | 5.521 | 0.273 | 0 | 0 | 0.091 |
| 713 | 6.714 | 4.354 | 1 | 0.029 | 0.029 | 0.057 |
| 717 | 4.688 | 5.785 | 0.364 | 0.636 | 0 | 0 |
| 721 | 6.657 | 6.391 | 1.8 | 1.971 | 0.229 | 0.543 |
| 722 | 2.966 | 5.3 | 0.844 | 0.062 | 0.469 | 0.5 |
| 724 | 6.351 | 4.546 | 1.429 | 0 | 0.629 | 0.714 |
| 728 | 8.003 | 4.517 | 0.314 | 0.057 | 0 | 0.257 |
| 731 | 5.122 | 2.616 | 0.156 | 0.094 | 0 | 0.094 |
| 733 | 3.223 | 3.766 | 0.229 | 0 | 0.314 | 0.143 |
| 735 | 7.788 | 3.809 | 0.469 | 0.531 | 0.156 | 0 |
| 736 | 6.838 | 4.669 | 0.812 | 0.031 | 0.25 | 0.188 |
| 738 | 6.612 | 2.262 | 0.094 | 0.406 | 0 | 0.344 |
| 741 | 6.978 | | 0.111 | 0.111 | 0 | 0 |
| 743 | 5.181 | 4.609 | 0.5 | 0.094 | 0.344 | 0.438 |
| 745 | 8.503 | 6.283 | 0.371 | 0.114 | 0 | 0 |
| 753 | 5.991 | 4.922 | 1.125 | 0.094 | 0.281 | 0.25 |
| 755 | 2.717 | 4.583 | 0.229 | 0 | 0.143 | 0.257 |
| 756 | 7.227 | 4.933 | 0.833 | 0.7 | 0.2 | 0.233 |
| 757 | 7.229 | 5.289 | 0.771 | 0.371 | 0.143 | 1.457 |
| 758 | 6.447 | 5.875 | 1.156 | 0.094 | 0.781 | 0.844 |
| 760 | 3.867 | | 0 | 0 | 0 | 0 |
| 761 | 7.091 | 5.156 | 1 | 0.031 | 0.469 | 0.25 |
| 762 | 7.38 | 4.606 | 0.914 | 1.029 | 0.029 | 0.286 |
| 763 | 4.86 | 5.807 | 1.367 | 0.367 | 0.5 | 0.533 |
| 764 | 5.922 | | 0.417 | 0.083 | 0 | 0.361 |
| 765 | 5.297 | 4.25 | 0.531 | 0.125 | 0.219 | 0.25 |
| 773 | 4.172 | 6.038 | 1.406 | 0.281 | 0.75 | 0.688 |
| 776 | 5.172 | 5.966 | 0.938 | 0.094 | 0.094 | 0.25 |
| 777 | 7.831 | 3.984 | 0.156 | 0.219 | 0 | 0 |
| 780 | 6.244 | 5.678 | 1.094 | 0.688 | 0.469 | 0.281 |
| 781 | 5.182 | 5.488 | 1.03 | 0 | 1.273 | 0.364 |
| 783 | 5.294 | 6.062 | 1.25 | 0.844 | 0.844 | 1.031 |
| 784 | 5.394 | 4.266 | 0.219 | 0.094 | 0.031 | 0.062 |
| 786 | 6.782 | 4.409 | 0.912 | 0 | 1.353 | 0.059 |
| 790 | 6.292 | | 0.944 | 0.25 | 0.639 | 0.806 |
| 791 | 2.286 | | 0.861 | 0 | 0.917 | 0.194 |
| 800 | 6.753 | 4.222 | 0 | 0.125 | 0 | 0.031 |
| 801 | 4.291 | 3.706 | 0.156 | 0.094 | 0.125 | 0 |
| 803 | 2.858 | 5.097 | 0.387 | 0.129 | 0.032 | 0.387 |
| 812 | 2.066 | 4.766 | 0.4 | 0.114 | 0.229 | 0.2 |
| 820 | 5.825 | 5.028 | 0.219 | 0.469 | 0.188 | 0.125 |
| 822 | 6.778 | | 1.222 | 0.194 | 0.417 | 0.222 |
| 827 | 1.712 | 4.985 | 0.118 | 0.059 | 0.118 | 0.118 |
| 829 | 7.368 | 2.903 | 0.032 | 0.032 | 0 | 0 |
| 832 | 2.816 | 5.166 | 0.312 | 0 | 0.5 | 0.219 |
| 834 | 3.189 | | 0.556 | 0 | 0.806 | 0.444 |
| 847 | 4.481 | | 0.278 | 0.25 | 0.139 | 0.278 |
| 848 | 7.317 | | 0 | 0.167 | 0 | 0.056 |
| 854 | 8.636 | | 0.306 | 0 | 0 | 0.056 |
| 861 | 8.306 | | 0.139 | 0.056 | 0 | 0.222 |
| 864 | 5.394 | 5.975 | 1.312 | 0.406 | 0.188 | 1.438 |
| 868 | 5.844 | | 0 | 0.056 | 0 | 0 |
| 875 | 4.14 | 5.147 | 0.867 | 0 | 0.433 | 0.533 |
| 876 | 8.084 | 5.848 | 1.903 | 2.065 | 1.097 | 0.097 |
| 877 | 7.023 | 2.966 | 0.029 | 0.029 | 0.086 | 0.029 |
| 879 | 6.374 | 3.623 | 0.143 | 0.286 | 0 | 0 |
| 881 | 5.491 | 4.944 | 0.647 | 0.324 | 0.382 | 0.206 |
| 882 | 5.469 | 5.109 | 0.8 | 0.029 | 0.914 | 0.229 |
| 887 | 0.903 | | 0.139 | 0 | 0 | 0.056 |
| 889 | 5.7 | 3.534 | 0.312 | 0.344 | 0.281 | 0.156 |
| 895 | 5.387 | 4.627 | 0.9 | 0.267 | 0 | 0.3 |
| 896 | 7.033 | | 0.194 | 0.194 | 0 | 0 |
| 897 | 5.243 | 5.26 | 1.333 | 0.233 | 0.8 | 0.167 |
| 898 | 3.372 | | 0.194 | 0.167 | 0.167 | 0.194 |
| 900 | 6.972 | 4.419 | 1.062 | 0.781 | 0.125 | 0.156 |
| 901 | 6.069 | 5.931 | 1.281 | 0.094 | 0.219 | 0 |
| 905 | 7.319 | 4.206 | 0.344 | 0.094 | 0 | 0.062 |
| 906 | 6.767 | 4.68 | 1.4 | 0.167 | 0.7 | 0.367 |
| 913 | 7.442 | 6.109 | 0.515 | 0.545 | 0 | 0 |
| 917 | 5.451 | 6.211 | 0.143 | 0.057 | 0 | 0 |
| 918 | 4.369 | 5.416 | 1.688 | 0.031 | 0.344 | 0 |
| 920 | 5.878 | 3.928 | 0.562 | 0.25 | 0.281 | 0.594 |
| 926 | 6.119 | | 1.167 | 0 | 0.417 | 0.306 |
| 927 | 7.734 | 3.194 | 0 | 0.281 | 0.156 | 0 |
| 931 | 2.4 | | 0.111 | 0 | 0.056 | 0.111 |
| 934 | 4.772 | | 0.139 | 0 | 0 | 0 |
| 941 | 5.457 | 5.94 | 1.086 | 0.114 | 0.571 | 0.314 |
| 944 | 6.878 | 4.259 | 0 | 0.125 | 0 | 0.312 |
| 946 | 4.929 | 5.92 | 1.886 | 0 | 1.457 | 0.914 |
| 947 | 6.662 | 4.647 | 1.312 | 0.75 | 0.156 | 0 |
| 950 | 5.197 | | 0.278 | 0.167 | 0 | 0.389 |
| 952 | 5.44 | 3.789 | 0.229 | 0.029 | 0 | 0.257 |
| 954 | 3.194 | | 0.083 | 0 | 0 | 0.056 |
| 955 | 4.3 | 2.672 | 0 | 0 | 0 | 0 |
| 959 | 2.497 | 5.491 | 0.242 | 0.091 | 0 | 0 |
| 960 | 6.812 | 3.472 | 0.25 | 0.281 | 0 | 0.125 |
| 961 | 7.584 | 6.547 | 2.281 | 1.469 | 1.438 | 0.406 |
| 962 | 2.957 | 5.24 | 0.567 | 0.2 | 0.2 | 0.067 |
| 963 | 5.575 | | 0.194 | 0.167 | 0 | 0 |
| 964 | 5.028 | 5.256 | 0.781 | 0.312 | 0.031 | 0.188 |
| 965 | 6.936 | | 0 | 0 | 0.139 | 0 |
| 968 | 7.019 | 4.469 | 0.906 | 0.438 | 0.125 | 0.781 |
| 971 | 5.591 | 4.106 | 0 | 0.125 | 0 | 0.062 |
| 974 | 7.587 | 6.661 | 2.032 | 1.968 | 0.484 | 0.355 |
| 976 | 2.366 | 4.826 | 0.143 | 0.171 | 0.143 | 0.086 |
| 982 | 5.568 | 4.955 | 0.323 | 0.613 | 0.032 | 0.097 |
| 985 | 6.125 | | 0.528 | 0.194 | 0.5 | 1.056 |
| 988 | 6.65 | 5.072 | 0.719 | 0.312 | 0.406 | 0.625 |
| 995 | 6.942 | 6.371 | 0.774 | 0 | 0 | 0 |
| 999 | 2.633 | | 0.056 | 0.028 | 0 | 0.083 |

The compounds were further evaluated by one or more trained and/or certified flavor or fragrance chemists or master perfumers. The compounds were considered based on the nature of their odor, and the intensity and duration of their odor, also considered against the needs of the flavor and fragrance marketplace and the likelihood for commercial exploitation. Based on this analysis, the compounds were categorized into four categories, wherein category (A) represents the compounds of highest commercial prospect, and the category (D) represents the compounds of lowest commercial prospect ((A)>(B)>(C)>(D)), while category (E) comprises compounds which require further study. The results of the evaluation are shown in the following table (Table 7), in which 399 compounds are analyzed:

| | | | Highest rated odor labels (with score) | | |
|---|---|---|---|---|---|
| ID | Name (common name) | Rating | First | Second | Third |
| 6 | 1-Cyclopropylethanol | (D) | Alcoholic 3.7 | Sharp 1.6 | Medicinal 0.8 |
| 7 | 2-(4-Methylthiazol-5- | (B)* | Roasted 1.8 | Meaty 1.7 | Cucumber 1.3 |
| | yl)ethyl formate | | | | |
| 12 | Boc-D,L-Alanine | (D) | Sweet 1.3 | Sharp 0.9 | Fruity 0.7 |
| 14 | 2,4-Dimethylbenzonitrile | (D) | Sweet 1.2 | Powdery | Floral 1 |
| | | | | 1.1 | |
| 17 | 2-Norbornanone | (D) | Tomato 1.5 | Sharp 1.4 | Alcoholic 1.1 |
| 18 | 1,3-Butanediol | (A) | Tomato 1.1 | Ozone 0.5 | Earthy 0.3 |
| | Dimethacrylate | | | | |
| 22 | 1,8- | (D) | Earthy 1.6 | Musty 1.2 | Grassy 0.8 |
| | Diazabicyclo[5.4.0]undec- | | | | |
| | 7-ene | | | | |
| 29 | N,N-Di(but-1-yl)formamide | (D) | Sweet 1.4 | Fruity 0.8 | Mint 0.7 |
| 30 | Bis(2-ethylhexyl)amine | (D) | Grassy 0.8 | Green 0.7 | Musty 0.7 |
| 36 | Methyl 3-amino-4- | (D) | Musty 2.1 | Earthy 0.9 | Ozone 0.9 |
| | methoxybenzoate | | | | |
| 38 | Isobutyl Cyanoacetate | (D) | Sweet 0.9 | Fruity 0.7 | Apple 0.5 |
| 41 | 2-Ethyladamantan-2-ol | (A) | Medicinal 1.9 | Camphor | Cooling 1.7 |
| | | | | 1.9 | |
| 45 | 4,5-Dimethyl-1,3-thiazol-2- | (B)* | Buttery 2.8 | Sweet 1 | Dairy 0.8 |
| | amine | | | | |
| 47 | 2-Pentyn-1-ol | (B)* | Tomato 1.2 | Garlic 1.1 | Green 1.1 |
| 50 | Ethyl 5-methylisoxazole-4- | (A) | Sweet 1.9 | Fruity 1.4 | Mint 1 |
| | carboxylate | | | | |
| 61 | 1,2,3,4,5- | (A) | Musty 1.5 | Earthy 0.7 | Medicinal 0.6 |
| | Pentamethylbenzene | | | | |
| 63 | Diethyl | (B) | Alcoholic 2 | Sharp 1.8 | Fermented 1.3 |
| | acetylenedicarboxylate | | | | |
| 64 | Idramantone | (D) | Dairy 0.3 | Waxy 0.2 | Powdery 0.1 |
| 76 | 2-(2- | (C) | Herbal 0.9 | Sweet 0.8 | Grassy 0.8 |
| | Propynyloxy) | | | | |
| | tetrahydropyran | | | | |
| 79 | Cyclooctylamine | (D) | Fishy 1.6 | Metallic | Musty 1 |
| | | | | 1.1 | |
| 80 | 3,5-Dimethyl-4-methoxy-2- | (D) | Sour 1 | Fermented | Green 1 |
| | pyridinemethanol | | | 1 | |
| 82 | Acetic acid, 2-hydroxy- | (C) | Alcoholic 1.6 | Sharp 0.7 | Fruity 0.7 |
| | phenylmethyl ester | | | | |
| 84 | (S)-Cyclohex-3- | (D) | Fruity 2.3 | Sweet 1.2 | Fermented 1.1 |
| | encarboxylic acid | | | | |
| 85 | 2-Ethyl-4-methylimidazole | (C) | Nutty 3 | Roasted 1.6 | Fatty 0.6 |
| 87 | 1-Isopropoxy-2- | (D) | Ozone 1.2 | Musty 1 | Smoky 0.8 |
| | methylbenzene | | | | |
| 89 | 2-Methyl-N- | (D) | Sharp 1.6 | Sweet 1.4 | Fruity 0.8 |
| | (phenylmethylene)-2- | | | | |
| | propylamine | | | | |
| 90 | N,N-Dimethyldecanamide | (D)* | Fishy 1.6 | Animal 0.7 | Fatty 0.5 |
| 92 | 1-Dimethylamino-2- | (D) | Alcoholic 2 | Sharp 1.7 | Cooling 0.8 |
| | methylpentan-3-one | | | | |
| 96 | 1,12-Diaminododecane | (D) | Nutty 1.3 | Roasted 0.8 | Sharp 0.5 |
| 98 | 2-Allyloxybenzaldehyde | (C) | Green 0.8 | Musty 0.7 | Ozone 0.7 |
| 100 | Diethyl Dipropylmalonate | (A) | Fruity 1.6 | Sweet 1.1 | Berry 0.6 |
| 101 | 3-Heptyn-1-ol | (C)* | Green 1.3 | Tomato 1.3 | Grassy 1.2 |
| 102 | 2-(Thiophen-3-yl)-1,3- | (B) | Sweet 1.8 | Fruity 1.7 | Sulfurous 1.1 |
| | dioxolane | | | | |
| 103 | 6-Dimethylamino-1-hexanol | (D)* | Fishy 3.7 | Sharp 0.5 | Meaty 0.3 |
| 105 | Dicyclohexylamine | (D) | Fishy 1.4 | Fatty 0.7 | Fermented 0.7 |
| 109 | Cyclohexylbenzene | (B) | Citrus 1.5 | Green 0.8 | Floral 0.8 |
| 116 | 3-Methyldihydrofuran- | (D) | Caramellic 1.2 | Sweet 0.6 | Musty 0.5 |
| | 2,5-dione | | | | |
| 118 | Dicyclopentanyl | (A) | Sweet 1.6 | Fruity 1.4 | Floral 0.8 |
| | methacrylate | | | | |
| 120 | Methyl 2- | (D) | Dairy 0.3 | Powdery | Fatty 0.2 |
| | cyanoisonicotinate | | | 0.2 | |
| 121 | 3-Acetylbenzonitrile | (C) | Sweet 1 | Smoky 0.9 | Ozone 0.9 |
| 125 | 5-Ethylidene-2-norbornene | (C) | Waxy 0.8 | Ozone 0.8 | Green 0.8 |
| 129 | 4-Cyclohex-1-enyl- | (D) | Sharp 4.1 | Alcoholic | Cooling 1.2 |
| | morpholine | | | 1.4 | |
| 131 | 3,4-Ethylenedioxythiophene | (D) | Alcoholic 1.5 | Sharp 1.1 | Medicinal 0.7 |
| 132 | Ethyl (R)-(—)-4-Cyano-3- | (C) | Roasted 0.8 | Sweet 0.6 | Fruity 0.6 |
| | hydroxybutyrate | | | | |
| 133 | 2,4-Dimethylimidazole | (D)* | Nutty 2.9 | Roasted 2.6 | Alcoholic 0.6 |
| 136 | tert-Butoxy | (D)* | Fishy 1.8 | Fatty 0.6 | Sulfurous 0.5 |
| | bis(dimethylamino)methane | | | | |
| 137 | 1,4-Dicyano-2-butene | (D) | Ozone 0.3 | Waxy 0.2 | Smoky 0.1 |
| 139 | 2,4-Dimethylpyrrole | (D) | Dairy 0.8 | Fermented | Roasted 0.7 |
| | | | | 0.7 | |
| 140 | Methyl 5-methyl-3- | (D) | Powdery 0.6 | Vanilla 0.5 | Fruity 0.4 |
| | isoxazole carboxylate | | | | |
| 141 | 1-Cyclohexyl-1-butanol | (A)* | Fruity 2.4 | Sweet 1.9 | Berry 1.8 |
| 143 | (S)-(-)-N,N-Dimethyl-3- | (D) | Sweet 0.8 | Fruity 0.4 | Green 0.3 |
| | hydroxy-3-(2- | | | | |
| | thienyl)propanamine | | | | |
| 144 | (1S,2S,3R,5S)-2,6,6- | (D) | Earthy 0.5 | Dairy 0.4 | Powdery 0.3 |
| | Trimethylbicyclo[3.1.1] | | | | |
| | heptane-2,3-diol | | | | |
| 146 | 1-Methylimidazole-2- | (D) | Musty 0.8 | Garlic 0.5 | Sweet 0.5 |
| | carbaldehyde | | | | |
| 147 | N-Vinylcaprolactam | (D) | Green 1.3 | Sweet 1 | Sour 0.9 |
| 148 | 3-Oxo-cyclobutane-1,1- | (D) | Musty 0.6 | Ozone 0.4 | Buttery 0.3 |
| | dicarboxylic acid | | | | |
| | diisopropyl ester | | | | |
| 149 | 3a,4,7,7a-Tetrahydroindene | (D) | Garlic 0.8 | Green 0.7 | Metallic 0.6 |
| 150 | tert-Butylcyclohexane | (D)* | Cooling 1.5 | Camphor | Herbal 0.9 |
| | | | | 1.2 | |
| 152 | 1-Methyl-1H-indole-3- | (D) | Musty 1 | Ozone 0.6 | Earthy 0.6 |
| | carbaldehyde | | | | |
| 153 | 3,3-dimethylcyclohexan- | (C) | Medicinal 2.9 | Cooling 2.5 | Camphor 2.3 |
| | 1-one | | | | |
| 157 | tert-Butyl pivalate | (D) | Camphor 1.3 | Cooling 1.3 | Medicinal 1.1 |
| 161 | 2-Methylquinolin-8-ol | (D) | Smoky 1.7 | Metallic | Ozone 0.6 |
| | | | | 0.7 | |
| 163 | 1-Phenyl-1H-pyrazole | (D) | Medicinal 0.9 | Ozone 0.9 | Musty 0.9 |
| 164 | 2-(Methylthio)thiazole | (C) | Roasted 2.2 | Nutty 2.1 | Smoky 0.6 |
| 165 | Ethyl N-phenylformimidate | (B) | Alcoholic 2 | Sweet 1.3 | Fruity 1.2 |
| 168 | Quinoline-2-carbaldehyde | (D) | Smoky 1.2 | Animal 0.9 | Musty 0.8 |
| 171 | 1,3-Dimethyl-4-piperidone | (D) | Fishy 1.1 | Sulfurous | Sharp 0.7 |
| | | | | 0.9 | |
| 173 | n-Octyl Acrylate | (D) | Fruity 1.2 | Berry 0.9 | Sweet 0.8 |
| 175 | 2-Methyl-4-isothiazolin-3- | (D) | Citrus 0.7 | Lemon 0.6 | Green 0.4 |
| | one | | | | |
| 177 | Picolinonitrile | (B) | Sweet 1.2 | Spicy 0.9 | Fruity 0.8 |
| 179 | 4-Aminothiophenol | (D) | Alcoholic 0.5 | Winey 0.3 | Fermented 0.3 |
| 181 | N,N- | (D) | Sour 1.6 | Fermented | Sharp 0.5 |
| | Dimethylacetoacetamide | | | 0.8 | |
| 183 | Trimethylquinone | (B) | Sharp 1.8 | Sweet 0.8 | Roasted 0.8 |
| 184 | Cyclooctanol | (C)* | Medicinal 1.5 | Camphor | Cooling 1.2 |
| | | | | 1.4 | |
| 185 | N,N,N′,N′-Tetramethyl- | (D) | Sharp 1.4 | Fishy 1.3 | Alcoholic 1 |
| | 1,3-diaminobutane | | | | |
| 188 | 1-(2-Tetrahydropyranyl)- | (D) | Alcoholic 2.1 | Sharp 1.3 | Cooling 0.7 |
| | 1H-pyrazole | | | | |
| 190 | Bibenzyl | (D) | Citrus 1.4 | Lemon 1 | Sweet 1 |
| 191 | 2-Ethyl-1,3-hexanediol | (C) | Sweet 0.7 | Fatty 0.7 | Musty 0.7 |
| 193 | Pinacolin oxime | (A) | Green 1.8 | Herbal 1.2 | Earthy 1.2 |
| 194 | 3,6-Dioxa-1,8-octanedithiol | (D) | Sulfurous 2.1 | Meaty 1.3 | Roasted 0.8 |
| 196 | 3-(1H-pyrrol-1- | (D) | Sweet 1 | Woody 0.7 | Herbal 0.5 |
| | ylmethyl)pyridine | | | | |
| 200 | 1-Methylcyclohexane-1- | (D) | Sweet 1.2 | Sour 1.1 | Earthy 0.8 |
| | carboxylic acid | | | | |
| 201 | 2-Butynoic acid | (D)* | Sour 2.3 | Fermented | Sharp 2.1 |
| | | | | 2.3 | |
| 203 | Ethylene glycol di-n-butyrate | (D) | Cheesy 2.9 | Dairy 1.2 | Buttery 0.8 |
| 206 | 3,4-Diaminotoluene | (D) | Earthy 0.3 | Musty 0.3 | Sweet 0.2 |
| 209 | Ethylcyclohexane | (C) | Sweet 0.6 | Earthy 0.5 | Musty 0.4 |
| 210 | 2,2,6,6-Tetramethyl-4- | (D) | Fishy 1.1 | Sharp 1 | Sulfurous 0.5 |
| | piperidone | | | | |
| 211 | Isopropyl phenyl sulfide | (D) | Floral 1.2 | Sweet 0.8 | Meaty 0.7 |
| 214 | 2,4,7,9-Tetramethyl-5- | (C) | Cheesy 1.7 | Herbal 0.8 | Fermented 0.7 |
| | decyne-4,7-diol | | | | |
| 216 | 3,4-Dimethyl-1H-pyrazole | (A) | Smoky 1.3 | Buttery 1.3 | Sweet 0.9 |
| | phosphate | | | | |
| 222 | 1-Hexylimidazole | (D) | Fatty 0.9 | Ozone 0.8 | Green 0.7 |
| 225 | 6,7-Dihydro-5H- | (D) | Roasted 1.1 | Nutty 0.8 | Musty 0.6 |
| | cyclopenta[b]pyridine | | | | |
| 227 | 1-(Benzo[d][1,3]dioxol-5- | (B) | Fruity 1.4 | Sweet 0.9 | Berry 0.5 |
| | yl)butan-1-one | | | | |
| 229 | Methyl 1-cyclopentene-1- | (A) | Alcoholic 1.5 | Sour 1.2 | Fermented 1.1 |
| | carboxylate | | | | |
| 230 | Imidazo[1,2-a]pyridine | (D) | Garlic 1 | Tomato 0.6 | Fishy 0.6 |
| 232 | cis-Cyclooctene | (A) | Green 1.3 | Cucumber | Ozone 0.7 |
| | | | | 1.2 | |
| 239 | 2-Hydroxy-2-methylbutyric | (D) | Fermented 1.2 | Sour 0.9 | Vanilla 0.8 |
| | acid | | | | |
| 238 | 2-Amino-3-phenylpropan-1-ol | (D) | Musty 0.9 | Smoky 0.8 | Animal 0.8 |
| 240 | 1,3-Dihydroxyadamantane | (D) | Ozone 0.4 | Sweet 0.2 | Dairy 0.2 |
| 241 | N-(1- | (D) | Floral 1 | Sweet 0.8 | Musty 0.6 |
| | phenylethylidene) | | | | |
| | hydroxylamine | | | | |
| 245 | Cyclohex-3-en-1-ylmethanol | (D) | Medicinal 0.7 | Garlic 0.6 | Sharp 0.6 |
| 246 | 3-Imino-3H-1,2,4-dithiazole- | (D) | Garlic 1 | Sulfurous | Roasted 0.4 |
| | 5-thiol | | | 0.9 | |
| 251 | 2-Phenoxyethylamine | (D) | Roasted 2.4 | Nutty 2.3 | Sharp 1.1 |
| 253 | N-[(5-Nitrofuran-2- | (D)* | Sour 0.5 | Spicy 0.4 | Musty 0.4 |
| | yl)methylidene] | | | | |
| | hydroxylamine | | | | |
| 257 | 1-(p-Tolyl)pentan-1-one | (C) | Fruity 2.4 | Sweet 1.8 | Apple 1 |
| 258 | 5,6,7,8- | (D) | Smoky 1.1 | Musty 1 | Medicinal 0.8 |
| | Tetrahydronaphthalen-1-ol | | | | |
| 259 | 2,4-Dimethoxypyrimidine | (A) | Roasted 2.6 | Nutty 2.5 | Fatty 0.6 |
| 260 | 2,5,6-Trimethyl-1,3- | (D) | Sweet 0.7 | Citrus 0.6 | Mint 0.5 |
| | benzothiazole | | | | |
| 261 | 4-Cyanopyridine | (B) | Sweet 0.8 | Berry 0.5 | Dairy 0.4 |
| 263 | 1,3-Dihydrobenzo[c]furan | (A) | Sweet 1.9 | Fruity 1.2 | Floral 0.9 |
| 265 | 2-(Dimethylamino)-2- | (D) | Fishy 1.7 | Sharp 1.1 | Metallic 0.8 |
| | methyl-1-propanol | | | | |
| 268 | 3,4-Diethoxycyclobut-3-ene- | (B) | Alcoholic 2.6 | Winey 1 | Fermented 0.8 |
| | 1,2-dione | | | | |
| 272 | 2-Butoxypyridine | (A) | Spicy 0.8 | Herbal 0.8 | Green 0.6 |
| 273 | β-Alanine, N- | (B) | Garlic 1.1 | Fatty 0.7 | Ozone 0.5 |
| | (phenylmethyl)-, ethyl ester | | | | |
| 275 | Metaldehyde | (A) | Sweet 1.1 | Alcoholic | Fruity 0.5 |
| | | | | 0.5 | |
| 276 | 7-Methyl-1H-indole | (B) | Musty 2.2 | Ozone 0.9 | Earthy 0.7 |
| 277 | 3-Hydroxy-6,6-dimethyl-1- | (D) | Smoky 0.9 | Woody 0.8 | Herbal 0.5 |
| | heptene-4-yne | | | | |
| 278 | (Dimethylamino)acetonitrile | (D) | Fishy 1.8 | Sharp 0.8 | Roasted 0.8 |
| 281 | 3-(Ethylamino)propanenitrile | (D) | Roasted 0.8 | Sharp 0.8 | Fishy 0.7 |
| 282 | 5-Methylbenzoxazole | (D) | Smoky 1.7 | Sweet 1 | Musty 0.9 |
| 285 | Methyl 4-acetyl-5- | (A)* | Garlic 2.4 | Sulfurous | Cheesy 0.6 |
| | oxohexanoate | | | 0.8 | |
| 290 | 4-Methylbenzyl cyanide | (E) | Sweet 1.3 | Spicy 0.8 | Green 0.7 |
| 294 | Bicyclo[2.2.1 ]hept-5-ene-2- | (D) | Sweet 0.9 | Fruity 0.8 | Alcoholic 0.7 |
| | carbonitrile | | | | |
| 295 | Ethyl 1-Boc-piperidine-2- | (B) | Sweet 2 | Fruity 1.7 | Floral 0.8 |
| | carboxylate | | | | |
| 297 | Pseudopelletierine oxime | (D) | Sour 0.4 | Roasted 0.4 | Musty 0.4 |
| 301 | (Methylthio)acetaldehyde | (D)* | Garlic 4.2 | Spicy 0.9 | Roasted 0.9 |
| | dimethyl acetal | | | | |
| 306 | 4-(4-Methoxyphenyl)-1- | (D) | Sweet 0.6 | Floral 0.3 | Spicy 0.3 |
| | butanol | | | | |
| 307 | n-Butyl nitrite | (D) | Alcoholic 1.5 | Sharp 1.4 | Sweet 1.2 |
| 312 | Thiophene-2-carbaldehyde | (D) | Musty 0.6 | Powdery | Sweet 0.5 |
| | oxime | | | 0.6 | |
| 313 | 2,3-Dihydro-1,4- | (D) | Sweet 0.8 | Medicinal | Alcoholic 0.8 |
| | benzodioxin-6-amine | | | 0.8 | |
| 314 | O-t-Butyl-L-serine methyl | (A) | Dairy 1.3 | Buttery 1.1 | Sweet 0.8 |
| | ester hydrochloride | | | | |
| 315 | Hexamethylacetone | (D) | Cooling 3 | Camphor | Medicinal 2.6 |
| | | | | 2.7 | |
| 316 | 1-Methyl-3- | (A)* | Roasted 2.6 | Nutty 1.6 | Buttery 0.9 |
| | piperidinemethanol | | | | |
| 317 | 2,4,4-Trimethyl-4,5- | (D) | Dairy 0.8 | Fruity 0.7 | Sweet 0.6 |
| | dihydrooxazole | | | | |
| 318 | Ethyl thiophene-2-glyoxylate | (D)* | Garlic 3.2 | Sulfurous 1 | Meaty 0.9 |
| 319 | 1-Ethynyl-1-cyclohexanol | (C)* | Medicinal 3 | Camphor | Cooling 2.2 |
| | | | | 2.4 | |
| 320 | 4-Amyloxybenzaldehyde | (D) | Waxy 0.7 | Fruity 0.6 | Sweet 0.6 |
| 321 | Indene | (D) | Sharp 1.1 | Alcoholic 1 | Musty 0.9 |
| 322 | 5-Hydroxy-4-propylfuran- | (A) | Waxy 0.9 | Nutty 0.9 | Sour 0.6 |
| | 2(5H)-one | | | | |
| 324 | N-tert-Butoxycarbonyl-1,6- | (D) | Musty 0.6 | Floral 0.4 | Fatty 0.3 |
| | hexanediamine | | | | |
| 327 | 2-(1- | (A) | Sweet 1.1 | Alcoholic 1 | Fermented 0.9 |
| | Cyclohexenyl) | | | | |
| | cyclohexanone | | | | |
| 330 | 4-Cyclohexanebutyric Acid | (D) | Musty 0.9 | Fermented | Spicy 0.7 |
| | | | | 0.8 | |
| 332 | 2,6-Di-tert-butylpyridine | (B) | Fruity 0.8 | Sweet 0.8 | Herbal 0.7 |
| 335 | (R)-(+)-2,2-Dimethyl-1,3- | (D) | Alcoholic 1.4 | Sweet 1.4 | Medicinal 1 |
| | dioxolane-4-carboxylic acid | | | | |
| | methyl ester | | | | |
| 340 | 3-Ethyl-3-pentanol | (B) | Cooling 3 | Medicinal | Camphor 2.2 |
| | | | | 2.6 | |
| 344 | Cyclohexyl acrylate | (D) | Sweet 1.4 | Fruity 0.9 | Sharp 0.8 |
| 349 | Ethoxy- | (D) | Floral 0.6 | Sweet 0.6 | Ozone 0.5 |
| | methylenemalononitrile | | | | |
| 352 | S-Phenyl thioacetate | (A) | Meaty 2.8 | Roasted 1.6 | Smoky 1.5 |
| 355 | Dimethyl | (D) | Sulfurous 1.7 | Garlic 1.5 | Cheesy 1.2 |
| | cyanodithioiminocarbonate | | | | |
| 358 | 4-Ethylbenzyl alcohol | (E) | Animal 1.2 | Powdery 1 | Musty 0.9 |
| 366 | 2,2-Diethoxy-1- | (B) | Fruity 2.2 | Sweet 1.9 | Berry 1.2 |
| | phenylethanone | | | | |
| 367 | Furylacrylic acid | (D) | Sweet 0.6 | Alcoholic | Rummy 0.5 |
| | | | | 0.5 | |
| 368 | 1-Phenylcyclopropane-1- | (D) | Floral 1.6 | Powdery | Rose 0.9 |
| | carboxylic acid | | | 1.2 | |
| 370 | 2-(Dimethylamino)ethyl | (D)* | Fishy 3.2 | Sharp 0.8 | Animal 0.8 |
| | acetate | | | | |
| 373 | 2-Aminophenethyl alcohol | (D) | Alcoholic 1.6 | Winey 0.8 | Musty 0.8 |
| 374 | 2-Cyanoimino-1,3- | (D) | Sulfurous 1.2 | Musty 1.1 | Animal 0.9 |
| | thiazolidine | | | | |
| 377 | Methylcyclopentadiene | (A) | Medicinal 1.2 | Camphor | Cooling 1 |
| | dimer | | | 1.1 | |
| 378 | Diisobutyl phthalate | (D) | Dairy 1 | Buttery 0.8 | Cheesy 0.8 |
| 380 | 2,3-Dihydrobenzo[b] | (D) | Sweet 1.4 | Fruity 1 | Vanilla 0.9 |
| | furan-5-carbaldehyde | | | | |
| 382 | 2-(1- | (D) | Sharp 1.7 | Fishy 0.9 | Metallic 0.7 |
| | Cyclohexenyl)ethylamine | | | | |
| 385 | Methyl 2-cyano-2,2- | (D) | Tomato 0.6 | Garlic 0.5 | Sweet 0.5 |
| | dimethylacetate | | | | |
| 386 | (R)-Methyl 2-(4- | (D) | Alcoholic 1.1 | Sweet 1 | Fermented 0.5 |
| | hydroxyphenoxy)propanoate | | | | |
| 391 | 2-Acetyl-5-norbornene (5- | (A) | Sweet 1.5 | Green 0.9 | Ozone 0.9 |
| | acetylbicyclo[2.2.1] | | | | |
| | hept-2-ene) | | | | |
| 392 | Cyclohexanecarboxylic acid | (D)* | Fruity 2.8 | Berry 2.4 | Sweet 2.2 |
| | isopropyl ester | | | | |
| 400 | 2,3,3-Trimethylindolenine | (D) | Camphor 0.7 | Medicinal | Musty 0.6 |
| | | | | 0.7 | |
| 401 | 2-Ethyl-1H-imidazole | (D) | Nutty 0.4 | Green 0.4 | Grassy 0.3 |
| 402 | 1,5-Dimethyl-1H-pyrrole-2- | (A) | Sweet 2.2 | Caramellic | Powdery 0.7 |
| | carbonitrile | | | 0.8 | |
| 403 | N,N,N′-Trimethylthiourea, | (D) | Roasted 0.4 | Sulfurous | Buttery 0.2 |
| | | | | 0.3 | |
| 404 | N,N- | (D) | Fishy 1.7 | Musty 0.9 | Sharp 0.9 |
| | Dicyclohexylmethylamine | | | | |
| 405 | tert-Butyl 3- | (D) | Green 0.2 | Sweet 0.2 | Cheesy 0.2 |
| | (cyanomethylene)azetidine- | | | | |
| | 1-carboxylate | | | | |
| 407 | 3-Methyl-4-heptanone | (A) | Sweet 1.5 | Alcoholic | Mint 1.2 |
| | | | | 1.3 | |
| 409 | 4-Isobutylmorpholine | (D)* | Fishy 2.1 | Sharp 0.6 | Fatty 0.6 |
| 411 | 3-(Ethylamino)-p-cresol | (D) | Fermented 0.6 | Animal 0.6 | Musty 0.5 |
| 413 | 2-Amino-4,6- | (A) | Green 1.5 | Earthy 1.3 | Herbal 1 |
| | dimethoxypyrimidine | | | | |
| 414 | 1-Adamantyl methyl ketone | (B) | Camphor 1.6 | Cooling 1.5 | Medicinal 1.3 |
| 415 | Dimethylcyanamide | (D) | Alcoholic 1.2 | Sweet 1.1 | Sharp 0.6 |
| 416 | H-Isoleucinol | (D) | Earthy 0.8 | Nutty 0.6 | Roasted 0.6 |
| 417 | 2-Hydroxymethyl-3,4- | (B) | Alcoholic 1.8 | Fruity 0.7 | Sharp 0.6 |
| | dihydro-2H-pyran | | | | |
| 418 | 3-Acetyldihydrofuran-2(3H)- | (B)* | Sour 2.4 | Fermented | Dairy 0.9 |
| | one | | | 1.8 | |
| 419 | 1-Boc-3-methylpiperazine | (D) | Roasted 1.2 | Coffee 1.1 | Sweet 1 |
| 424 | Ethyl 1-cyano-1- | (A) | Sweet 1.3 | Caramellic | Honey 0.8 |
| | cyclopropanecarboxylate | | | 1.2 | |
| 427 | Methyl tetrahydropyran-4- | (B) | Alcoholic 1.9 | Sweet 1.9 | Fruity 1.8 |
| | carboxylate | | | | |
| 428 | 2-(1-Ethoxy-ethylidene)- | (D) | Caramellic 1.1 | Musty 0.7 | Sweet 0.5 |
| | malononitrile | | | | |
| 432 | Valeric acid hydrazide | (C) | Cheesy 2.7 | Sour 1.2 | Sulfurous 0.9 |
| 433 | 2-(2- | (D) | Dairy 0.7 | Sweet 0.7 | Green 0.6 |
| | Diethylaminoethoxy)ethanol | | | | |
| 434 | Tricyclo[5.2.1.0(2,6)] | (D) | Camphor 1.7 | Cooling 1.6 | Sweet 1.4 |
| | decan-8-one | | | | |
| 436 | 5-Nitroindoline | (D) | Powdery 0.4 | Spicy 0.4 | Buttery 0.2 |
| 439 | 3-Amino-2-hydroxy-5- | (D) | Sharp 1.2 | Sweet 0.6 | Musty 0.5 |
| | picoline | | | | |
| 442 | Cyclopropyl methyl ketone | (D)* | Alcoholic 3.8 | Sharp 1.7 | Medicinal 1 |
| 445 | Benzo[b]thiophene-2- | (D) | Fruity 2.5 | Sweet 1.7 | Berry 1.2 |
| | carboxaldehyde | | | | |
| 449 | (S)-2,2- | (D) | Sweet 1.4 | Fruity 0.9 | Berry 0.8 |
| | Dimethylcyclo- | | | | |
| | propanecarboxamide | | | | |
| 450 | 4-Methylthiophene-2- | (D) | Meaty 1.3 | Sulfurous | Sharp 1 |
| | carboxylic acid | | | 1.2 | |
| 451 | 2,6-Dimethylbenzonitrile | (C) | Caramellic 0.7 | Sweet 0.7 | Medicinal 0.6 |
| 452 | 2-Piperidinoethanol | (D) | Roasted 1.2 | Fishy 0.8 | Musty 0.8 |
| 453 | 3-Acetylthiophene | (B) | Roasted 2.2 | Sweet 1.1 | Nutty 1 |
| 455 | 4-Methyl-1H-imidazole | (A)* | Nutty 2.6 | Roasted 2.4 | Sweet 0.7 |
| 457 | N-Benzyl-N-ethylaniline | (D) | Floral 1.7 | Sweet 1.4 | Rose 0.9 |
| 458 | 3-Nitro-1H-pyridin-4-one | (A) | Buttery 1.7 | Nutty 1.2 | Roasted 1 |
| 460 | 2-Adamantanol | (B) | Camphor 0.7 | Earthy 0.6 | Musty 0.6 |
| 461 | 4- | (D)* | Garlic 1.5 | Fishy 1.3 | Sulfurous 1.1 |
| | (Ethylaminomethyl)pyridine | | | | |
| 464 | 1,2,4-Trivinylcyclohexane | (B) | Green 0.9 | Citrus 0.8 | Grassy 0.8 |
| 465 | 4-Methoxy-4-methyl-2- | (D) | Alcoholic 2.1 | Medicinal | Camphor 1.2 |
| | pentanone | | | 1.5 | |
| 470 | 1-Benzothiophene-3- | (D) | Sweet 0.8 | Fishy 0.8 | Musty 0.6 |
| | carbaldehyde | | | | |
| 471 | Diethyl isobutylmalonate | (D) | Fruity 2.3 | Berry 2.2 | Sweet 1.7 |
| 472 | tert-Butyl N-(1,3-thiazol-2- | (D) | Sulfurous 0.6 | Meaty 0.5 | Sweet 0.3 |
| | yl)carbamate | | | | |
| 473 | 1,9-Decadiene | (E) | Ozone 1.2 | Waxy 0.7 | Smoky 0.6 |
| 474 | 3-Phenyloxolane-2,5-dione | (D) | Musty 0.8 | Waxy 0.7 | Ozone 0.6 |
| 478 | 2-Hydroxy-3- | (D) | Sweet 1.8 | Caramellic | Cooling 1 |
| | methylbenzaldehyde | | | 1.2 | |
| 480 | 4H-1-Benzopyran-4-one | (B) | Sweet 1.2 | Floral 0.9 | Musk 0.6 |
| 481 | N-Methylphthalimide | (D) | Dairy 0.3 | Metallic | Winey 0.2 |
| | | | | 0.2 | |
| 482 | Ethyl 3- | (A) | Fruity 1.4 | Tropical | Sweet 1.2 |
| | oxocyclobutanecarboxylate | | | 1.2 | |
| 484 | 4-Methyl-3-nitroanisole | (B) | Green 0.8 | Cooling 0.7 | Mint 0.7 |
| 485 | 3,3-Dimethylbutanol | (D) | Cooling 2.2 | Medicinal | Camphor 1.5 |
| | | | | 1.8 | |
| 487 | 3,4-Dimethoxyphenol | (B) | Smoky 1 | Animal 0.9 | Musty 0.7 |
| 489 | 4-Vinylpyridine | (D) | Sweet 0.9 | Animal 0.8 | Floral 0.7 |
| 490 | Thiazole-4-carboxylic acid | (D)* | Sulfurous 2.9 | Meaty 1.5 | Garlic 1.3 |
| 491 | Dimethyl cyclobutane-1,1- | (D)* | Garlic 3.5 | Sulfurous | Tomato 1 |
| | dicarboxylate | | | 1.2 | |
| 492 | Diisopropyl succinate | (A) | Fruity 1.4 | Berry 0.9 | Sweet 0.8 |
| 499 | 4-(Methylthio)aniline | (D)* | Garlic 1.6 | Sulfurous 1 | Roasted 0.8 |
| 500 | 1,2,3,4- | (D) | Ozone 0.7 | Floral 0.6 | Medicinal 0.6 |
| | Tetrahydronaphthalen- | | | | |
| | 1-amine | | | | |
| 502 | Ethyl 3-oxo-3-(4- | (A) | Sweet 0.7 | Fruity 0.5 | Musty 0.5 |
| | pyridyl)propionate | | | | |
| 504 | Oxolan-3-ylmethanol | (B) | Medicinal 0.7 | Cooling 0.6 | Alcoholic 0.6 |
| 505 | Ethyl 3-cyclopropyl-3- | (A) | Fruity 1.9 | Sweet 1.8 | Apple 1.8 |
| | oxopropanoate | | | | |
| 507 | Methyl-5-norbornene-2,3- | (D) | Fermented 0.8 | Sour 0.6 | Sulfurous 0.6 |
| | dicarboxylic anhydride | | | | |
| 511 | 1H-Indazole | (D) | Smoky 1 | Sweet 0.6 | Meaty 0.5 |
| 512 | 3-Methylamino-1- | (D) | Musty 0.2 | Woody 0.2 | Earthy 0.2 |
| | phenylpropanol | | | | |
| 514 | 2,3,4,5-Tetramethoxytoluene | (A) | Musty 1.4 | Green 0.8 | Earthy 0.5 |
| 515 | Cyclohexanone oxime | (C) | Sharp 2 | Smoky 0.7 | Sulfurous 0.6 |
| 517 | 2-[Methyl(2- | (D) | Roasted 1.3 | Nutty 1.1 | Sweet 0.6 |
| | pyridinyl)amino]-1-ethanol | | | | |
| 518 | (E)-2-Butanone oxime | (C) | Green 1.4 | Earthy 0.8 | Roasted 0.7 |
| 520 | 3-Methoxybutyl 3- | (D)* | Sulfurous 3 | Animal 1.6 | Meaty 1.4 |
| | mercaptopropionate | | | | |
| 526 | Methyl 1H-pyrrole-2- | (D) | Sweet 1.8 | Mint 0.9 | Fruity 0.8 |
| | carboxylate | | | | |
| 527 | Phenylthioacetonitrile | (D) | Meaty 0.9 | Garlic 0.7 | Roasted 0.7 |
| 531 | 2-(4- | (C) | Animal 1.2 | Powdery | Musty 0.8 |
| | Methoxyphenoxy) | | | 0.8 | |
| | acetonitrile | | | | |
| 533 | Isonicotinamide | (A) | Sweet 1.6 | Fruity 1.5 | Cucumber 1.2 |
| 534 | 3-Aminopyridazine | (D) | Ozone 0.3 | Sour 0.2 | Fermented 0.2 |
| 539 | 2-Isopropylanisole | (A) | Woody 1.2 | Green 1.1 | Herbal 1 |
| 541 | Triethyl orthoacetate | (D) | Alcoholic 3.6 | Sharp 2.1 | Cooling 1.8 |
| 544 | Ethylene glycol monotert- | (A) | Medicinal 2.1 | Camphor | Cooling 2 |
| | butyl ether | | | 2.1 | |
| 545 | alpha-Cyclopropylbenzyl | (D) | Sweet 1.4 | Mint 0.8 | Floral 0.7 |
| | alcohol | | | | |
| 550 | Methyl 2-amino-4- | (C)* | Sulfurous 3.1 | Garlic 1 | Musty 0.9 |
| | methylthiophene-3- | | | | |
| | carboxylate | | | | |
| 551 | 2-Aminobiphenyl | (D) | Smoky 1.3 | Ozone 1.1 | Animal 0.8 |
| 554 | N-Methyl-1- | (D) | Musty 1.4 | Nutty 0.7 | Roasted 0.6 |
| | naphthylmethylamine | | | | |
| 558 | 1-Benzyl-3-pyrrolidinone | (B) | Garlic 1.2 | Fruity 0.8 | Sweet 0.6 |
| 560 | Dodecyl methyl sulfide | (B)* | Meaty 2.7 | Roasted 1.5 | Smoky 0.8 |
| 561 | N,N-Diethylhydroxylamine | (D) | Fishy 1.7 | Sharp 0.6 | Roasted 0.6 |
| 562 | Pyridazine | (D) | Alcoholic 1.6 | Fermented | Medicinal 0.6 |
| | | | | 0.7 | |
| 563 | Triisopentylamine | (D) | Fruity 1.1 | Sweet 1 | Cheesy 0.8 |
| 568 | 1-Adamantanemethanol | (B) | Fermented 0.5 | Medicinal | Musty 0.5 |
| | | | | 0.5 | |
| 569 | N-Isopropylacrylamide | (D)* | Ozone 1 | Garlic 0.8 | Grassy 0.5 |
| 570 | Cyclopropyl 4- | (C) | Buttery 1.2 | Sweet 1.1 | Herbal 0.8 |
| | methoxyphenyl ketone | | | | |
| 571 | 2,2-Dimethyl-1,3- | (D) | Green 2.1 | Grassy 1.5 | Herbal 1 |
| | dioxaindane | | | | |
| 575 | 2,6-Dimethyl-4-hydroxy | (D) | Musty 1.1 | Sweet 0.6 | Smoky 0.6 |
| | benzaldehyde | | | | |
| 578 | (R)-(+)-1- | (D) | Fishy 1.3 | Musty 1.1 | Sharp 0.9 |
| | Phenylpropylamine | | | | |
| 580 | Acenaphthylene | (D) | Musty 2.1 | Ozone 1.4 | Earthy 0.9 |
| 582 | 4- | (A) | Green 1.6 | Sour 1.3 | Fermented 1.3 |
| | Dimethoxymethylpyrimidine | | | | |
| 585 | Bisabolene | (C) | Sour 1.3 | Sweet 1.1 | Citrus 1 |
| 586 | 2,5-Dimethylindole | (D) | Buttery 1.2 | Sulfurous | Cheesy 0.6 |
| | | | | 0.8 | |
| 590 | 1,3-Dimethylcyclohexane | (D) | Sweet 1 | Fruity 0.8 | Green 0.5 |
| 591 | 1,1-Dimethoxycyclohexane | (D) | Medicinal 1.9 | Cooling 1.7 | Camphor 1.4 |
| 592 | N-Methoxy-N- | (D) | Musty 0.9 | Sweet 0.8 | Coffee 0.7 |
| | methylacetamide | | | | |
| 593 | Ethyl 2-(2- | (B)* | Sweet 1.8 | Vanilla 1.5 | Rummy 0.9 |
| | methoxyphenoxy)acetate | | | | |
| 594 | 1,3-Cyclohexanedione | (D)* | Cheesy 2.2 | Dairy 0.9 | Buttery 0.8 |
| 595 | 1-Phenyl-1H-pyrrole | (D) | Musty 1.1 | Ozone 0.9 | Medicinal 0.7 |
| 596 | 2,6-Dimethylpyrimidin-4-ol | (B) | Roasted 2.6 | Nutty 1.4 | Buttery 0.5 |
| 598 | 2-Amino-5-methylthiophene- | (D) | Sweet 1.6 | Caramellic | Fruity 0.5 |
| | 3-carbonitrile | | | 0.6 | |
| 600 | 2,5-Dimethyl-2,4-hexadiene | (D) | Ozone 0.9 | Alcoholic | Metallic 0.7 |
| | | | | 0.8 | |
| 601 | 1,3-Dimethyl-1H-pyrazol- | (D) | Roasted 2.3 | Meaty 1.5 | Smoky 1.2 |
| | 5(4H)-one | | | | |
| 604 | 2-Aminocyclohexanol | (D) | Sharp 1.3 | Fishy 1.1 | Musty 0.8 |
| 607 | Ethyl 2-methylthiazole-4- | (D)* | Garlic 1.2 | Sulfurous | Cheesy 0.5 |
| | carboxylate | | | 0.5 | |
| 611 | 1-Phenyl-1-cyclohexene | (D) | Floral 1.2 | Herbal 1.1 | Woody 0.9 |
| 613 | 2-(prop-2-en-1-yl) | (A) | Cooling 2.7 | Mint 2.3 | Alcoholic 1.6 |
| | cyclohexan-1-one | | | | |
| 615 | Isobornyl methacrylate | (D)* | Pine 1.5 | Cooling 1.1 | Camphor 1.1 |
| 620 | 1-Methyl-1H-imidazole | (D) | Fishy 0.7 | Ozone 0.6 | Roasted 0.4 |
| 625 | 1-Methyl-2-pyrrolidine | (D)* | Roasted 2.7 | Nutty 1.9 | Fatty 0.8 |
| | ethanol | | | | |
| 627 | 4-Pentylcyclohexanone | (D) | Lemon 2 | Citrus 1.9 | Ozone 0.7 |
| 630 | trans-4- | (D) | Animal 1.2 | Musty 1.2 | Sour 0.8 |
| | Isopropylcyclohexane- | | | | |
| | carboxylic acid | | | | |
| 631 | N,N-Dimethylglycine ethyl | (D) | Fishy 2 | Sharp 1 | Sulfurous 0.9 |
| | ester | | | | |
| 634 | 1-(3-Hydroxyphenyl)propan- | (A) | Musty 1.4 | Sweet 0.7 | Earthy 0.7 |
| | 1-one | | | | |
| 638 | (4-tert- | (D) | Sulfurous 1.8 | Meaty 1.2 | Smoky 1.1 |
| | butylphenyl)methanethiol | | | | |
| 642 | Cyclopropylacetic acid | (D) | Cheesy 2.9 | Sweet 1.2 | Sour 1.1 |
| 649 | 3,5-Dimethylanisole | (D) | Musty 1.3 | Alcoholic 1 | Medicinal 0.9 |
| 660 | 2-Ethyl-2-oxazoline | (A) | Roasted 1 | Garlic 0.9 | Sulfurous 0.7 |
| 661 | N-tert-Butylformamide | (D) | Sweet 1 | Fruity 0.7 | Honey 0.7 |
| 663 | 2-Hydroxy-5- | (C) | Sweet 1.9 | Fruity 0.7 | Spicy 0.6 |
| | methoxybenzaldehyde | | | | |
| 665 | Dibutyl itaconate | (D) | Cheesy 0.9 | Sweet 0.8 | Caramellic |
| | | | | | 0.6 |
| 679 | Ethyl 3-ethoxyacrylate | (B) | Fruity 2.6 | Sweet 1.8 | Berry 1.1 |
| 680 | 3-Cyclopentylacrylonitrile | (B) | Waxy 0.9 | Sweet 0.8 | Cucumber 0.8 |
| 692 | Lipoic acid | (D)* | Sulfurous 3.5 | Sour 0.6 | Meaty 0.5 |
| 693 | Nonan-5-ol | (B) | Fruity 2 | Sweet 1.5 | Apple 1.2 |
| 694 | 1,2,3,6-Tetrahydrophthalic | (D) | Musty 0.7 | Sour 0.3 | Ozone 0.3 |
| | anhydride | | | | |
| 698 | 2-(Methylamino)benzoic | (D) | Dairy 0.5 | Sweet 0.4 | Musty 0.3 |
| | acid | | | | |
| 699 | Cyclohex-1-en-1-yl acetate | (A) | Sweet 1.6 | Fruity 1.5 | Alcoholic 1 |
| 700 | 1,3-Diethylurea | (D) | Spicy 0.6 | Musty 0.3 | Floral 0.3 |
| 701 | N,N-Diisopropylformamide | (A) | Cucumber 1 | Sweet 1 | Fruity 0.9 |
| 702 | Tetramethyl-1,3- | (D) | Cooling 1.2 | Medicinal | Camphor 1.1 |
| | cyclobutanedione | | | 1.2 | |
| 703 | 1,1,3,3-Tetraethoxypropane | (C) | Roasted 1.2 | Nutty 0.7 | Sweet 0.6 |
| 704 | 3-Anilinopropionitrile | (D) | Powdery 0.4 | Sweet 0.4 | Musty 0.4 |
| 709 | 2,2′- | (D) | Roasted 2.6 | Nutty 1.8 | Sharp 0.7 |
| | Disulfanediyldiethanamine | | | | |
| 710 | 3-Ethyl-4-methyl-3-pyrrolin- | (D) | Ozone 0.6 | Sweet 0.5 | Medicinal 0.4 |
| | 2-one | | | | |
| 711 | 4-(tert-Butoxy)-4- | (D) | Buttery 1.1 | Roasted 0.9 | Nutty 0.8 |
| | oxobutanoic acid | | | | |
| 713 | 3,4-Dimethyl-1H-pyrazole | (C) | Smoky 1.4 | Sweet 1 | Ozone 0.8 |
| 717 | 4-Methyl-2-thio-1,3-thiazole | (D) | Garlic 1.8 | Cheesy 1 | Buttery 0.7 |
| 721 | 2-Nitro-1-phenylpropene | (D) | Spicy 2 | Sweet 1.8 | Mint 0.7 |
| 722 | 4′-Hydroxy-3′- | (A) | Sweet 0.8 | Floral 0.5 | Fruity 0.5 |
| | methylacetophenone | | | | |
| 724 | 2-Methylbenzyl alcohol | (C) | Sweet 1.4 | Ozone 0.9 | Medicinal 0.8 |
| 728 | 2-Ethylcyclohexanol | (A)* | Camphor 2.1 | Cooling 1.8 | Medicinal 1.5 |
| 730 | Methyl imidothiocarbamate | (D) | Garlic 1.4 | Sulfurous | Sour 1 |
| | sulfate | | | 1.1 | |
| 731 | 1-Cyclohexylpiperazine | (D)* | Fishy 2.5 | Sulfurous | Animal 0.7 |
| | | | | 0.7 | |
| 733 | 2,2,6,6-Tetramethyl-4- | (D) | Fishy 0.8 | Musty 0.6 | Fatty 0.5 |
| | piperidyl methacrylate | | | | |
| 735 | 5-Vinylbicyclo[2.2.1] | (B) | Green 1 | Ozone 0.8 | Garlic 0.7 |
| | hept-2-ene | | | | |
| 736 | Bicyclo[2.2.1]hept-5-en-2- | (A) | Sweet 0.8 | Fermented | Musty 0.6 |
| | ylmethanol | | | 0.7 | |
| 738 | Isopropyl 3-aminocrotonate | (D) | Animal 2 | Sharp 1 | Smoky 0.9 |
| 741 | 1,3,3-Trimethyl-2- | (B) | Musty 1.1 | Medicinal | Cooling 0.8 |
| | methyleneindoline | | | 1 | |
| 743 | 2-Hydroxyindole | (D) | Musty 0.9 | Mint 0.6 | Powdery 0.6 |
| 745 | 2-Isopropyl-2,3-dimethyl- | (C)* | Cooling 3.3 | Camphor | Medicinal 2.9 |
| | butyronitrile | | | 3.2 | |
| 753 | 2,1,3-Benzothiadiazole | (C) | Musty 1.2 | Sweet 1.1 | Earthy 0.7 |
| 755 | 2-Methylpropane-2- | (D) | Sulfurous 1.2 | Herbal 0.3 | Floral 0.3 |
| | sulfinamide | | | | |
| 756 | 1,3-Dimethyl-2-nitrobenzene | (D) | Musty 1.9 | Green 0.8 | Sweet 0.8 |
| 757 | 4-propylcyclohexan-1-ol | (A) | Floral 1.5 | Citrus 1 | Rose 0.8 |
| 758 | 2-Butylbenzofuran | (A) | Sweet 1.2 | Floral 0.8 | Herbal 0.8 |
| 760 | tert-Butyl N-(piperidin-3-yl) | (B) | Ozone 0.5 | Roasted 0.5 | Medicinal 0.5 |
| | carbamate hydrochloride | | | | |
| 761 | 2-Methyl-2-propylpropane- | (D) | Sweet 1 | Alcoholic | Musty 0.8 |
| | 1,3-diol | | | 0.9 | |
| 762 | Ethyl 1,3-dimethyl-5- | (A) | Musty 1.4 | Herbal 1 | Spicy 1 |
| | pyrazolecarboxylate | | | | |
| 763 | 3,5-Dimethyl-1H-1,2,4- | (D) | Sweet 1.4 | Floral 0.5 | Fruity 0.5 |
| | triazole | | | | |
| 764 | 2-Methylindene | (D) | Musty 1.2 | Medicinal | Alcoholic 0.6 |
| | | | | 0.9 | |
| 765 | 1-Ethyl-3-pyrrolidonol | (D) | Roasted 0.7 | Garlic 0.6 | Nutty 0.6 |
| 773 | 4-Nitrobenzaldehyde | (D) | Sweet 1.4 | Fruity 0.8 | Waxy 0.7 |
| 776 | Methyl 2-methoxynicotinate | (B) | Sweet 0.9 | Pine 0.7 | Green 0.6 |
| 777 | 4-Pentyn-1-ol | (B)* | Roasted 1.6 | Tomato 1.5 | Meaty 1.2 |
| 780 | 4-N-Pentylphenylacetylene | (A) | Sweet 1.1 | Herbal 0.9 | Spicy 0.7 |
| 781 | Methyl 4-methylcinnamate | (D) | Fruity 1.3 | Sweet 1 | Sour 0.7 |
| 783 | 1,4- | (D) | Sweet 1.2 | Floral 1 | Herbal 1 |
| | Bis(methoxymethyl)benzene | | | | |
| 784 | 1-Benzyl-N- | (C) | Roasted 1.3 | Garlic 0.8 | Nutty 0.7 |
| | methylpyrrolidin-3-amine | | | | |
| 786 | 3,3-Dimethylbutyric acid | (D) | Fruity 1.4 | Sour 1.3 | Dairy 1 |
| 790 | 3-Butylthiophene | (D) | Sweet 0.9 | Floral 0.8 | Green 0.8 |
| 791 | 4,4-Dimethyl-3- | (D) | Fruity 0.9 | Sweet 0.9 | Berry 0.4 |
| | oxopentanenitrile | | | | |
| 800 | Thiomorpholine | (D) | Roasted 2.2 | Garlic 1.6 | Meaty 0.9 |
| 801 | 3,4-Dihydro-2H-pyran-5- | (D) | Musty 0.9 | Animal 0.7 | Dairy 0.6 |
| | carboxylic acid | | | | |
| 803 | (3-Methoxyphenyl)methanol | (D) | Musty 0.7 | Smoky 0.6 | Floral 0.4 |
| 812 | 2-Butyl-2-ethyl-1,3- | (D) | Dairy 0.7 | Sweet 0.4 | Buttery 0.3 |
| | propanediol | | | | |
| 820 | 1,1-Diphenylethylene | (D) | Herbal 0.8 | Tomato 0.8 | Pine 0.7 |
| 822 | Methyl propionylacetate | (D)* | Alcoholic 1.8 | Sweet 1.2 | Caramellic 1 |
| 827 | 7-Methoxy-3,4,5,6- | (D) | Alcoholic 0.5 | Powdery | Smoky 0.2 |
| | tetrahydro-2H-azepine | | | 0.3 | |
| 829 | 1,2-Dimethylindole | (C) | Musty 2.1 | Animal 1 | Smoky 1 |
| 832 | Ethyl (R)-(−)-mandelate | (D) | Waxy 0.6 | Fruity 0.5 | Musty 0.4 |
| 834 | 2,2-Dibutoxyethyl ether | (D) | Fruity 0.8 | Sweet 0.6 | Floral 0.4 |
| 847 | N-Methyl-N-phenylaniline | (D) | Herbal 0.8 | Ozone 0.7 | Woody 0.5 |
| 848 | ethyl 3-(piperidin-1-yl) | (D) | Garlic 1.2 | Roasted 0.6 | Sour 0.6 |
| | propanoate | | | | |
| 854 | Tetramethylpiperidine free | (C) | Medicinal 2.8 | Cooling 2.7 | Camphor 2.1 |
| | radical | | | | |
| 861 | 1-Decanethiol | (B) | Sulfurous 2 | Smoky 1 | Animal 0.8 |
| 864 | Ethyl 4-ethoxyphenylacetate | (C)* | Floral 1.4 | Sweet 1.3 | Herbal 0.9 |
| 868 | 1,1-Bis(methylsulfanyl)-2- | (D)* | Garlic 1.7 | Sulfurous | Roasted 0.6 |
| | nitroethene | | | 1.3 | |
| 875 | 2-(Ethyl(m- | (D) | Sweet 0.9 | Fermented | Musty 0.7 |
| | tolyl)amino)ethanol | | | 0.8 | |
| 876 | 2-Thiophenecarbonitrile | (A) | Spicy 2.1 | Sweet 1.9 | Fruity 1.1 |
| 877 | 1-Propyl-4-piperidone | (C) | Fishy 1.2 | Sharp 0.9 | Sulfurous 0.9 |
| 879 | 1-Cyclohexyl-2- | (D) | Roasted 1.5 | Sulfurous | Garlic 1 |
| | pyrrolidinone | | | 1.2 | |
| 881 | 1-Methoxy-2-butanol | (D) | Alcoholic 1.6 | Sweet 0.6 | Fermented 0.5 |
| 882 | 3-Phenylpropiolic acid | (C) | Alcoholic 1.2 | Fermented | Fruity 0.9 |
| | | | | 0.9 | |
| 887 | 5-Hydroxy-1-indanone | (D) | Waxy 0.3 | Smoky 0.2 | Musty 0.2 |
| 889 | 2-Amino-5-ethyl-1,3,4- | (D) | Sour 1.1 | Musty 0.8 | Sulfurous 0.6 |
| | thiadiazole | | | | |
| 895 | 2-Butanone oxime | (B) | Musty 1.1 | Smoky 1 | Green 1 |
| 896 | 1-tert-butyl-3,5- | (D) | Green 1.2 | Herbal 0.9 | Musty 0.9 |
| | dimethylbenzene | | | | |
| 897 | 3,4-Dimethylpyridine | (D) | Sweet 1.3 | Fruity 0.8 | Musty 0.6 |
| 898 | tert-Butyl sulfide | (D) | Pine 0.6 | Herbal 0.5 | Green 0.5 |
| 900 | 4-Acetoxystyrene | (B) | Sweet 1.1 | Herbal 1 | Medicinal 0.8 |
| 901 | Butopyronoxyl | (B) | Sweet 1.3 | Cheesy 1 | Buttery 0.8 |
| 905 | 2,6-Dimethylcyclohexanol | (C) | Medicinal 1.4 | Earthy 1.3 | Cooling 1 |
| 906 | 6-Methoxy-2- | (D) | Sweet 1.4 | Musty 1.1 | Fruity 0.7 |
| | methylquinoline | | | | |
| 913 | 2-Ethoxypyrazine | (D) | Roasted 3.2 | Nutty 2.6 | Buttery 0.7 |
| 917 | 2-Thiophenemethanol, α-[2- | (A)* | Roasted 3.1 | Nutty 1.6 | Buttery 1.4 |
| | (methylamino)ethyl]-, (S)- | | | | |
| 918 | 2-Methyl-3-furoic acid | (D)* | Sweet 1.7 | Sharp 1 | Caramellic |
| | | | | | 0.9 |
| 920 | 2-(p-Tolyl)acetic acid | (A) | Sour 0.9 | Musty 0.8 | Fermented 0.7 |
| 926 | Benzoxazole | (A) | Sweet 1.2 | Smoky 0.5 | Musk 0.5 |
| 927 | (Methylthio)acetic acid | (D)* | Garlic 2 | Cheesy 2 | Sour 1.4 |
| 931 | Benzoic acid, 4-amino-, 1,1- | (D) | Smoky 0.4 | Sulfurous | Animal 0.3 |
| | dimethylethyl ester | | | 0.4 | |
| 934 | Phenyl carbamate | (D) | Ozone 0.9 | Smoky 0.8 | Musty 0.7 |
| 941 | 2-Phenyl-4,5-dihydrooxazole | (D) | Sweet 1.1 | Mint 0.8 | Berry 0.7 |
| 944 | 1-Pyrrolidinebutanenitrile | (D) | Roasted 2.4 | Nutty 1.4 | Fatty 1 |
| 946 | 4-Cyanotetrahydro-4H-pyran | (D) | Sweet 1.9 | Fruity 1.5 | Alcoholic 1.1 |
| 947 | Tropolone | (D) | Smoky 1.8 | Sweet 1.3 | Musty 0.9 |
| 950 | 2-(tert-Butyl)phenol | (C) | Herbal 0.8 | Woody 0.7 | Medicinal 0.6 |
| 952 | 3-Methyl-4- | (D) | Smoky 1.1 | Musty 0.9 | Sulfurous 0.8 |
| | (methylthio)phenol | | | | |
| 954 | 3- | (D) | Fishy 1.5 | Fatty 0.6 | Sulfurous 0.6 |
| | (Cyclohexylamino) | | | | |
| | propionitrile | | | | |
| 955 | 1-(o-Tolyl)piperazine | (D)* | Fishy 1.7 | Sulfurous | Musty 0.7 |
| | | | | 0.7 | |
| 959 | 5-Methylisoxazol-3(2H)-one | (D) | Buttery 0.6 | Musty 0.6 | Waxy 0.3 |
| 960 | 2,4′-Bipyridine | (D) | Animal 1.3 | Green 1.3 | Earthy 1 |
| 961 | Thiophene-3-carbonitrile | (D) | Sweet 2.3 | Spicy 1.5 | Fruity 1.4 |
| 962 | p-Aminoacetanilide | (D) | Sweet 0.6 | Buttery 0.3 | Musty 0.3 |
| 963 | 2,2-dimethyl-2,3-dihydro-1- | (B) | Herbal 2.4 | Woody 1.4 | Earthy 0.5 |
| | benzofuran-7-ol | | | | |
| 964 | Benzoylacetonitrile | (D) | Caramellic 1.5 | Sweet 0.8 | Honey 0.5 |
| 965 | 2-(Pyridin-2-ylthio)ethanol | (B) | Sulfurous 1.4 | Meaty 1.3 | Animal 0.8 |
| 968 | Methyl 3-(4- | (B) | Powdery 1.6 | Animal 0.9 | Sweet 0.9 |
| | hydroxyphenyl)propionate | | | | |
| 971 | 2-(Aminomethyl)-1- | (D) | Buttery 1.2 | Roasted 1.1 | Nutty 1 |
| | ethylpyrrolidine | | | | |
| 974 | 3,5-Dimethylbenzonitrile | (B) | Sweet 2 | Spicy 2 | Caramellic |
| | | | | | 1.3 |
| 976 | 7-Methoxy-1-tetralone | (B) | Musty 0.7 | Waxy 0.7 | Earthy 0.6 |
| 982 | tert-Pentylbenzene | (C) | Herbal 1.4 | Green 0.9 | Grassy 0.7 |
| 985 | 1- | (D) | Green 1.2 | Floral 1.1 | Herbal 0.7 |
| | Phenylcyclopentane- | | | | |
| | carbonitrile | | | | |
| 988 | 3,3-Dimethyl-1-indanone | (A) | Green 1.1 | Musty 0.8 | Herbal 0.8 |
| 995 | 2,6-Dimethyl-3-nitropyridine | (A)* | Nutty 3 | Roasted 2.8 | Sweet 0.8 |
| 999 | 3-Methylbenzoic acid | (D) | Musty 0.9 | Waxy 0.7 | Earthy 0.2 |

*Confirmed or suspected impurity may contribute to odor.

The Examples provided herein are exemplary only and are not intended to be limiting in any way to the various aspects and embodiments of the invention described herein.

1. A compound selected from any one or more of the following compounds, each in free base or salt form (e.g., acid addition salt form or base addition salt form, as appropriate):
1-cyclopropylethanol
2-(4-methyl-1,3-thiazol-5-yl)ethyl formate
boc-DL-alanine
2,4-dimethylbenzonitrile
bicyclo[2,2,1]heptan-2-one
3-(2-methylprop-2-enoyloxy)butyl 2-methylprop-2-enoate
2,3,4,6,7,8,9,10-octahydropyrimido[1,2-a]azepine
N,N-dibutyl formamide
2-ethyl-N-(2-ethylhexyl)hexan-1-amine
methyl 3-amino-4-methoxybenzoate
2-methylpropyl 2-cyanoacetate
2-ethyladamantan-2-ol
4,5-dimethyl-1,3-thiazol-2-amine
pent-2-yn-1-ol
ethyl 5-methyl-1,2-oxazole-4-carboxylate
1,2,3,4,5-pentamethylbenzene
diethyl but-2-ynedioate
5-hydroxyadamantan-2-one
2-prop-2-ynoxyoxane
cyclooctanamine
(4-methoxy-3,5-dimethylpyridin-2-yl)methanol
benzyl 2-hydroxyacetate
(1S)-cyclohex-3-ene-1-carboxylic acid
2-ethyl-5-methyl-1H-imidazole
1-methyl-2-propan-2-yloxybenzene
N-tert-butyl-1-phenylmethanimine
N,N-dimethyl decanamide
1-(dimethylamino)-2-methylpentan-3-one
dodecane-1,12-diamine
2-prop-2-enoxybenzaldehyde
diethyl 2,2-dipropylpropanedioate
hept-3-yn-1-ol
2-thiophen-3-yl-1,3-dioxolane
6-(dimethylamino)hexan-1-ol
N-cyclohexyl cyclohexanamine
cyclohexylbenzene
3-methyloxolane-2,5-dione
8-tricyclo[5.2.1.02,6]decanyl 2-methylprop-2-enoate
methyl 2-cyanopyridine-4-carboxylate
3-acetylbenzonitrile
(1R,4R,5E)-5-ethylidenebicyclo[2.2.1]hept-2-ene
4-(cyclohexen-1-yl)morpholine
2,3-dihydrothieno[3,4-b][1.4]dioxine
ethyl (3R)-4-cyano-3-hydroxybutanoate
2,5-dimethyl-1H-imidazole
N,N,N′,N′-tetramethyl-1-[(2-methylpropan-2-yl)oxy]methanediamine
(E)-hex-3-enedinitrile
2,4-dimethyl-1H-pyrrole
methyl 5-methyl-1,2-oxazole-3-carboxylate
1-cyclohexylbutan-1-ol
(1S)-3-(dimethylamino)-1-thiophen-2-ylpropan-1-ol
(1S,2S,3R,5S)-2,6,6-trimethylbicyclo[3.1.1]heptane-2,3-diol
1-methylimidazole-2-carbaldehyde
1-ethenylazepan-2-one
dipropan-2-yl 3-oxocyclobutane-1,1-dicarboxylate
3a,4,7,7α-tetrahydro-1H-indene
tert-butylcyclohexane
1-methylindole-3-carbaldehyde
3,3-dimethylcyclohexan-1-one
tert-butyl 2,2-dimethylpropanoate
2-methylquinolin-8-ol
1-phenylpyrazole
2-methylsulfanyl-1,3-thiazole
ethyl N-phenylmethanimidate
quinoline-2-carbaldehyde
1,3-dimethylpiperidin-4-one
octyl prop-2-enoate
2-methyl-1,2-thiazol-3-one
pyridine-2-carbonitrile
4-aminobenzenethiol
N,N-dimethyl-3-oxobutanamide
2,3,5-trimethylcyclohexa-2,5-diene-1,4-dione
cyclooctanol
N,N,N,N-tetramethylbutane-1,3-diamine
1-(oxan-2-yl)pyrazole
2-phenylethylbenzene
2-ethylhexane-1,3-diol
N-(3,3-dimethylbutan-2-ylidene)hydroxylamine
2-[2-(2-sulfanylethoxy)ethoxy]ethanethiol
3-(pyrrol-1-ylmethyl)pyridine
1-methylcyclohexane-1-carboxylic acid
but-2-ynoic acid
2-butanoyloxyethyl butanoate
4-methylbenzene-1,2-diamine
ethylcyclohexane
2,2,6,6-tetramethylpiperidin-4-one
propan-2-ylsulfanylbenzene
2,4,7,9-tetramethyldec-5-yne-4,7-diol
4,5-dimethyl-1H-pyrazole (e.g., phosphate salt)
1-hexylimidazole
6,7-dihydro-5H-cyclopenta[b]pyridine
1-(1,3-benzodioxol-5-yl)butan-1-one
methyl cyclopentene-1-carboxylate
imidazo[1,2-a]pyridine
cyclooctene
2-amino-3-phenylpropan-1-ol
2-hydroxy-2-methylbutanoic acid
adamantane-1,3-diol
N-(1-phenylethylidene)hydroxylamine
cyclohex-3-en-1-ylmethanol
5-amino-1,2,4-dithiazole-3-thione
2-phenoxyethanamine
N-[(5-nitrofuran-2-yl)methylidene]hydroxylamine
1-(4-methylphenyl)pentan-1-one
5,6,7,8-tetrahydronaphthalen-1-ol
2,4-dimethoxypyrimidine
2,5,6-trimethyl-1,3-benzothiazole
pyridine-4-carbonitrile
1,3-dihydro-2-benzofuran
2-(dimethylamino)-2-methylpropan-1-ol
3,4-diethoxycyclobut-3-ene-1,2-dione
2-butoxypyridine
ethyl 3-(benzylamino)propanoate
2,4,6,8-tetramethyl-1,3,5,7-tetraoxocane
7-methyl-1H-indole
6,6-dimethylhept-1-en-4-yn-3-ol
2-(dimethylamino)acetonitrile
3-(ethylamino)propanenitrile
5-methyl-1,3-benzoxazole
methyl 4-acetyl-5-oxohexanoate
2-(4-methylphenyl)acetonitrile
bicyclo[2.2.1]hept-5-ene-2-carbonitrile
1-O-tert-butyl 2-O-ethyl piperidine-1,2-dicarboxylate
N-(9-methyl-9-azabicyclo[3.3.1]nonan-3-ylidene)hydroxylamine
1,1-dimethoxy-2-methylsulfanylethane
4-(4-methoxyphenyl)butan-1-ol
1-nitrobutane
(NZ)—N-(thiophen-2-ylmethylidene)hydroxylamine
2,3-dihydro-1,4-benzodioxin-6-amine
[(2S)-1-methoxy-3-[(2-methylpropan-2-yl)oxy]-1-oxopropan-2-yl]azanium (e.g., hydrochloride salt)
2,2,4,4-tetramethylpentan-3-one
(1-methylpiperidin-3-yl)methanol
2,4,4-trimethyl-5H-1,3-oxazole
ethyl 2-oxo-2-thiophen-2-ylacetate
1-ethynylcyclohexan-1-ol
4-pentoxybenzaldehyde
1H-indene
2-hydroxy-3-propyl-2H-furan-5-one
tert-butyl N-(6-aminohexyl)carbamate
2-(cyclohexen-1-yl)cyclohexan-1-one
4-cyclohexylbutanoic acid
2,6-ditert-butylpyridine
methyl (R)-(+)-2,2-Dimethyl-1,3-dioxolane-4-carboxylate
3-ethylpentan-3-ol
cyclohexyl prop-2-enoate
2-(ethoxymethylidene)propanedinitrile
S-phenyl ethanethioate
bis(methylsulfanyl)methylidenecyanamide
(4-ethylphenyl)methanol
2,2-diethoxy-1-phenylethanone
3-(2-furyl)acrylic acid
1-phenylcyclopropane-1-carboxylic acid
2-(dimethylamino)ethyl acetate
2-(2-aminophenyl)ethanol
4,5-dihydro-1,3-thiazol-2-ylcyanamide
4,9-dimethyltricyclo[5.2.1.02,6]deca-3,8-diene
bis(2-methylpropyl) benzene-1,2-dicarboxylate
2,3-dihydro-1-benzofuran-5-carbaldehyde
2-(cyclohexen-1-yl)ethanamine
methyl 2-cyano-2-methylpropanoate
methyl (2R)-2-(4-hydroxyphenoxy)propanoate
1-(2-bicyclo[2.2.1]hept-5-enyl)ethanone
propan-2-yl cyclohexanecarboxylate
2,3,3-trimethylindole
2-ethyl-1H-imidazole
1,5-dimethylpyrrole-2-carbonitrile
1,1,3-trimethylthiourea
N-cyclohexyl-N-methylcyclohexanamine
tert-butyl 3-(cyanomethylidene)azetidine-1-carboxylate
3-methylheptan-4-one
4-(2-methylpropyl)morpholine
3-(ethylamino)-4-methylphenol
4,6-dimethoxypyrimidin-2-amine
1-(1-adamantyl)ethanone
dimethylcyanamide
L-isoleucinol HCl
3,4-dihydro-2H-pyran-2-ylmethanol
3-acetyloxolan-2-one
tert-butyl 3-methylpiperazine-1-carboxylate
ethyl 1-cyanocyclopropane-1-carboxylate
methyl oxane-4-carboxylate
2-(1-ethoxyethylidene)propanedinitrile
pentanehydrazide
2-[2-(diethylamino)ethoxy]ethanol
tricyclo[5.2.1.02,6]decan-8-one
5-nitro-2,3-dihydro-1H-indole
3-amino-5-methyl-1H-pyridin-2-one
1-cyclopropylethanone
1-benzothiophene-2-carbaldehyde
(1S)-2,2-dimethylcyclopropane-1-carboxamide
4-methylthiophene-2-carboxylic acid
2,6-dimethylbenzonitrile
2-piperidin-1-ylethanol
1-thiophen-3-ylethanone
5-methyl-1H-imidazole
N-benzyl-N-ethylaniline
3-nitro-1H-pyridin-4-one
adamantan-2-ol
N-(pyridin-4-ylmethyl)ethanamine
1,2,4-tris(ethenyl)cyclohexane
4-methoxy-4-methylpentan-2-one
1-benzothiophene-3-carbaldehyde
diethyl 2-(2-methylpropyl)propanedioate
tert-butyl N-(1,3-thiazol-2-yl)carbamate
deca-1,9-diene
3-phenyloxolane-2,5-dione
2-hydroxy-3-methylbenzaldehyde
chromen-4-one
2-methylisoindole-1,3-dione
ethyl 3-oxocyclobutane-1-carboxylate
4-methoxy-1-methyl-2-nitrobenzene
3,3-dimethylbutan-1-ol
3,4-dimethoxyphenol
4-ethenylpyridine
1,3-thiazole-4-carboxylic acid
dimethyl cyclobutane-1,1-dicarboxylate
dipropan-2-yl butanedioate
4-methylsulfanylaniline
1,2,3,4-tetrahydronaphthalen-1-amine
ethyl 3-oxo-3-pyridin-4-ylpropanoate
oxolan-3-ylmethanol
ethyl 3-cyclopropyl-3-oxopropanoate
(1S,2R,6S,7R)-2-methyl-4-oxatricyclo[5.2.1.02,6]dec-8-ene-3,5-dione
1H-indazole
3-(methylamino)-1-phenylpropan-1-ol
1,2,3,4-tetramethoxy-5-methylbenzene
N-cyclohexylidenehydroxylamine
2-[methyl(pyridin-2-yl)aminolethanol
(NE)-N-butan-2-ylidenehydroxylamine
3-methoxybutyl 3-sulfanylpropanoate
methyl 1H-pyrrole-2-carboxylate
2-phenylsulfanylacetonitrile
2-(4-methoxyphenoxy)acetonitrile
pyridine-4-carboxamide
pyridazin-3-amine
1-methoxy-2-propan-2-ylbenzene
1,1,1-triethoxyethane
2-[(2-methylpropan-2-yl)oxy]ethanol
cyclopropyl(phenyl)methanol
methyl 2-amino-4-methylthiophene-3-carboxylate
2-phenylaniline
N-methyl-1-naphthalen-1-ylmethanamine
1-benzylpyrrolidin-3-one
1-methylsulfanyldodecane
N,N-diethyl hydroxylamine
pyridazine
3-methyl-N,N-bis(3-methylbutyl)butan-1-amine
1-adamantylmethanol
N-propan-2-ylprop-2-enamide
cyclopropyl-(4-methoxyphenyl)methanone
2,2-dimethyl-1,3-benzodioxole
4-hydroxy-2,6-dimethylbenzaldehyde
(1R)-1-phenylpropan-1-amine
acenaphthylene
4-(dimethoxymethyl)pyrimidine
(4Z)-1-methyl-4-(6-methylhept-5-en-2-ylidene)cyclohexene
2,5-dimethyl-1H-indole
1,3-dimethylcyclohexane
1,1-dimethoxycyclohexane
N-methoxy-N-methylacetamide
ethyl 2-(2-methoxyphenoxy)acetate
cyclohexane-1,3-dione
1-phenylpyrrole
2,4-dimethyl-1H-pyrimidin-6-one
2-amino-5-methylthiophene-3-carbonitrile
2,5-dimethylhexa-2,4-diene
2,5-dimethyl-4H-pyrazol-3-one
2-aminocyclohexan-1-ol
ethyl 2-methyl-1,3-thiazole-4-carboxylate
cyclohexen-1-ylbenzene
2-prop-2-enylcyclohexan-1-one
isobornyl methacrylate
1-methylimidazole
2-(1-methylpyrrolidin-2-yl)ethanol
4-pentylcyclohexan-1-one
4-propan-2-ylcyclohexane-1-carboxylic acid
ethyl 2-(dimethylamino)acetate
1-(3-hydroxyphenyl)propan-1-one
(4-tert-butylphenyl)methanethiol
2-cyclopropylacetic acid
1-methoxy-3,5-dimethylbenzene
2-ethyl-4,5-dihydro-1,3-oxazole
N-tert-butyl formamide
2-hydroxy-5-methoxybenzaldehyde
dibutyl 2-methylidenebutanedioate
ethyl (E)-3-ethoxyprop-2-enoate
(E)-3-cyclopentylprop-2-enenitrile
5-[(3R)-dithiolan-3-yl]pentanoic acid
nonan-5-ol
3a,4,7,7α-tetrahydro-2-benzofuran-1,3-dione
2-(methylamino)benzoic acid
cyclohexen-1-yl acetate
1,3-diethylurea
N,N-di(propan-2-yl)formamide
2,2,4,4-tetramethylcyclobutane-1,3-dione
1,1,3,3-tetraethoxypropane
3-anilinopropanenitrile
2-(2-aminoethyldisulfanyl)ethanamine
4-ethyl-3-methyl-1,2-dihydropyrrol-5-one
4-[(2-methylpropan-2-yl)oxy]-4-oxobutanoic acid
4,5-dimethyl-1H-pyrazole
4-methyl-3H-1,3-thiazole-2-thione
1-phenyl-2-nitropropene
1-(4-hydroxy-3-methylphenyl)ethanone
(2-methylphenyl)methanol
2-ethylcyclohexan-1-ol
methyl carbamimidothioate (e.g., sulfate salt)
1-cyclohexylpiperazine
(2,2,6,6-tetramethylpiperidin-4-yl) 2-methylprop-2-enoate
5-ethenylbicyclo[2.2.1]hept-2-ene
2-bicyclo[2.2.1]hept-5-enylmethanol
propan-2-yl (Z)-3-aminobut-2-enoate
1,3,3-trimethyl-2-methylideneindole
1H-indol-2-ol
2,3-dimethyl-2-propan-2-ylbutanenitrile
2,1,3-benzothiadiazole
2-methylpropane-2-sulfinamide
1,3-dimethyl-2-nitrobenzene
4-propylcyclohexan-1-ol
2-butyl-1-benzofuran
tert-butyl N-piperidin-3-ylcarbamate (e.g., hydrochloride salt)
2-methyl-2-propylpropane-1,3-diol
ethyl 2,5-dimethylpyrazole-3-carboxylate
3,5-dimethyl-1H-1,2,4-triazole
2-methyl-1H-indene
1-ethylpyrrolidin-3-ol
4-nitrobenzaldehyde
methyl 2-methoxypyridine-3-carboxylate
pent-4-yn-1-ol
1-ethynyl-4-pentylbenzene
methyl (E)-3-(4-methylphenyl)prop-2-enoate
1,4-bis(methoxymethyl)benzene
1-benzyl-N-methylpyrrolidin-3-amine
3,3-dimethylbutanoic acid
3-butylthiophene
4,4-dimethyl-3-oxopentanenitrile
thiomorpholine
3,4-dihydro-2H-pyran-5-carboxylic acid
(3-methoxyphenyl)methanol
2-butyl-2-ethylpropane-1,3-diol
1-phenylethenylbenzene
methyl 3-oxopentanoate
7-methoxy-3,4,5,6-tetrahydro-2H-azepine
1,2-dimethylindole
ethyl (2R)-2-hydroxy-2-phenylacetate
1-[2-(2-butoxyethoxy)ethoxy]butane
N-methyl-N-phenylaniline
ethyl 3-piperidin-1-ylpropanoate
2,2,6,6-tetramethyl-1-piperidinyloxy radical
decane-1-thiol
ethyl 2-(4-ethoxyphenyl)acetate
1,1-bis(methylsulfanyl)-2-nitroethene
2-(N-ethyl-3-methylanilino)ethanol
thiophene-2-carbonitrile
1-propylpiperidin-4-one
1-cyclohexylpyrrolidin-2-one
1-methoxybutan-2-ol
3-phenylprop-2-ynoic acid
5-hydroxy-2,3-dihydroinden-1-one
5-ethyl-1,3,4-thiadiazol-2-amine
N-butan-2-ylidenehydroxylamine
1-tert-butyl-3,5-dimethylbenzene
3,4-dimethylpyridine
2-tert-butylsulfanyl-2-methylpropane
(4-ethenylphenyl) acetate
butyl 2,2-dimethyl-4-oxo-3H-pyran-6-carboxylate
2,6-dimethylcyclohexan-1-ol
6-methoxy-2-methylquinoline
2-ethoxypyrazine
(1S)-3-(methylamino)-1-thiophen-2-ylpropan-1-ol
2-methylfuran-3-carboxylic acid
2-(4-methylphenyl)acetic acid
1,3-benzoxazole
2-methylsulfanylacetic acid
tert-butyl 4-aminobenzoate
phenyl carbamate
2-phenyl-4,5-dihydro-1,3-oxazole
4-pyrrolidin-1-ylbutanenitrile
oxane-4-carbonitrile
2-hydroxycyclohepta-2,4,6-trien-1-one
2-tert-butylphenol
3-methyl-4-methylsulfanylphenol
3-(cyclohexylamino)propanenitrile
1-(2-methylphenyl)piperazine
5-methyl-1,2-oxazol-3-one
2-pyridin-4-ylpyridine
thiophene-3-carbonitrile
N-(4-aminophenyl)acetamide
2,2-dimethyl-3H-1-benzofuran-7-ol
3-oxo-3-phenylpropanenitrile
2-pyridin-2-ylsulfanylethanol
methyl 3-(4-hydroxyphenyl)propanoate
(1-ethylpyrrolidin-2-yl)methanamine
3,5-dimethylbenzonitrile
7-methoxy-3,4-dihydro-2H-naphthalen-1-one
2-methylbutan-2-ylbenzene
1-phenylcyclopentane-1-carbonitrile
3,3-dimethyl-2H-inden-1-one
2,6-dimethyl-3-nitropyridine
and
3-methylbenzoic acid.

2. A compound according to claim 1, wherein the compound is selected from any one or more of the following compounds, each in free base or salt form (e.g., acid addition salt form or base addition salt form, as appropriate):
3-(2-methylprop-2-enoyloxy)butyl 2-methylprop-2-enoate
2-ethyladamantan-2-ol
ethyl 5-methyl-1,2-oxazole-4-carboxylate
1,2,3,4,5-pentamethylbenzene
diethyl 2,2-dipropylpropanedioate
8-tricyclo[5.2.1.02,6]decanyl 2-methylprop-2-enoate
1-cyclohexylbutan-1-ol
N-(3,3-dimethylbutan-2-ylidene)hydroxylamine
4,5-dimethyl-1H-pyrazole (e.g., phosphate salt)
methyl cyclopentene-1-carboxylate
cyclooctene
2,4-dimethoxypyrimidine
1,3-dihydro-2-benzofuran
2-butoxypyridine
2,4,6,8-tetramethyl-1,3,5,7-tetraoxocane
methyl 4-acetyl-5-oxohexanoate
[(2S)-1-methoxy-3-[(2-methylpropan-2-yl)oxy]-1-oxopropan-2-yl]azanium
(e.g., hydrochloride salt)
(1-methylpiperidin-3-yl)methanol
2-hydroxy-3-propyl-2H-furan-5-one
2-(cyclohexen-1-yl)cyclohexan-1-one
S-phenyl ethanethioate
4,9-dimethyltricyclo[5.2.1.02,6]deca-3,8-diene
1-(2-bicyclo[2.2.1]hept-5-enyl)ethanone
1,5-dimethylpyrrole-2-carbonitrile
3-methylheptan-4-one
4,6-dimethoxypyrimidin-2-amine
ethyl 1-cyanocyclopropane-1-carboxylate
5-methyl-1H-imidazole
3-nitro-1H-pyridin-4-one
ethyl 3-oxocyclobutane-1-carboxylate
dipropan-2-yl butanedioate
ethyl 3-oxo-3-pyridin-4-ylpropanoate
ethyl 3-cyclopropyl-3-oxopropanoate
1,2,3,4-tetramethoxy-5-methylbenzene
pyridine-4-carboxamide
1-methoxy-2-propan-2-ylbenzene
2-[(2-methylpropan-2-yl)oxy]ethanol
4-(dimethoxymethyl)pyrimidine
2-prop-2-enylcyclohexan-1-one
1-(3-hydroxyphenyl)propan-1-one
2-ethyl-4,5-dihydro-1,3-oxazole
cyclohexen-1-yl acetate
N,N-di(propan-2-yl)formamide
1-(4-hydroxy-3-methylphenyl)ethanone
2-ethylcyclohexan-1-ol
2-bicyclo[2.2.1]hept-5-enylmethanol
4-propylcyclohexan-1-ol
2-butyl-1-benzofuran
ethyl 2,5-dimethylpyrazole-3-carboxylate
1-ethynyl-4-pentylbenzene
thiophene-2-carbonitrile
(1S)-3-(methylamino)-1-thiophen-2-ylpropan-1-ol
2-(4-methylphenyl)acetic acid
1,3-benzoxazole
3,3-dimethyl-2H-inden-1-one
2,6-dimethyl-3-nitropyridine
2-(4-methyl-1,3-thiazol-5-yl)ethyl formate
4,5-dimethyl-1,3-thiazol-2-amine
pent-2-yn-1-ol
diethyl but-2-ynedioate
2-thiophen-3-yl-1,3-dioxolane
cyclohexylbenzene
ethyl N-phenylmethanimidate
pyridine-2-carbonitrile
2,3,5-trimethylcyclohexa-2,5-diene-1,4-dione
1-(1,3-benzodioxol-5-yl)butan-1-one
pyridine-4-carbonitrile
3,4-diethoxycyclobut-3-ene-1,2-dione
ethyl 3-(benzylamino)propanoate
7-methyl-1H-indole
1-O-tert-butyl 2-O-ethyl piperidine-1,2-dicarboxylate
2,6-ditert-butylpyridine
3-ethylpentan-3-ol
2,2-diethoxy-1-phenylethanone
1-(1-adamantyl)ethanone
3,4-dihydro-2H-pyran-2-ylmethanol
3-acetyloxolan-2-one
methyl oxane-4-carboxylate
1-thiophen-3-ylethanone
adamantan-2-ol
1,2,4-tris(ethenyl)cyclohexane
chromen-4-one
4-methoxy-1-methyl-2-nitrobenzene
3,4-dimethoxyphenol
oxolan-3-ylmethanol
1-benzylpyrrolidin-3-one
1-methylsulfanyldodecane
1-adamantylmethanol
ethyl 2-(2-methoxyphenoxy)acetate
2,4-dimethyl-1H-pyrimidin-6-one
ethyl (E)-3-ethoxyprop-2-enoate
(E)-3-cyclopentylprop-2-enenitrile
nonan-5-ol
5-ethenylbicyclo[2,2,1]hept-2-ene
1,3,3-trimethyl-2-methylideneindole
tert-butyl N-piperidin-3-ylcarbamate (e.g., hydrochloride salt)
methyl 2-methoxypyridine-3-carboxylate
pent-4-yn-1-ol
decane-1-thiol
N-butan-2-ylidenehydroxylamine
(4-ethenylphenyl) acetate
butyl 2,2-dimethyl-4-oxo-3H-pyran-6-carboxylate
2,2-dimethyl-3H-1-benzofuran-7-ol
2-pyridin-2-ylsulfanylethanol
methyl 3-(4-hydroxyphenyl)propanoate
3,5-dimethylbenzonitrile
7-methoxy-3,4-dihydro-2H-naphthalen-1-one
2-prop-2-ynoxyoxane
benzyl 2-hydroxyacetate
2-ethyl-5-methyl-1H-imidazole
2-prop-2-enoxybenzaldehyde
hept-3-yn-1-ol
3-acetylbenzonitrile
(1R,4R,5E)-5-ethylidenebicyclo[2.2.1]hept-2-ene
ethyl (3R)-4-cyano-3-hydroxybutanoate
3,3-dimethylcyclohexan-1-one
2-methylsulfanyl-1,3-thiazole
cyclooctanol
2-ethylhexane-1,3-diol
ethylcyclohexane
2,4,7,9-tetramethyldec-5-yne-4,7-diol
1-(4-methylphenyl)pentan-1-one
1-ethynylcyclohexan-1-ol
pentanehydrazide
2,6-dimethylbenzonitrile
N-cyclohexylidenehydroxylamine
(NE)-N-butan-2-ylidenehydroxylamine
2-(4-methoxyphenoxy)acetonitrile
methyl 2-amino-4-methylthiophene-3-carboxylate
cyclopropyl-(4-methoxyphenyl)methanone
(4Z)-1-methyl-4-(6-methylhept-5-en-2-ylidene)cyclohexene
2-hydroxy-5-methoxybenzaldehyde
1,1,3,3-tetraethoxypropane
4,5-dimethyl-1H-pyrazole
(2-methylphenyl)methanol
2,3-dimethyl-2-propan-2-ylbutanenitrile
2,1,3-benzothiadiazole
1-benzyl-N-methylpyrrolidin-3-amine
1,2-dimethylindole
2,2,6,6-tetramethyl-1-piperidinyloxy free radical
ethyl 2-(4-ethoxyphenyl)acetate
1-propylpiperidin-4-one
3-phenylprop-2-ynoic acid
2,6-dimethylcyclohexan-1-ol
2-tert-butylphenol
2-methylbutan-2-ylbenzene
2-(4-methylphenyl)acetonitrile
(4-ethylphenyl)methanol
and
deca-1,9-diene.

3. A compound according to claim 1, wherein the compound is selected from any one or more of the following compounds, each in free base or salt form (e.g., acid addition salt form or base addition salt form, as appropriate):
3-(2-methylprop-2-enoyloxy)butyl 2-methylprop-2-enoate
2-ethyladamantan-2-ol
ethyl 5-methyl-1,2-oxazole-4-carboxylate
1,2,3,4,5-pentamethylbenzene
diethyl 2,2-dipropylpropanedioate
8-tricyclo[5.2.1.02,6]decanyl 2-methylprop-2-enoate
1-cyclohexylbutan-1-ol
N-(3,3-dimethylbutan-2-ylidene)hydroxylamine
4,5-dimethyl-1H-pyrazole (e.g., phosphate salt)
methyl cyclopentene-1-carboxylate
cyclooctene
2,4-dimethoxypyrimidine
1,3-dihydro-2-benzofuran
2-butoxypyridine
2,4,6,8-tetramethyl-1,3,5,7-tetraoxocane
methyl 4-acetyl-5-oxohexanoate
[(2S)-1-methoxy-3-[(2-methylpropan-2-yl)oxy]-1-oxopropan-2-yl]azanium
(e.g., hydrochloride salt)
(1-methylpiperidin-3-yl)methanol
2-hydroxy-3-propyl-2H-furan-5-one
2-(cyclohexen-1-yl)cyclohexan-1-one
S-phenyl ethanethioate
4,9-dimethyltricyclo[5.2.1.02,6]deca-3,8-diene
1-(2-bicyclo[2.2.1]hept-5-enyl)ethanone
1,5-dimethylpyrrole-2-carbonitrile
3-methylheptan-4-one
4,6-dimethoxypyrimidin-2-amine
ethyl 1-cyanocyclopropane-1-carboxylate
5-methyl-1H-imidazole
3-nitro-1H-pyridin-4-one
ethyl 3-oxocyclobutane-1-carboxylate
dipropan-2-yl butanedioate
ethyl 3-oxo-3-pyridin-4-ylpropanoate
ethyl 3-cyclopropyl-3-oxopropanoate
1,2,3,4-tetramethoxy-5-methylbenzene
pyridine-4-carboxamide
1-methoxy-2-propan-2-ylbenzene
2-[(2-methylpropan-2-yl)oxy]ethanol
4-(dimethoxymethyl)pyrimidine
2-prop-2-enylcyclohexan-1-one
1-(3-hydroxyphenyl)propan-1-one
2-ethyl-4,5-dihydro-1,3-oxazole
cyclohexen-1-yl acetate
N,N-di(propan-2-yl)formamide
1-(4-hydroxy-3-methylphenyl)ethanone
2-ethylcyclohexan-1-ol
2-bicyclo[2.2.1]hept-5-enylmethanol
4-propylcyclohexan-1-ol
2-butyl-1-benzofuran
ethyl 2,5-dimethylpyrazole-3-carboxylate
1-ethynyl-4-pentylbenzene
thiophene-2-carbonitrile
(1S)-3-(methylamino)-1-thiophen-2-ylpropan-1-ol
2-(4-methylphenyl)acetic acid
1,3-benzoxazole
3,3-dimethyl-2H-inden-1-one
2,6-dimethyl-3-nitropyridine
2-(4-methyl-1,3-thiazol-5-yl)ethyl formate
4,5-dimethyl-1,3-thiazol-2-amine
pent-2-yn-1-ol
diethyl but-2-ynedioate
2-thiophen-3-yl-1,3-dioxolane
cyclohexylbenzene
ethyl N-phenylmethanimidate
pyridine-2-carbonitrile
2,3,5-trimethylcyclohexa-2,5-diene-1,4-dione
1-(1,3-benzodioxol-5-yl)butan-1-one
pyridine-4-carbonitrile
3,4-diethoxycyclobut-3-ene-1,2-dione
ethyl 3-(benzylamino)propanoate
7-methyl-1H-indole
1-O-tert-butyl 2-O-ethyl piperidine-1,2-dicarboxylate
2,6-ditert-butylpyridine
3-ethylpentan-3-ol
2,2-diethoxy-1-phenylethanone
1-(1-adamantyl)ethanone
3,4-dihydro-2H-pyran-2-ylmethanol
3-acetyloxolan-2-one
methyl oxane-4-carboxylate
1-thiophen-3-ylethanone
adamantan-2-ol
1,2,4-tris(ethenyl)cyclohexane
chromen-4-one
4-methoxy-1-methyl-2-nitrobenzene
3,4-dimethoxyphenol
oxolan-3-ylmethanol
1-benzylpyrrolidin-3-one
1-methylsulfanyldodecane
1-adamantylmethanol
ethyl 2-(2-methoxyphenoxy)acetate
2,4-dimethyl-1H-pyrimidin-6-one
ethyl (E)-3-ethoxyprop-2-enoate
(E)-3-cyclopentylprop-2-enenitrile
nonan-5-ol
5-ethenylbicyclo[2.2.1]hept-2-ene
1,3,3-trimethyl-2-methylideneindole
tert-butyl N-piperidin-3-ylcarbamate (e.g., hydrochloride salt)
methyl 2-methoxypyridine-3-carboxylate
pent-4-yn-1-ol
decane-1-thiol
N-butan-2-ylidenehydroxylamine
(4-ethenylphenyl) acetate
butyl 2,2-dimethyl-4-oxo-3H-pyran-6-carboxylate
2,2-dimethyl-3H-1-benzofuran-7-ol
2-pyridin-2-ylsulfanylethanol
methyl 3-(4-hydroxyphenyl)propanoate
and
3,5-dimethylbenzonitrile.

4. A compound according to claim 1, wherein the compound is selected from any one or more of the following compounds, each in free base or salt form (e.g., acid addition salt form or base addition salt form, as appropriate):
3-(2-methylprop-2-enoyloxy)butyl 2-methylprop-2-enoate
2-ethyladamantan-2-ol
ethyl 5-methyl-1,2-oxazole-4-carboxylate
1,2,3,4,5-pentamethylbenzene
diethyl 2,2-dipropylpropanedioate
8-tricyclo[5.2.1.02,6]decanyl 2-methylprop-2-enoate
1-cyclohexylbutan-1-ol
N-(3,3-dimethylbutan-2-ylidene)hydroxylamine
4,5-dimethyl-1H-pyrazole (e.g., phosphate salt)
methyl cyclopentene-1-carboxylate
cyclooctene
2,4-dimethoxypyrimidine
1,3-dihydro-2-benzofuran
2-butoxypyridine
2,4,6,8-tetramethyl-1,3,5,7-tetraoxocane
methyl 4-acetyl-5-oxohexanoate
[(2S)-1-methoxy-3-[(2-methylpropan-2-yl)oxy]-1-oxopropan-2-yl]azanium (e.g., hydrochloride salt)
(1-methylpiperidin-3-yl)methanol
2-hydroxy-3-propyl-2H-furan-5-one
2-(cyclohexen-1-yl)cyclohexan-1-one
S-phenyl ethanethioate
4,9-dimethyltricyclo[5.2.1.02,6]deca-3,8-diene
1-(2-bicyclo[2.2.1]hept-5-enyl)ethanone
1,5-dimethylpyrrole-2-carbonitrile
3-methylheptan-4-one
4,6-dimethoxypyrimidin-2-amine
ethyl 1-cyanocyclopropane-1-carboxylate
5-methyl-1H-imidazole
3-nitro-1H-pyridin-4-one
ethyl 3-oxocyclobutane-1-carboxylate
dipropan-2-yl butanedioate
ethyl 3-oxo-3-pyridin-4-ylpropanoate
ethyl 3-cyclopropyl-3-oxopropanoate
1,2,3,4-tetramethoxy-5-methylbenzene
pyridine-4-carboxamide
1-methoxy-2-propan-2-ylbenzene
2-[(2-methylpropan-2-yl)oxy]ethanol
4-(dimethoxymethyl)pyrimidine
2-prop-2-enylcyclohexan-1-one
1-(3-hydroxyphenyl)propan-1-one
2-ethyl-4,5-dihydro-1,3-oxazole
cyclohexen-1-yl acetate
N,N-di(propan-2-yl)formamide
1-(4-hydroxy-3-methylphenyl)ethanone
2-ethylcyclohexan-1-ol
2-bicyclo[2.2.1]hept-5-enylmethanol
4-propylcyclohexan-1-ol
2-butyl-1-benzofuran
ethyl 2,5-dimethylpyrazole-3-carboxylate
1-ethynyl-4-pentylbenzene
thiophene-2-carbonitrile
(1S)-3-(methylamino)-1-thiophen-2-ylpropan-1-ol
2-(4-methylphenyl)acetic acid
1,3-benzoxazole
3,3-dimethyl-2H-inden-1-one
and
2,6-dimethyl-3-nitropyridine.

5. A flavor composition and/or fragrance composition comprising a compound according to claim 1, in admixture with one or more carriers or excipients, which carriers or excipients are non-toxic, orally acceptable, pharmaceutically acceptable, cosmetically acceptable, acceptable for a household product, or otherwise acceptable for the intended purpose of the Composition.

6. The composition of claim 5, wherein the composition further comprises one or more solvents.

7. The composition of claim 5, wherein the composition further comprises one or more other flavors or fragrances.

8. A product comprising the compound of claim 4, e.g., a product selected from the following: personal care products (e.g., a soap, skin cream or lotion, balm, shampoo, body wash, shower gel, hydrating cream, deodorant, antiperspirant, after-shave lotion, cologne, perfume, or other hair care or skin care product), sunscreens, insect repellants and insecticides, detergents, household cleaning agents (e.g., a surface cleaner, a metal cleaner, a wood cleaner, a glass cleaner, a body cleaner such as a soap, a dish-washing detergent, or a laundry detergent), air fresheners, room sprays, pomanders, candles, cosmetics (e.g., perfumes, colognes, nail polish, eye liner, mascara, lipstick, foundation, concealer, blush, bronzer, eye shadow, lip liner, lip balm), toilet waters, talcum powders, and pet litter.
